(19) United States
(12) Patent Application Publication
(10) Pub. No.: US 2026/0106720 A1
(43) Pub. Date: Apr. 16, 2026

(54) INTERFERENCE MITIGATION MODE SIGNALING DESIGNS FOR A PHYSICAL LAYER PROTOCOL DATA UNIT

(71) Applicant: QUALCOMM Incorporated, San Diego, CA (US)

(72) Inventors: Eugene BAIK, Sunnyvale, CA (US); Jialing Li CHEN, San Diego, CA (US); Lin YANG, San Diego, CA (US); Sameer VERMANI, San Diego, CA (US); Bin TIAN, San Diego, CA (US)

(21) Appl. No.: 19/169,924

(22) Filed: Apr. 3, 2025

Related U.S. Application Data
(63) Continuation-in-part of application No. 18/988,600, filed on Dec. 19, 2024.
Application No. 18/988,600 is a continuation-in-part of application No. 18/949,788, filed on Nov. 15, 2024.
Application No. 18/949,788 is a continuation-in-part of application No. 18/913,741, filed on Oct. 11, 2024.

(51) Int. Cl. H04L 5/00

(52) U.S. Cl. CPC H04L 5/0094; H04L 5/0044

(57) ABSTRACT

This disclosure provides methods, components, devices and systems for interference mitigation (IM) mode signaling designs for a physical layer protocol data unit (PPDU). Some aspects relate to IM mode signaling designs according to which two or more wireless communication devices determine locations of IM pilot tones within a data portion of a PPDU comprising a multiple resource unit (MRU). In such aspects, an MRU may be defined with multiple tone separation distances including a tone separation distance that corresponds to an ON state of the IM mode. Some further aspects relate to IM mode signaling designs according to which two or more wireless communication devices determine locations of pilot tones within a data portion of a PPDU that are usable as IM pilot tones and/or as carrier frequency offset (CFO) pilot tones. In such aspects, the data portion may exclude IM- or CFO-specific pilot tones.

### CROSS REFERENCE

The present application for patent is a continuation-in-part of U.S. patent application Ser. No. 18/988,600 by BAIK et al., entitled “INTERFERENCE MITIGATION MODE SIGNALING DESIGNS FOR A PHYSICAL LAYER PROTOCOL DATA UNIT,” filed Dec. 19, 2024, which is a continuation-in-part of U.S. patent application Ser. No. 18/949,788 by BAIK et al., entitled “INTERFERENCE MITIGATION MODE SIGNALING DESIGNS FOR A PHYSICAL LAYER PROTOCOL DATA UNIT,” filed Nov. 15, 2024, which is a continuation-in-part of U.S. patent application Ser. No. 18/913,741 by BAIK et al., entitled “INTERFERENCE MITIGATION MODE SIGNALING DESIGNS FOR A PHYSICAL LAYER PROTOCOL DATA UNIT,” filed Oct. 11, 2024, each of which is assigned to the assignee hereof, and each of which is expressly incorporated by reference in their entirety herein.

### TECHNICAL FIELD

This disclosure relates generally to wireless communication and, more specifically, to interference mitigation (IM) mode signaling designs for a physical layer (PHY) protocol data unit (PPDU).

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

In some wireless communication systems, two or more wireless communication devices may support an interference mitigation (IM) mode. An IM mode may enable a wireless communication device to measure or otherwise ascertain information associated with interference experienced at the wireless communication device. For example, in accordance with an IM mode, a first wireless communication device may allocate pilot tone subcarriers within one or more orthogonal frequency division multiplexing (OFDM) symbols of a data field of a physical layer (PHY) protocol data unit (PPDU). In such examples, a second wireless communication device may receive the PPDU and process the data field of the PPDU such that the second wireless communication device uses the pilot tone subcarriers to measure or otherwise ascertain information associated with interference experienced by the second wireless communication device.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a wireless communication device. The wireless communication device may include a processing system that includes processor circuitry and memory circuitry that stores code. The processing system may be configured to cause the wireless communication device to communicate first information indicative of an ON state of an interference mitigation (IM) mode for a physical layer protocol data unit (PPDU), communicate second information indicative of at least one punctured subchannel within a channel bandwidth of the PPDU, and transmit the PPDU via a subset of the channel bandwidth in accordance with the at least one punctured subchannel within the channel bandwidth, the PPDU including a data portion based on the IM mode in accordance with the first information, the data portion including at least a multiple resource unit (MRU) in accordance with the second information, and the MRU including a set of multiple pilot tones corresponding to the IM mode and a set of multiple data tones that are interleaved within the MRU in accordance with a first tone separation distance, of a set of multiple tone separation distances defined for the MRU, that corresponds to the ON state of the IM mode.

Another innovative aspect of the subject matter described in this disclosure can be implemented in a method for wireless communication by or at a wireless communication device. The method may include communicating first information indicative of an ON state of an IM mode for a PPDU, communicating second information indicative of at least one punctured subchannel within a channel bandwidth of the PPDU, and transmitting the PPDU via a subset of the channel bandwidth in accordance with the at least one punctured subchannel within the channel bandwidth, the PPDU including a data portion based on the IM mode in accordance with the first information, the data portion including at least an MRU in accordance with the second information, and the MRU including a set of multiple pilot tones corresponding to the IM mode and a set of multiple data tones that are interleaved within the MRU in accordance with a first tone separation distance, of a set of multiple tone separation distances defined for the MRU, that corresponds to the ON state of the IM mode.

Some examples of the method and wireless communication devices described herein may further include operations, features, means, or instructions for determining the first tone separation distance from the set of multiple tone separation distances defined for the MRU in accordance with the ON state of the IM mode for the PPDU. In some examples of the method and wireless communication devices described herein, the set of multiple tone separation distances defined for the MRU includes the first tone separation distance that corresponds to the ON state of the IM mode and includes a second tone separation distance that corresponds to an OFF state of the IM mode.

In some examples of the method and wireless communication devices described herein, the first tone separation distance may be equal to 9 tones and the second tone separation distance may be equal to 18 tones. In some examples of the method and wireless communication devices described herein, the MRU may be a 484-tone plus 242-tone MRU (MRU484+242).

In some examples of the method and wireless communication devices described herein, the MRU may be in accordance with a parameter value for a quantity of data tones in a fractional resource unit (RU) increment to use in a pre-forward error correction (FEC) padding calculation, of a set of multiple parameter values defined for the MRU for the quantity of data tones in the fractional RU increment to use in pre-FEC padding calculations, that corresponds to the ON state of the IM mode.

Another innovative aspect of the subject matter described in this disclosure can be implemented in a wireless communication device. The wireless communication device may include a processing system that includes processor circuitry and memory circuitry that stores code. The processing system may be configured to cause the wireless communication device to communicate information indicative of an ON state of an IM mode for a PPDU and transmit the PPDU via a channel bandwidth, the PPDU including a data portion based on the IM mode in accordance with the information, and the data portion including a first RU that includes a set of multiple pilot tones usable as interference measurement pilot tones corresponding to the IM mode and usable as carrier frequency offset (CFO) measurement pilot tones in accordance with the ON state of the IM mode, the set of multiple pilot tones at fixed tone locations within the first RU, and includes a set of multiple data tones interleaved within the first RU in accordance with a first tone separation distance, of a set of multiple tone separation distances defined for the first RU, that corresponds to the ON state of the IM mode.

Another innovative aspect of the subject matter described in this disclosure can be implemented in a method for wireless communication by or at a wireless communication device. The method may include communicating information indicative of an ON state of an IM mode for a PPDU and transmitting the PPDU via a channel bandwidth, the PPDU including a data portion based on the IM mode in accordance with the information, and the data portion including a first RU that includes a set of multiple pilot tones usable as interference measurement pilot tones corresponding to the IM mode and usable as CFO measurement pilot tones in accordance with the ON state of the IM mode, the set of multiple pilot tones at fixed tone locations within the first RU, and includes a set of multiple data tones interleaved within the first RU in accordance with a first tone separation distance, of a set of multiple tone separation distances defined for the first RU, that corresponds to the ON state of the IM mode.

In some examples of the method and wireless communication devices described herein, the first RU may have a first RU size and the fixed tone locations within the first RU correspond, at least in part, to CFO pilot tone locations of a set of multiple RUs having a second RU size smaller than the first RU size.

In some examples of the method and wireless communication devices described herein, the fixed tone locations within the first RU correspond to a full union of all the CFO pilot tone locations of the set of multiple RUs having the second RU size.

In some examples of the method and wireless communication devices described herein, the fixed tone locations within the first RU correspond to a subset of the CFO pilot tone locations of the set of multiple RUs having the second RU size.

In some examples of the method and wireless communication devices described herein, the fixed tone locations within the first RU correspond to at least a subset of the CFO pilot tone locations of the set of multiple RUs having the second RU size and to one or more additional tone locations within the first RU.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communication between a wireless access point (AP) and one or more wireless stations (STAs).

FIG. 3 shows a hierarchical format of an example physical layer (PHY) protocol data unit (PPDU) usable for communication between a wireless AP and one or more wireless STAs.

FIG. 4 shows an example of signaling diagram that supports interference mitigation (IM) mode signaling designs for a PPDU.

FIG. 5 shows an example PPDU usable for communication between a wireless AP and one or more wireless STAs that supports IM mode signaling designs for a PPDU.

FIGS. 6A and 6B show example user information fields that support IM mode signaling designs for a PPDU.

FIG. 7 shows an example signaling diagram that supports IM mode signaling designs for a PPDU.

FIG. 8 shows an example trigger frame that supports IM mode signaling designs for a PPDU.

FIG. 9 shows an example common information field that supports IM mode signaling designs for a PPDU.

FIG. 10 shows an example special user information field that supports IM mode signaling designs for a PPDU.

FIGS. 11A, 11B, 11C, 11D, and 11E show example subfield designs that support IM mode signaling designs for a PPDU.

FIGS. 12A and 12B show example subfield designs that support IM mode signaling designs for a PPDU.

FIGS. 13-15 show example pilot tone patterns that support IM mode signaling designs for a PPDU.

FIG. 16 shows an example pilot tone sequence generation procedure that supports IM mode signaling designs for a PPDU.

FIG. 17 shows example process flows that support IM mode signaling designs for a PPDU.

FIGS. 18A and 18B show example transmit flows that support IM mode signaling designs for a PPDU.

FIGS. 19A, 19B, 20A, and 20B show example punctured transmissions that support IM mode signaling designs for a PPDU.

FIGS. 21A and 21B show example pilot tone plans for pilot tones usable as IM pilot tones and usable as CFO pilot tones that support IM mode signaling designs for a PPDU.

FIG. 22 shows a block diagram of an example wireless communication device that supports IM mode signaling designs for a PPDU.

FIGS. 23-32 show flowcharts illustrating example processes performable by or at a wireless communication device that supports IM mode signaling designs for a PPDU.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, two or more wireless communication devices may support an interference mitigation (IM) mode. An IM mode may enable or facilitate at least one wireless communication device to measure or otherwise ascertain information associated with interference experienced at the wireless communication device. The information (which may be derived or measured from IM pilots) may be used by the wireless communication device to apply further receiver processing to mitigate the present interference. An IM mode may apply to a physical layer (PHY) protocol data unit (PPDU), such that a wireless communication device may transmit and/or receive a PPDU in accordance with the IM mode. In other words, an IM mode may relate to (such as impact) both transmit operations and receive operations associated with a PPDU. In some networks, wireless communication devices may optionally, selectively, or conditionally use an IM mode for transmission and/or reception of a PPDU. For example, a wireless communication device may use the IM mode for PPDU transmissions and/or receptions at some times and may not use the IM mode for PPDU transmissions and/or receptions at some other times (in accordance with one or more of various parameters, criteria, or device-level decisions). By way of further example, a wireless communication device may enable or disable the IM mode (for transmissions and/or receptions) on a per-PPDU basis. Some networks, however, may lack signaling mechanisms according to which wireless communication devices can coordinate on whether the IM mode is enabled (such as used) for a current or subsequent PPDU. Without such signaling mechanisms, a wireless communication device may be unable to accurately (or successfully) decode or parse one or more data fields of a received PPDU, which may result in communication errors including packet drops and/or decoding failures because the wireless communication device lacks knowledge of whether the IM mode was used for the transmission of the PPDU. Thus, some networks may benefit from additional signaling capabilities associated with indicating whether the IM mode is enabled or disabled for a current or subsequent PPDU.

Various aspects relate generally to IM mode signaling designs according to which two or more wireless communication devices may coordinate on a state associated with an IM mode for a current or subsequent PPDU. Such a state associated with the IM mode may be an ON state (in which the IM mode is enabled) or an OFF state (in which the IM mode is disabled). Some aspects more specifically relate to MU PPDU IM mode signaling designs and trigger-based (TB) PPDU IM mode signaling designs. In accordance with some example MU PPDU IM mode signaling designs, a first wireless communication device may indicate, to a second wireless communication device via a preamble portion of a first PPDU (such as an MU PPDU), a state associated with the IM mode for the first PPDU. Additionally, or alternatively, the first wireless communication device may indicate, to the second wireless communication device via the preamble portion of the first PPDU, a requested or commanded state associated with the IM mode for PPDU(s) transmitted by the second wireless communication device to the first wireless communication device. In accordance with some example TB PPDU IM mode signaling designs, a first wireless communication device may indicate, to a second wireless communication device via a trigger frame, a state associated with the IM mode for a TB PPDU solicited by the trigger frame. Some further aspects relate to which field(s) and/or bit(s) may be used to provide such indications via an MU PPDU or a trigger frame, how devices may indicate operating parameters associated with the IM mode, for which transmission types devices may enable the IM mode, and pilot tone patterns associated with the IM mode, among other aspects disclosed herein.

Particular aspects of the subject matter described in this disclosure can be implemented to realize one or more of the following potential advantages. In some examples, by indicating a state associated with the IM mode for a PPDU (such as an MU PPDU) via a preamble portion of the PPDU or a frame soliciting the PPDU, the described techniques may allow for or otherwise enable the IM mode to be dynamically enabled or disabled on a per-PPDU basis such that the IM mode is used as suitable, such as in scenarios in which the benefits of IM exceed an associated overhead such that the IM mode provides an overall system benefit. Additionally, the described techniques can be used to achieve greater synchronization between a transmitter of the PPDU and one or more receivers of the PPDU and provide sufficient time for the one or more receivers to prepare to receive a data field in accordance with the IM mode. Such synchronization and sufficient time allocation may support greater communication reliability by aligning expectations regarding how a PPDU is transmitted and by enabling the one or more receivers to prepare one or more antennas or processors for a measurement associated with the IM mode. Further, by indicating a state associated with the IM mode for a second PPDU via a preamble portion of a first PPDU, the described techniques can be used to enable a first wireless communication device to request other wireless communication device(s) to use the IM mode for PPDU transmissions to the first wireless communication device. In accordance with such a request, the first wireless communication device may selectively perform measurements associated with the IM mode, which may enable the first wireless communication device to balance data throughput with communication reliability (by measuring and managing interference). Moreover, by indicating a state associated with the IM mode for a TB PPDU via a trigger frame soliciting the TB PPDU, the described techniques can be used to enable a transmitter of the TB PPDU to rely on information provided via the trigger frame for generation of the TB PPDU, which may reduce ambiguity and align expectations regarding how the TB PPDU is to be transmitted in some networks. In accordance with such reduced ambiguity and aligned expectations, communicating devices may realize greater communication reliability, which may in turn support higher data rates, higher network capacity, and greater spectral efficiency, among other benefits.

Various further aspects relate generally to IM mode signaling designs according to which two or more wireless communication devices may coordinate on a state associated with an IM mode as part of an OFDMA communication scheme. Some aspects more specifically relate to MU PPDU IM mode signaling designs and signaling designs in a trigger frame (which may be referred to as a “Trigger Frame”) that solicits a TB PPDU with the IM mode in the context of OFDMA communication in which different wireless communication devices use different resource units (RUs) or multiple RUs (MRUs) within an operating or PPDU bandwidth. In some examples, a wireless communication device may indicate, via one or more fields of a message (such as an MU PPDU or a trigger frame), information indicative of a respective state associated with the IM mode for each wireless communication device of a set of multiple wireless communication devices. The multiple wireless communication devices may be two or more wireless communication devices addressed, allocated, or triggered by the message. The one or more fields may include a field that is applicable to (such as decodable by) the multiple wireless communication devices and/or one or more user information fields. Such a field that is applicable to the multiple wireless communication devices may be a universal signal (U-SIG) field or a common field of an ultra-high reliability (UHR) signal (UHR-SIG) field of an MU PPDU. Alternatively, such a field that is applicable to the multiple wireless communication devices may be a common information field or a special user information field of a trigger frame.

Particular aspects of the subject matter described in this disclosure can be implemented to realize one or more of the following potential advantages. In some examples, by supporting IM mode signaling designs as part of an OFDMA communication scheme, the described techniques may allow for or otherwise enable the IM mode to be dynamically enabled or disabled (on a per-PPDU basis) within OFDMA transmissions, which may facilitate greater use of the IM mode across various network scenarios. By facilitating greater use of the IM mode across various network scenarios, including network scenarios in which OFDMA transmissions provide greater network performance (such as higher data rates), the described techniques may can be used to measure and/or reduce interference while still allowing for (and realizing) the greater network performance provided by OFDMA transmissions. Further, by indicating a respective state associated with the IM mode for each of multiple wireless communication devices via one or more fields in accordance with the described techniques, a wireless communication device may provide an IM mode state indication for each of the multiple wireless communication devices with relatively low signaling overhead, which may support greater communication reliability, greater spectral efficiency, backwards compatibility, and lower processing costs, among other benefits.

Various further aspects relate generally to determining locations for pilot tones associated with the IM mode, which may be referred to herein as IM pilots or IM pilot tones. In some examples, a wireless communication device may determine locations for IM pilot tones in accordance with a tone mapping distance, or “DTM,”-based operation. In such examples, the wireless communication device may define one or more values of one or more parameters associated with the DTM operation to account for the IM pilot tones added prior to the DTM operation. Such parameters may include a D_{SD,IM} parameter and/or a D_{IMP} parameter. In some other examples, the wireless communication device may determine locations for IM pilot tones in accordance with a fixed tone approach. In such examples, the wireless communication device may define one or more values of one or more parameters associated with the DTM operation to account for the IM pilot tones inserted after the DTM operation. Such parameters also may include a D_{SD,IM} parameter and/or a D_{IMP} parameter. Further, in some of such examples, the wireless communication device may select a D_{TM} parameter and/or a tone interleaver (such as a tone interleaver operation or equation) in accordance with whether the IM mode is set to an ON state for a PPDU.

Particular aspects of the subject matter described in this disclosure can be implemented to realize one or more of the following potential advantages. In some examples, by supporting various mechanisms according to which a wireless communication device may determine locations for IM pilot tones, various networks may flexibly achieve a target complexity and/or a target interference measurement performance by configuring wireless communication devices with different tone plans depending on whether the IM mode is set to an ON state. By achieving a target complexity and/or a target interference measurement performance, such networks may facilitate lower processing costs, reduced network ambiguity, compatible PPDU transmissions with the IM mode set to an ON state, and more reliable communication, which may in turn support greater or more suitably balanced spectral efficiency, higher data rates, and reduced power consumption, among other benefits.

Various further aspects relate generally to supporting IM pilot tones within one or more MRUs and to supporting pilot tones that are usable as IM pilot tones and usable as carrier frequency offset (CFO) pilot tones. In some examples, a wireless communication device may use IM pilot tones within an MRU to perform a punctured PPDU transmission for which the IM mode is in an ON state. In such examples, the punctured PPDU transmission may be associated with at least an MRU (such as a 484-tone plus 242-tone MRU, or “MRU484+242”) and the wireless communication device may select a tone separation distance (such as a D_{TM} parameter or value), from a set of tone separation distances that is associated with the MRU, that corresponds to the ON state of the IM mode. In some other examples, a wireless communication device may use pilot tones within an RU as IM pilot tones and/or CFO pilot tones (“IM+CFO pilot tones”). In such examples, the pilot tones may be positioned at fixed locations that correspond, at least in part, to CFO pilot tone locations of multiple RUs of a smaller RU size. For example, the fixed locations of the IM+CFO pilot tones within a 242-tone RU (RU242) may correspond, at least in part, to CFO pilot tone locations of the constituent 26-tone RUs (RU26s) within the RU242.

Particular aspects of the subject matter described in this disclosure can be implemented to realize one or more of the following potential advantages. In some examples, by supporting punctured PPDU transmissions for which the IM mode is in an ON state, wireless communication devices may transmit and/or receive PPDUs with the IM mode in relatively more deployment scenarios and/or in relatively more diverse operating conditions, including scenarios and/or conditions in which subchannel puncturing is performed. By extending the IM mode to more scenarios and/or more operating conditions, relatively more wireless communication devices may use the IM mode as suitable even with the presence of one or more punctured subchannels, such as whenever the benefits of the IM mode exceed an associated overhead (such that the IM mode provides an overall system benefit). Such an extension of the IM mode may support more reliable communication, which may in turn support greater or more suitably balanced spectral efficiency, higher data rates, and reduced power consumption, among other benefits. Moreover, by supporting pilot tones usable as IM pilot tones and usable as CFO pilot tones, a transmitting wireless communication device may enable a receiving wireless communication device to autonomously determine whether to use the pilot tones for IM, CFO measurement, or both. The receiving wireless communication device may perform such a determination in accordance with which of IM or CFO measurement, or both, is relatively more likely to increase a reliability of communication from the transmitting wireless communication device to the receiving wireless communication device, which may enable flexible and dynamic implementation decisions across a wireless communication network. By enabling flexible and dynamic implementation decisions across a wireless communication network, various wireless communication devices may achieve more reliable communication, which may in turn support greater or more suitably balanced spectral efficiency, higher data rates, and reduced power consumption, among other benefits.

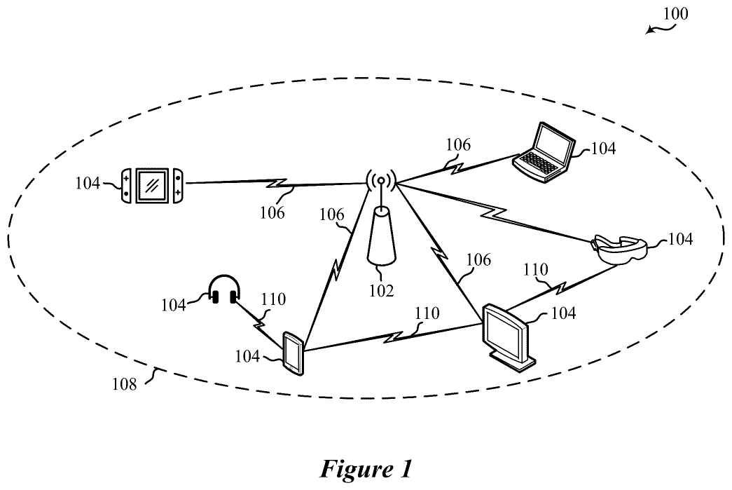

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit.

Each of the STAs 104 also may be referred to as a mobile station (MS), a mobile device, a mobile handset, a wireless handset, an access terminal (AT), a user equipment (UE), a subscriber station, or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency expectations, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput expectations.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communication (hereinafter also referred to as “Wi-Fi communication” or “wireless packets”) to and from one another in the form of PPDUs.

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communication. For example, the APs 102 or STAs 104, or both, also may be capable of communicating over licensed operating bands, in which multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple subbands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS may involve transmission on the primary 20 MHz channel. As such, in conventional systems, the transmitting device may contend on and win a TXOP on the primary channel to transmit anything at all. However, some APs 102 and STAs 104 supporting ultra-high reliability (UHR) communication or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some examples, two or more wireless communication devices (such as two or more APs 102 or two or more STAs 104, or any combination of one or more APs 102 and one or more STAs 104) of the wireless communication network 100 may support receive-side IM (pilots), such as in accordance with an IM mode. An IM mode may be any communication mode, scheme, or procedure according to which a wireless communication device may allocate additional pilot tone subcarriers in one or more OFDM symbols of a data field of a PPDU or otherwise format, generate, or construct a data field of a PPDU to enable or facilitate an interference measurement. For example, one or more wireless communication devices may use IM pilot (which, as used herein, may refer generally to +1/−1 valued or 0 valued) tones for detection and mitigation of interference. Potential sources of interference may include over-the-air (narrowband or wideband) transmissions and/or OBSS transmissions, and/or on-device interference. Such “pilot” tones associated with the IM mode may be pilots embedded per OFDM symbol, null tones, and/or LTF-symbol midambles, among other examples. Such pilot tones may be optionally inserted at a stage in a data field transmitter flow that is separate from CFO pilots. In other words, within a data field of a PPDU, pilot tones associated with the IM mode (and the IM mode more generally) may be in addition to CFO pilots associated with a CFO measurement.

An “IM mode” may refer generally to any combination of a usage of one or more +1/−1 valued tones, one or more null (0 valued) tones, and/or one or more LTF sequence values distributed throughout at least one data field of a PPDU to enable or otherwise facilitate detection and mitigation of interference. An IM mode design may include interference estimation, receiver processing, and/or usage and signaling aspects. Regarding interference estimation, one or more wireless communication devices may support defined (in accordance with a network specification or one or more signaled indications) locations of pilots (such as within an OFDM time-frequency resource grid), a quantity or density of pilots, values used for pilot tones (including pilot sequence), or additional spreading (in scenarios of MIMO communication), rotation, or scrambling sequences applied to a pilot sequence. One or more parameters associated with the IM mode may indicate locations (such as a pattern) of pilots, a quantity or density of pilots, values used for pilot tones, a spreading sequence applied to an IM pilot sequence, a rotation sequence applied to an IM pilot sequence, and/or a scrambling sequence applied to an IM pilot sequence.

Regarding receiver processing, one or more wireless communication devices may support (in accordance with a network specification or one or more signaled indications) mechanisms for how a receiving device is able to detect a presence and/or a specific location of an interferer, mechanisms for how a receiving device is able to estimate one or more characteristics of the interference, mitigation techniques (such as receive beamforming) for suppressing the interference, or other receiver algorithms associated with the IM mode. Regarding usage and signaling aspects, one or more wireless communication devices may support signaling/indications to indicate whether the IM mode is ON/OFF in transmission, signaling of IM mode operation parameters (such as information indicative of or otherwise associated with a quantity, location, or periodicity, among other example parameters, of pilots or other such IM mechanisms), and/or signaling for a first device to request a second device to enable the IM mode in one or more subsequent packets transmitted by the second device to the first device.

In some networks, such as the wireless communication network 100, the IM mode may be defined (by a network specification) as an optional mode for a set of devices associated with a specific capability or generation. For example, a set of devices (such as all devices) associated with a UHR capability or generation may optionally support the IM mode. In some examples, each device of the set of devices may enable or disable the IM mode on a per-PPDU basis. For example, one or more devices may optionally, selectively, or conditionally support a transmission of PPDUs with IM mode set to an ON state and/or may optionally, selectively, or conditionally support a reception of PPDUs with IM mode set to an ON state. In examples in which a device does not support the IM mode, the device may not expect to receive signaling indicating that the IM mode is enabled (such as in accordance with a rule or expectation defined by a network specification).

In some examples, a wireless communication device or a network may support or define the IM mode for one or more of various transmission or PPDU types. For example, a wireless communication device or a network may support or define the IM mode for one or both of full bandwidth scenarios (such as full bandwidth transmissions) and OFDMA scenarios (such as OFDMA transmissions). Full bandwidth scenarios may include SU PPDUs (both downlink (DL) and uplink (UL)) and non-OFDMA MU-MIMO PPDUs (DL and TB UL). Additionally, puncturing of one or more subbands, as defined in the allowed punctured patterns in a punctured channel information subfield of U-SIG, may be allowed. In some aspects, a PPDU bandwidth subfield and the punctured channel information subfield may jointly indicate an RU or MRU assigned to one user in an SU transmission or a quantity of users in a non-OFDMA MU-MIMO transmission. Additionally, or alternatively, the PPDU bandwidth subfield, the punctured channel information subfield, and an IM mode indication may jointly indicate an RU or MRU assigned to one user in an SU transmission in the IM mode or all users in a non-OFDMA MU-MIMO transmission in the IM mode.

In examples in which an UL or DL PPDU transmission spans a full, an entire, or a complete bandwidth (such as a full operating bandwidth or a full BSS bandwidth), a data field of the UL or DL PPDU may support or otherwise be associated with OFDM pilot tone-based IM mode designs. In some aspects, a wireless communication device may set a state associated with the IM mode to an ON state or an OFF state for all users in a PPDU. In such aspects, and in examples in which the IM mode involves pilots, the pilots may cover a full bandwidth (of the PPDU) and may apply to all users of the PPDU. In some aspects, full bandwidth PPDUs may support one or more of various preamble signal (SIG) field definitions or interpretations to indicate the state associated with the IM mode. Additionally, or alternatively, for a TB UL MIMO PPDU, a trigger frame soliciting the TB UL MIMO PPDU may include (such as carry) IM mode signaling.

In OFDMA scenarios, which may involve both DL and UL scenarios, a bandwidth may be segmented into different RUs and/or MRUs assigned to different users. In such scenarios, and in examples in which the IM mode involves pilots, a wireless communication device or a network may support or define the IM mode such that the IM mode is not defined for DL and UL OFDMA or such that, in DL or UL OFDMA operation, the IM mode design may expect a set of receivers (such as all users) of the PPDU to have IM mode enabled. In other words, in examples in which the IM mode is enabled for a PPDU, the IM mode may apply for a set of receivers (such as all users) of the PPDU. Otherwise, such as if some RUs/MRUs have pilots present while some other RUs/MRUs have no pilots, data field generation and/or parsing may become complicated (in terms of processing costs) and/or the interference management associated with the IM mode may become ineffective. Likewise, IM mode signaling within a preamble of a PPDU may be to the set of receivers (such as all users) of the PPDU, as opposed to being within one or more user information fields of a SIG field (such as one or more user information fields of a UHR-SIG field).

Alternatively, in some implementations, two or more wireless communication devices may support IM mode signaling designs in the context of OFDMA scenarios (such as OFDMA transmissions and/or OFDMA communication schemes). In such implementations, a wireless communication device may transmit a message (such as an MU PPDU or a trigger frame) to multiple other wireless communication devices and may indicate, via one or more fields of the message, information indicative of a respective state associated with the IM mode for each wireless communication device of the multiple other wireless communication devices. For example, the wireless communication device may indicate, via the one or more fields of the message, a first state associated with the IM mode for a first wireless communication device of the multiple other wireless communication devices and a second state associated with the IM mode for a second wireless communication device of the multiple other wireless communication devices. The first state may be the same as or different than the second state, with, for example, each (explicitly or implicitly) separately indicated.

A wireless communication device that receives a PPDU for which the IM mode is set to an ON state may support, implement, or employ one or more mechanisms associated with interference detection and/or estimation (using one or more aspects or components of the IM mode or prior to enabling the IM mode). For example, a wireless communication device may support one or more mechanisms to detect whether interference is present (to determine whether to turn the IM mode to an ON state) and may support one or more mechanisms (once the IM mode is set to the ON state) to estimate one or more characteristics of the interference (for use in receive IM processing). The wireless communication device may detect whether interference is present using a guard interval (GI)-based detection within a data portion of a PPDU and/or using a covariance-based detection within a short interframe space (SIFS) period, among other examples. The wireless communication device may estimate one or more characteristics of the interference (once IM mode is set to the ON state) by measuring pilot tones across time and frequency in accordance with an OFDM tone plan and/or by measuring periodic midambles OFDM symbols, among other examples. Example pilot tone patterns associated with the IM mode are illustrated and described herein.

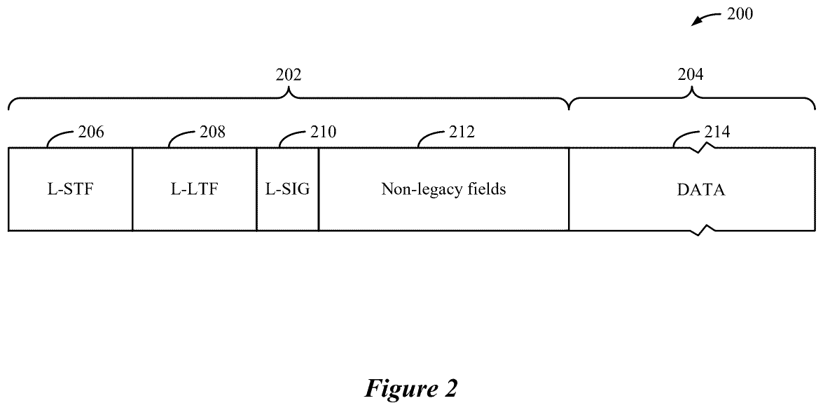

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field 214 (illustrated as “DATA” in the example of FIG. 2) that, in turn, may carry higher layer data, for example, in the form of MAC protocol data units (MPDUs) or an aggregated MPDU (A-MPDU).

In some examples, UHR-capable STAs 104 and APs 102 may support unequal modulation techniques (also referred to as unequal quadrature amplitude modulation (QAM)) with joint encoding across multiple streams for MIMO communication. For example, while different data streams may be transmitted using different spatial streams, or different RUs, or both, different spatial streams or RUs may be associated with different levels of quality (such as a different signal to noise ratios (SNRs)), and it may be advantageous to use different (unequal) modulation and coding schemes (MCSs) for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams. The multiple spatial streams may be encoded with the same code rate.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communication protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communication in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

In accordance with some of the example implementations disclosed herein, a first wireless communication device may transmit the PDU 200 (as a PPDU) to a second wireless communication device and may indicate a state associated with an IM mode for the PDU 200 or another PDU. Additionally, or alternatively, a wireless communication device may transmit the PDU 200 to multiple wireless communication devices and may indicate a respective state associated with an IM mode for each wireless communication device of the multiple wireless communication devices addressed or allocated by the PDU 200. The IM mode may involve pilot tones, such as OFDM tone pilots, among other examples. In some examples in which the IM mode associated with the PDU 200 involves OFDM tone pilots (which may be positioned or located within the data field 214), the first wireless communication device may use the OFDM tone pilots with LDPC coding. For example, a pilot placement design may be related to an LDPC tone mapping distance (DTM) procedure. In such examples, a wireless communication device may refrain from using IM pilots if any user in a PPDU is using a binary convolutional code (BCC) coding scheme. In some other examples in which the IM mode associated with the PDU 200 involves OFDM tone pilots (which may be positioned or located within the data field 214), the first wireless communication device may use the OFDM tone pilots with BCC coding.

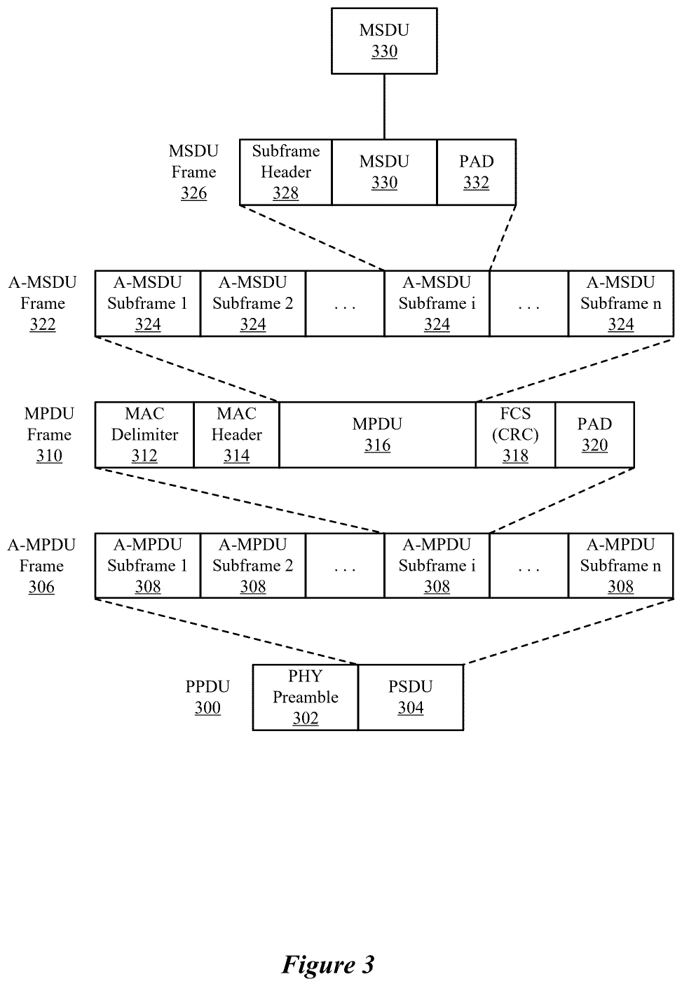

FIG. 3 shows a hierarchical format of an example PPDU usable for communication between a wireless AP and one or more wireless STAs. For example, the AP and STAs may be examples of the AP 102 and the STAs 104 described with reference to FIG. 1. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 308 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (such as the FCS field 318 may include a cyclic redundancy check (CRC)) and padding bits 320. The MPDU 316 may carry one or more MAC service data units (MSDUs) 330. For example, the MPDU 316 may carry an aggregated MSDU (A-MSDU) 322 including multiple A-MSDU subframes 324. Each A-MSDU subframe 324 may be associated with an MSDU frame 326 and may contain a corresponding MSDU 330 preceded by a subframe header 328 and, in some examples, followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body. The MAC header 314 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 314 also includes one or more fields indicating addresses for the data encapsulated within the frame body. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

In some implementations, the AP 102 and STAs 104 can support various multi-user communication; that is, concurrent transmissions from one device to each of multiple devices (such as multiple simultaneous downlink communication from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple RUs each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communication networks or services. For example, an AI/ML model may be utilized for supporting or improving aspects such as reducing signaling overhead (such as by CSI feedback compression), enhancing roaming or other mobility operations, multi-AP coordination, and generally facilitating network management or optimizing network connections or characteristics to, for example, increase throughput or capacity, reduce latency or otherwise enhance user experience.

In accordance with some of the example implementations disclosed herein, a first wireless communication device may transmit the PPDU 300 to a second wireless communication device and may indicate a state associated with an IM mode for the PPDU 300 and/or another PPDU. In some examples, the first wireless communication device may include information indicative of the state associated with the IM mode for the PPDU 300, or for the other PPDU, within the PHY preamble 302 of the PPDU 300. For example, the PHY preamble 302 may include one or more fields or one or more bits that the first wireless communication device may use to provide an indication of the state associated with an IM mode for the PPDU 300 and/or the other PPDU. Additionally, or alternatively, the PHY preamble 302 may include one or more fields or one or more bits that a wireless communication device may use to provide an indication of a respective state associated with an IM mode for each wireless communication device of multiple wireless communication devices addressed or allocated by the PPDU 300.

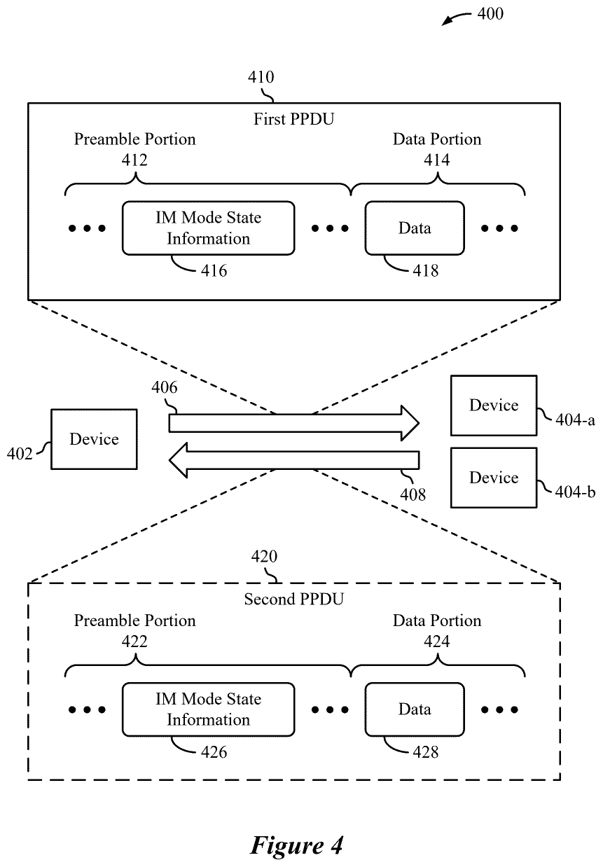

FIG. 4 shows an example signaling diagram 400 that supports IM mode signaling designs for a PPDU. The signaling diagram 400 may implement or be implemented to realize one or more aspects of the wireless communication network 100, the PDU 200, or the PPDU 300. For example, the signaling diagram 400 illustrates communication between a wireless communication device 402, a wireless communication device 404-a, and a wireless communication device 404-b. The wireless communication device 402 may be an example of a STA 104 or an AP 102, such as a STA 104 or an AP 102 as illustrated by and described with reference to FIG. 1. The wireless communication device 404-a and the wireless communication device 404-b may each be an example of a STA 104 or an AP 102, such as a STA 104 or an AP 102 as illustrated by and described with reference to FIG. 1.

The wireless communication device 402 and the wireless communication device 404-a and/or the wireless communication device 404-b may communicate with each other via a communication link 406 (which may be one of an UL or a DL, among other examples) and a communication link 408 (which may be the other of the UL or the DL, among other examples). In some examples, the wireless communication device 402 may transmit a first PPDU 410 to the wireless communication device 404-a and/or the wireless communication device 404-b. The first PPDU 410 may include a preamble portion 412 and a data portion 414. The first PPDU 410 may be an example of an MU PPDU, such as a UHR-MU PPDU. A UHR-MU PPDU may be used for DL SU transmissions, UL SU transmissions, OFDMA transmissions, or downlink (full bandwidth) MU-MIMO transmissions. In DL, the UHR-MU PPDU may be associated with a UHR-MU PPDU sub-type, such as a DL SU or a null data packet (NDP) sub-type (which may exclude an RU allocation field or table within a UHR-SIG field), a DL OFDMA sub-type (which may include an RU allocation field or table within a UHR-SIG field), or a DL MU-MIMO sub-type (which may not include an RU allocation field or table within a UHR-SIG field, as DL MU-MIMO transmissions may be full bandwidth).

In some aspects, various (such as all) PPDU sub-types may carry or include one or more user information fields. A user information field may be associated with one of two different types (with both types defined to be 23 bits in some networks, such as UHR networks). A first type of user information field may be a non-MU-MIMO user information field, which a device may use in examples in which a user associated with the user information field is not part of an MU-MIMO grouping (within an RU/MRU or within a full bandwidth PPDU). A second type of user information field may be an MU-MIMO user information field, which a device may use in examples in which a user associated with the user information field is part of an MU-MIMO grouping.

In some implementations, the wireless communication device 402 may transmit the first PPDU 410 (such as a UHR-MU PPDU) with the IM mode set to a specific state (such as an ON state or an OFF state) for a data field 418 within the data portion 414 of the first PPDU 410. In such implementations, the wireless communication device 402 may signal the state associated with the IM mode via the preamble portion 412 of the first PPDU 410. In other words, the wireless communication device 402 may include, within the preamble portion 412 of the first PPDU 410, information 416 indicative of the state associated with the IM mode for the first PPDU 410. The wireless communication device 404-a and/or the wireless communication device 404-b (one or more devices receiving the first PPDU 410) may receive the information 416 and identify, determine, or otherwise ascertain whether, for example, pilot tones associated with the IM mode are present within the data field 418 of the first PPDU 410. The wireless communication device 404-a and/or the wireless communication device 404-b may adjust (such as set, configure, tune, or update) a receive processing in accordance with the indicated state associated with the IM mode. For example, the wireless communication device 404-a and/or the wireless communication device 404-b may use a first receive processing scheme or procedure to receive (and decode, parse, or process) the data field 418 in examples in which the state associated with the IM mode is an OFF state and may use a second receive processing scheme or procedure to receive (and decode, parse, or process) the data field 418 in examples in which the state associated with the IM mode is an ON state.

In some implementations, the information 416 may indicate a respective state associated with the IM mode for each of the wireless communication device 404-a and the wireless communication device 404-b. For example, the information 416 may indicate a first state associated with the IM mode for the wireless communication device 404-a and may indicate a second state associated with the IM mode for the wireless communication device 404-b. In such implementations, the wireless communication device 404-a may adjust (such as set, configure, tune, or update) a receive processing in accordance with the indicated first state associated with the IM mode and the wireless communication device 404-b may adjust (such as set, configure, tune, or update) a receive processing in accordance with the indicated second state associated with the IM mode. In accordance with the separately indicated states associated with the IM mode across the wireless communication device 404-a and the wireless communication device 404-b, the wireless communication device 402 may transmit a first portion of the data field 418 (a portion of data within a first RU or MRU allocated to the wireless communication device 404-a) in accordance with the first state associated with the IM mode and may transmit a second portion of the data field 418 (a portion of data within a second RU or MRU allocated to the wireless communication device 404-b) in accordance with the second state associated with the IM mode. In this context in which the data portion 414 of the first PPDU 410 is transmitted in accordance with separately indicated IM mode states associated with each receiver of the first PPDU 410, the separately indicated IM mode states may be the same or different.

In addition to including information 416 indicative of the state associated with the IM mode for the first PPDU 410, or as an alternative to including information 416 indicative of the state associated with the IM mode for the first PPDU 410, the wireless communication device 402 may include information 416 indicative of a state associated with the IM mode for a second PPDU 420. Such information 416 indicative of the state associated with the IM mode for the second PPDU 420 may be an indication of a state that the wireless communication device 402 requests or commands the wireless communication device 404-a and/or the wireless communication device 404-b to use for one or more (subsequent) PPDUs transmitted by the wireless communication device 404-a and/or the wireless communication device 404-b to the wireless communication device 402. In examples in which the first PPDU 410 indicates a requested or commanded state associated with the IM mode for the second PPDU 420, the wireless communication device 404-a and/or the wireless communication device 404-b may transmit the second PPDU 420 in accordance with the requested or commanded state. The wireless communication device 404-a and/or the wireless communication device 404-b may comply with or otherwise use the requested or commanded state immediately after receiving the first PPDU 410 or some duration after receiving the first PPDU 410. Such a duration may be associated with a capability of the wireless communication device 404-a and/or the wireless communication device 404-b or may be associated with a condition experienced by the wireless communication device 404-a and/or the wireless communication device 404-b, among other examples. Alternatively, in some examples, the wireless communication device 404-a and/or the wireless communication device 404-b may ignore the requested or commanded state.

The second PPDU 420, which may be an example of another UHR-MU PPDU, may include a preamble portion 422 and a data portion 424. The wireless communication device 404-a and/or the wireless communication device 404-b may include, within the preamble portion 422 of the second PPDU 420, information 426 indicative of a state associated with the IM mode for the second PPDU 420. The data portion 424 may include a data field 428, which the wireless communication device 404-a and/or the wireless communication device 404-b may transmit in accordance with the state associated with the IM mode indicated by the information 426. In some examples, the state associated with the IM mode that the wireless communication device 404-a and/or the wireless communication device 404-b uses to transmit the data field 428 of the second PPDU 420 may be in accordance with a requested or commanded state indicated by the first PPDU 410. In some other examples, the wireless communication device 404-a and/or the wireless communication device 404-b may autonomously select the state associated with the IM mode that the wireless communication device 404-a and/or the wireless communication device 404-b uses to transmit the data field 428 of the second PPDU 420. The wireless communication device 402 may receive the second PPDU 420, parse the information 426, and parse the data field 428 in accordance with the indicated state associated with the IM mode. For example, the wireless communication device 402 may use a first receive processing scheme or procedure to receive (and decode, parse, or process) the data field 428 in examples in which the state associated with the IM mode is an OFF state and may use a second receive processing scheme or procedure to receive (and decode, parse, or process) the data field 428 in examples in which the state associated with the IM mode is an ON state.

In some UHR-MU PPDU usage scenarios, the wireless communication device 402, the wireless communication device 404-a, and/or the wireless communication device 404-b may include the information 416 and/or the information 426 (each of which may be understood as one or more IM mode signaling bits) within one or more fields of the preamble portion 412 and/or the preamble portion 422, respectively. In other words, one or more fields within the preamble portion 412 may include, carry, or provide the information 416 and one or more fields within the preamble portion 422 may include, carry, or provide the information 426. The wireless communication device 402, the wireless communication device 404-a, and/or the wireless communication device 404-b may generate the first PPDU 410 and/or the second PPDU 420 such that the information 416 and/or the information 426 are/is located within a common signaling portion of the preamble portion 412 and/or the preamble portion 422, respectively. In other words, the information 416 and the information 426 may be located outside of one or more user-specific fields, such as outside of one or more user information fields. Alternatively, in some implementations, (at least a portion of) the information 416 and (at least a portion of) the information 426 may be located within one or more user-specific fields, such as within one or more user information fields.

Such field(s) that may carry the information 416 and the information 426 may include a universal signal (U-SIG) field and/or a UHR signal (UHR-SIG) common field. In some examples, such field(s) may more specifically include a U-SIG version-dependent field or portion within the U-SIG field and/or a U-SIG overflow field within the UHR-SIG common field (which may be equivalently understood as a common field in a UHR-SIG field, or as one or more U-SIG overflow bits within a UHR-SIG common section). Some PPDU sub-types may be associated with different UHR-SIG field formats/definitions (depending on whether a PPDU is associated with an SU/NDP sub-type, a DL OFDMA sub-type, or a DL MU-MIMO sub-type), with each of such PPDU sub-types including one or more U-SIG overflow bits within a UHR-SIG common field. Some UHR PPDU sub-types (such as a DL OFDMA sub-type) may include 17 U-SIG overflow bits within a UHR-SIG common field and some other PPDU sub-types (such as non-OFDMA sub-types, such as an SU sub-type or an MU-MIMO sub-type) may include 16 U-SIG overflow bits within a UHR-SIG common field. Across such different PPDU sub-types, there may be a quantity of reserved (such as Validate and/or Disregard) bits within the version-dependent portion of the U-SIG field and the UHR-SIG common field, which the wireless communication device 402, the wireless communication device 404-a, and/or the wireless communication device 404-b may use/re-purpose/re-assign to carry IM mode information (such as the information 416 and/or the information 426).

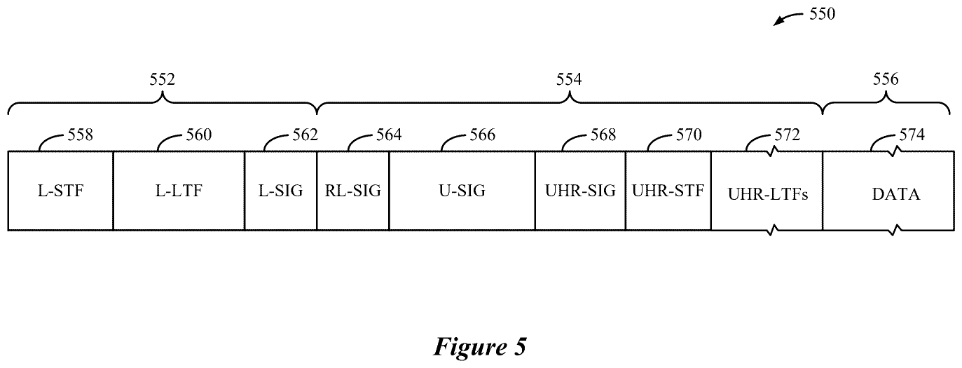

FIG. 5 shows an example PPDU 550 usable for communication between a wireless AP and one or more wireless STAs that supports IM mode signaling designs for a PPDU. For example, the AP and STAs may be examples of the AP 102 and the STAs 104 described with reference to FIG. 1. As shown, the PPDU 550 includes a PHY preamble (a preamble portion of the PPDU 550), that includes a legacy portion 552 and a non-legacy portion 554, and a payload 556 (a data portion of the PPDU 550) that includes a data field 574. The legacy portion 552 of the preamble includes an L-STF 558, an L-LTF 560, and an L-SIG 562. The non-legacy portion 554 of the preamble includes a repetition of L-SIG (RL-SIG) 564, a U-SIG field 566 and a UHR-SIG field 568.

The presence of RL-SIG 564 and U-SIG field 566 may indicate to UHR or later version-compliant STAs 104 that the PPDU 550 is a UHR PPDU or a PPDU conforming to any later (post-UHR) version of a new wireless communication protocol conforming to a future IEEE 802.11 wireless communication protocol standard. One or both of the U-SIG field 566 and the UHR-SIG field 568 may be structured as, and carry version-dependent information for, other wireless communication protocol versions associated with amendments to the IEEE family of standards beyond UHR. For example, the U-SIG field 566 may be used by a receiving device (such as an AP 102 or a STA 104) to interpret bits in one or more of the UHR-SIG field 568 or the data field 574. The U-SIG field 566 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication).

The version-dependent fields may include format information fields used for interpreting other fields of the U-SIG field 566 and the UHR-SIG field 568 and additional information fields or SU-specific fields that may be useful to intended recipients. In some implementations, the version-dependent fields may include at least a PPDU format field to indicate a general PPDU format for the PPDU 550 (such as a trigger-based (TB), an SU, or an MU PPDU format). Like L-STF 558, L-LTF 560, and L-SIG 562, the information in the U-SIG field 566 and the UHR-SIG field 568 may be duplicated and transmitted in each of the component 20 MHz channels in instances involving the use of a bonded channel.

The non-legacy portion 554 further includes an additional STF (referred to herein as a “UHR-STF 570,” although it may be structured as, and carry version-dependent information for, other wireless communication protocol versions beyond UHR) and one or more additional LTFs (referred to herein as “UHR-LTFs 572,” although they may be structured as, and carry version-dependent information for, other wireless communication protocol versions beyond UHR). The UHR-STF 570 may be used for timing and frequency tracking and AGC, and the UHR-LTF 572 may be used for more refined channel estimation.

The UHR-SIG field 568 may be used by an AP 102 to identify and inform one or multiple STAs 104 that the AP 102 has scheduled UL or DL resources for them. The UHR-SIG field 568 may be decoded by each compatible STA 104 served by the AP 102. The UHR-SIG field 568 also may generally be used by the receiving device to interpret bits in the data field 574. For example, the UHR-SIG field 568 may include RU allocation information, spatial stream configuration information, and per-user (such as STA-specific) signaling information. Each UHR-SIG field 568 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 574.

In accordance with some example implementations of the present disclosure, the U-SIG field 566 and/or the UHR-SIG field 568 may include, carry, or otherwise provide information indicative of a state associated with an IM mode for the PPDU 550 (such as an IM mode for the data field 574 of the PPDU 550) and/or for another PPDU. For example, one or more bits or subfields of the U-SIG field 566 and/or the UHR-SIG field 568 may include, carry, or otherwise provide the information 416 or the information 426 as illustrated by and described with reference to FIG. 4. Such bit(s) or subfield(s) of the U-SIG field 566 and/or the UHR-SIG field 568 may include a version-dependent portion (such as a U-SIG version-dependent field) of the U-SIG field 566 and/or a UHR-SIG common field (such as a common field in the UHR-SIG field 568) one or more U-SIG overflow bis within the UHR-SIG common field) of the UHR-SIG field 568. A wireless communication device that receives the PPDU 550 may interpret the one or more bits or subfields of the U-SIG field 566 and/or the UHR-SIG field 568 to determine or otherwise ascertain the state associated with the IM mode for the PPDU 550 (and/or for another PPDU) and may receive at least the data field 574 of the PPDU 550 in accordance with the state associated with the IM mode (and/or may transmit or receive at least a data field of the other PPDU in accordance with the state associated with the IM mode).

In some implementations, a wireless communication device (such as the wireless communication device 402, the wireless communication device 404-a, or the wireless communication device 404-b) may use (such as re-purpose) a single bit from the version-dependent portion of the U-SIG field 566 and/or from the UHR common field of the UHR-SIG field 568 to indicate whether the payload 556 (the data portion or section) of the PPDU 550 has the IM mode enabled or disabled. In such implementations, a first value of the single bit may indicate that the IM mode is enabled (in an ON state) for the data field 574 of the PPDU 550 and a second value of the single bit may indicate that the IM mode is disabled (in an OFF state) for the data field 574 of the PPDU 550. In some examples, the wireless communication device may select the single bit from a group of unallocated (such as available) Disregard or Validate bits within the version-dependent portion of the U-SIG field 566 and/or from the UHR common field of the UHR-SIG field 568. In some networks, such implementations may be applicable to scenarios in which the PPDU 550 is associated with a DL SU/NDP sub-type, an UL SU/NDP sub-type, a DL OFDMA sub-type, or a DL MU-MIMO sub-type, among other examples.

Additionally, or alternatively, the wireless communication device (such as the wireless communication device 402, the wireless communication device 404-a, or the wireless communication device 404-b) may use (such as re-purpose) two or more bits from the version-dependent portion of the U-SIG field 566 and/or from the UHR common field of the UHR-SIG field 568 to indicate, convey, or create a “UHR Protocols” field, with an encoding of the two or more bits representing (such as indicating) an ON/OFF status for at least one of a set of UHR protocols. Such a set of UHR protocols may include protocols that are unable or not expected to be simultaneously enabled or may include UHR protocols that are able to be simultaneously enabled. For example, the set of protocols may include the IM mode, coordinated beamforming (COBF), frequency domain (FD) unequal modulation (UEQM), or coordinated spatial reuse (CSR), among other examples.

Different codepoints associated with the two or more bits may indicate that a corresponding protocol within the set of protocols is enabled (and may, at least in some examples, implicitly indicate that other protocols of the set are disabled). For example, a first codepoint (such as “00”) may indicate that none of the set of protocols are enabled for the PPDU 550, a second codepoint (such as “01”) may indicate that the IM mode is enabled for the PPDU 550, a third codepoint (such as “10”) may indicate that COBF is enabled for the PPDU 550, and a fourth codepoint (such as “11”) may indicate that FD UEQM is enabled for the PPDU 550. In some examples, the wireless communication device may select the two or more bits from a group of unallocated (such as available) Disregard or Validate bits within the version-dependent portion of the U-SIG field 566 and/or from the UHR common field of the UHR-SIG field 568.

Additionally, or alternatively, the wireless communication device (such as the wireless communication device 402, the wireless communication device 404-a, or the wireless communication device 404-b) may use (such as re-purpose) one or more bits from the version-dependent portion of the U-SIG field 566 and/or from the UHR common field of the UHR-SIG field 568 to indicate one or more parameters (such as one or more operational or operating parameters) associated with the IM mode. Such parameters may depend on a design associated with the IM mode and may include, for example, parameters indicating information associated with a pattern of pilot tones, a quantity of pilot tones, and/or a pilot tone occurrence periodicity, among other examples. In some examples, the wireless communication device may select the one or more bits from a group of unallocated (such as available) Disregard or Validate bits within the version-dependent portion of the U-SIG field 566 and/or from the UHR common field of the UHR-SIG field 568. In some implementations, the wireless communication device may selectively or conditionally use such one or more bits to indicate the one or more parameters associated with the IM mode. For example, the wireless communication device may use the one or more bits to indicate the one or more parameters in examples in which the IM mode is enabled and may refrain from using the one or more bits to indicate the one or more parameters in examples in which the IM mode is disabled. In other words, a wireless communication device receiving the PPDU 550 may disregard a setting of the one or more bits if the IM mode is indicated to be disabled.

Additionally, or alternatively, the wireless communication device (such as the wireless communication device 402, the wireless communication device 404-a, or the wireless communication device 404-b) may use (such as re-purpose) a single bit from the version-dependent portion of the U-SIG field 566 and/or from the UHR common field of the UHR-SIG field 568 to indicate whether a payload (a data portion or section) of another (subsequent) PPDU is requested or commanded to have the IM mode enabled or disabled. In other words, the wireless communication device may use such a single bit to indicate that the wireless communication device is requesting or commanding that the IM mode be enabled or disabled for one or more PPDUs subsequently transmitted by another wireless communication device (one or more wireless communication devices receiving the PPDU 550) in the reverse direction of the link back to the wireless communication device. In such implementations, a first value of the single bit may indicate that the IM mode is requested or commanded to be enabled (in an ON state) for the data field of the subsequent PPDU(s) and a second value of the single bit may indicate that the IM mode is requested or commanded to be disabled (in an OFF state) for the data field of the subsequent PPDU(s). In some examples, the wireless communication device may select the single bit from a group of unallocated (such as available) Disregard or Validate bits within the version-dependent portion of the U-SIG field 566 and/or from the UHR common field of the UHR-SIG field 568. In some examples, one or more bits from the version-dependent portion of the U-SIG field 566 and/or from the UHR common field of the UHR-SIG field 568 may indicate one or more parameters associated with the IM mode requested or commanded to be used for the subsequent PPDU(s).

Additionally, or alternatively, the wireless communication device (such as the wireless communication device 402, the wireless communication device 404-a, or the wireless communication device 404-b) may use (such as re-purpose) one or more bits from the version-dependent portion of the U-SIG field 566 and/or from the common field of the UHR-SIG field 568 to provide an IM mode state indication in OFDMA. For example, the wireless communication device may use a quantity of bits to indicate a specific (such as single) RU or MRU for which a state associated with the IM mode is an ON state. The quantity of bits may be, for example, 9 bits (such as to indicate an RU or MRU from a complete set of RUs or MRUs defined in the 802.11be and 802.11bn specification). Additionally, or alternatively, the quantity of bits (such as the 9 bits) may include or indicate one state that indicates that none of the RUs or MRUs (such as from a complete set of RUs or MRUs defined in the 802.11be and 802.11bn specification) is in an IM mode. Alternatively, if the IM mode is prohibited or not expected for some RUs or MRUs (such as in accordance with a signaled or network specification-based rule, or in accordance with a rule of size of RUs or MRUs that enable the IM mode), the quantity of bits may be less than 9 bits (such as, for example, 6, 7, or 8 bits). In such examples, the quantity of bits may indicate that the IM mode is associated with an ON state for a single RU or MRU, which may implicitly indicate that the IM mode is associated with an OFF state for a remainder of RUs or MRUs allocated by the PPDU 550, or vice versa. Such an indication of a state associated with the IM mode on a per RU or MRU basis may indicate a state associated with the IM mode on a per wireless communication device basis in accordance with each RU or MRU allocated by the PPDU 550 being allocated to one or more wireless communication devices (such that a wireless communication device may expect an IM mode state in accordance with (the same as) an IM mode state indicated for an RU or MRU allocated to the wireless communication device).

Additionally, or alternatively, the wireless communication device (such as the wireless communication device 402, the wireless communication device 404-a, or the wireless communication device 404-b) may use (such as re-purpose) one or more entries of a table associated with one or more RU allocation subfields within the common field of the UHR-SIG field 568 to indicate a state associated with the IM mode. For example, an RU allocation subfield within the common field of the UHR-SIG field 568 may indicate an RU or MRU with the IM mode set to an ON state or an OFF state. In other words, an entry of a table associated with an RU allocation subfield (to which a codepoint of the RU allocation subfield may point) may indicate, for a corresponding RU or MRU, “x user(s) with IM mode set to an ON state.” Additionally, or alternatively, an entry of a table associated with an RU allocation subfield may indicate, for a corresponding RU or MRU, “x user(s) with IM mode set to an OFF state.” In some aspects, x=1.

In such examples, a first RU allocation subfield within the common field of the UHR-SIG field 568 may indicate a first RU or MRU and a first state associated with the first RU or MRU. By way of further example, a second RU allocation subfield within the common field of the UHR-SIG field 568 may indicate a second RU or MRU and a second state associated with the first RU or MRU. In some aspects, such an entry indicative of the IM mode state may be associated with a subset of RUs or MRUs. For example, an RU allocation subfield may indicate an IM mode state for RUs or MRUs associated with at least a threshold size (such as a size of greater than or equal to 242 tones or subcarriers) and may not indicate an IM mode state for RUs or MRUs associated with less than the threshold size (such as less than 242 tones or subcarriers). In examples in which the threshold size is equal to 242 tones or subcarriers, the subset of RUs or MRUs for which an RU allocation subfield may indicate an IM mode state may correspond to RUs or MRUs that may use MU-MIMO or non-MU-MIMO. For example, there may be 8 entries associated with RU996 in the RU allocation subfield to indicate from one to eight users being assigned to an RU996, as in the RU allocation subfield encoding in the 802.11be specification. These 8 entries may be interpreted to indicate from one to eight users being assigned to an RU996 with the IM mode in an OFF state in the RU996. Further, one entry may be added in the RU allocation subfield (by repurposing a reserved entry) to indicate one user being assigned to the RU996 with the IM mode in an ON state in the RU996.

Additionally, or alternatively, a first RU allocation subfield within the common field of the UHR-SIG field 568 may indicate a quantity of RUs or MRUs within a 20 MHz subband and may indicate each of the quantity of RUs or MRUs (such as with size smaller than 242 tones or subcarriers). In some aspects, such an entry indicative of the IM mode state may be associated with all RUs or MRUs within the quantity of RUs or MRUs within a 20 MHz subband. For example, all RUs or MRUs within one 20 MHz subband may be in a same IM mode state and each RU or MRU is assigned one user (in non-MU-M IMO). For example, there may be one entry in the RU allocation subfield, as in the RU allocation subfield encoding in the 802.11be specification, to indicate one user assigned to a first RU106, one user assigned to a center RU26, and one user assigned to a second RU106 within a 20 MHz subband. This entry may be interpreted to indicate one user assigned to a first RU106 with the IM mode in an OFF state, one user assigned to a center RU26 with the IM mode in an OFF state, and one user assigned to a second RU106 with the IM mode in an OFF state, within a 20 MHz subband. Further, one entry may be added in the RU allocation subfield (by repurposing a reserved entry) to indicate one user assigned to a first RU106 with the IM mode in an ON state, one user assigned to a center RU26 with the IM mode in an ON state, and one user assigned to a second RU106 with the IM mode in an ON state, within a 20 MHz subband.

Additionally, or alternatively, the wireless communication device (such as the wireless communication device 402, the wireless communication device 404-a, or the wireless communication device 404-b) may use (such as re-purpose) one or more bits from the version-dependent portion of the U-SIG field 566 and/or from the common field of the UHR-SIG field 568 to indicate a bitmap associated with a set of subbands. Each bit of the bitmap may be associated with a respective subband of the set of subbands and, in some implementations, each bit of the bitmap may indicate whether the IM mode for a corresponding subband is associated with an ON state or an OFF state. For example, a first bit of the bitmap may correspond to a first subband and a second bit of the bitmap may correspond to a second subband. A value of the first bit may indicate whether the IM mode for the first subband is associated with an ON state or an OFF state, a value of the second bit may indicate whether the IM mode for the second subband is associated with an ON state or an OFF state, and so on.

A size of the bitmap may depend on an operating or PPDU bandwidth and/or a granularity of the indicated subbands. For example, the bitmap may be a 4-bit bitmap to indicate IM mode ON/OFF for each 80 MHz subband within (up to) a 320 MHz PPDU bandwidth. By way of further example, the bitmap may be an 8-bit bitmap to indicate IM mode ON/OFF for each 40 MHz subband within (up to) a 320 MHz PPDU bandwidth. By way of further example, the bitmap may be a 16-bit bitmap to indicate IM mode ON/OFF for each 20 MHz subband within (up to) a 320 MHz PPDU bandwidth. In such examples in which the bitmap indicates a respective state associated with the IM mode for each subband of the set of subbands, an RU or MRU may inherit the state associated with the IM mode of the subband including at least a portion of the RU or MRU. In other words, a set of RUs or MRUs (at least partially) within a subband may have a same state associated with the IM as is indicated for the subband (such that, for example, the IM mode for all RU(s) or MRU(s) within a subband is either associated with an ON state or an OFF state). For instance, a union of one or more subbands for which the IM mode is associated with a same state (an ON state or an OFF state) may include one or more RUs or MRUs. In such examples, the wireless communication device 402 may indicate multiple RUs or MRUs having an IM mode associated with an ON state (via indications on a per subband basis). Therefore, the RU allocation subfields and the bitmap of IM mode indication may jointly indicate the RUs and MRUs in the IM mode in OFDMA.

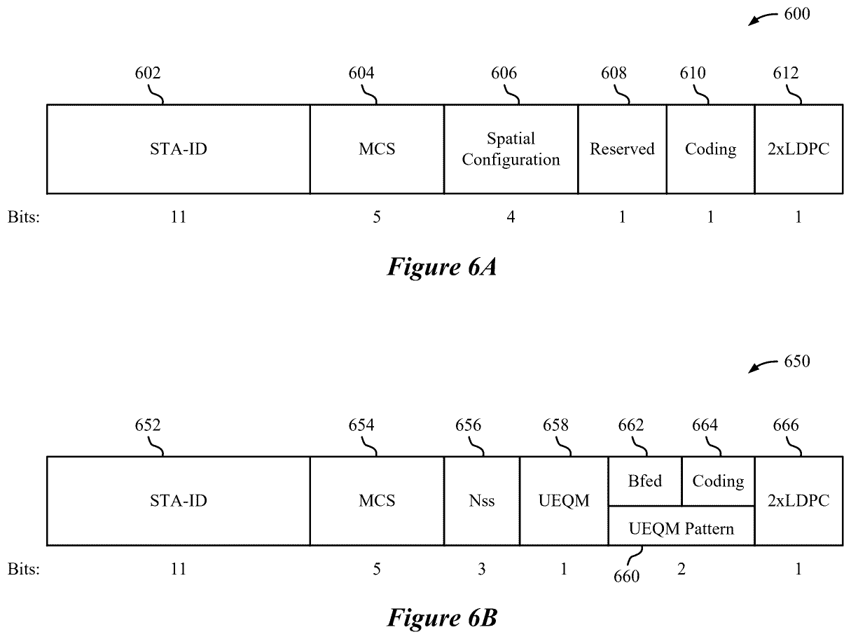

FIGS. 6A and 6B show example user information fields 600 and 650 that support IM mode signaling designs for a PPDU. The user information field 600 and the user information field 650 may each be an example of a user information field within, for example, the first PPDU 410 or the PPDU 550. For example, the preamble portion 412 of the first PPDU 410 may include the user information field 600 and/or the user information field 650. By way of further example, the UHR-SIG field 568 may include the user information field 600 and/or the user information field 650. The user information field 600 may be an example of an MU-MIMO user field and the user information field 650 may be an example of a non-MU-MIMO user field. The preamble portion 412 of the first PPDU 410 (and/or the UHR-SIG field 568) may include multiple user information fields, with each user information field associated with (addressed to) a respective wireless communication device.

The user information field 600 (an MU-MIMO user information field) may include a STA-ID subfield 602 of 11 bits, an MCS subfield 604 of 5 bits, a spatial configuration subfield 606 of 4 bits, a reserved bits subfield 608 of 1 bit, a coding subfield 610 of 1 bit, and a 2×LDPC subfield 612 of 1 bit. The user information field 650 (a non-MU-MIMO user information field) may include a STA-ID subfield 652 of 11 bits, an MCS subfield 654 of 5 bits, a number of spatial streams (Nss) subfield 656 of 3 bits, an UEQM subfield 658 of 1 bit to indicate if equal modulation (EQM) or UEQM is used, and a 2×LDPC subfield 666 of 1 bit to indicate if nominal LDPC codeword size of 3888 is used or not used. In examples in which the UEQM subfield 658 indicates that UEQM is used, the user information field 650 may include an UEQM pattern subfield 660 of 2 bits. In examples in which the UEQM subfield 658 indicates that UEQM is not used but EQM is used, the user information field 650 may include a beamformed subfield 662 (illustrated in the example of FIG. 6B as a “Bfed” subfield) of 1 bit and a coding subfield 664 of 1 bit to indicate if BCC or LDPC is used.

In some implementations, a wireless communication device (such as the wireless communication device 402, the wireless communication device 404-a, or the wireless communication device 404-b) may include an IM mode state indication within the user information field 600 and/or the user information field 650. For example, the wireless communication device may use (such as re-purpose) the coding subfield 610 of the user information field 600 and/or the coding subfield 664 of the user information field 650 to indicate a state associated with the IM mode for another wireless communication device addressed by the STA-ID subfield 602 and/or the STA-ID subfield 652, respectively. For example, a first value of the coding subfield 610 and/or the coding subfield 664 may indicate an ON state associated with the IM mode for the addressed wireless communication device and a second value of the coding subfield 610 and/or the coding subfield 664 may indicate an OFF state associated with the IM mode for the addressed wireless communication device. In some aspects, the wireless communication device may use the coding subfield 610 and/or the coding subfield 664 to indicate a state associated with the IM mode in MU-MIMO and/or in non-MU-MIMO with EQM.

In examples of non-MU-MIMO with UEQM, the wireless communication device may use (such as re-purpose) one or more bits (such as a single bit) within the Nss subfield 656 to indicate a state associated with the IM mode for the addressed wireless communication device. For example, the wireless communication device may use a most significant bit (MSB) within the Nss subfield 656 (such as bit 18 (B18) within the user information field 650) to indicate the state associated with the IM mode. By way of further example, a first value of the MSB within the Nss subfield 656 may indicate an ON state associated with the IM mode for the addressed wireless communication device and a second value of the MSB within the Nss subfield 656 may indicate an OFF state associated with the IM mode for the addressed wireless communication device.

In some examples, the wireless communication device may use the coding subfield 610, the coding subfield 664, and/or the MSB of the Nss subfield 656 to indicate a state associated with the IM mode in accordance with a size of an RU or MRU allocated to the addressed wireless communication device satisfying at least a threshold size (such as greater than 242 tones or subcarriers). In such examples, the wireless communication device may use the coding subfield 610, the coding subfield 664, and/or the MSB of the Nss subfield 656 to indicate a state associated with the IM mode for user information fields associated with an RU or MRU size of at least the threshold size (such as greater than 242 tones or subcarriers) and may refrain from using the coding subfield 610, the coding subfield 664, and/or the MSB of the Nss subfield 656 to indicate a state associated with the IM mode for user information fields associated with an RU or MRU size of less than the threshold size (such as less than or equal to 242 tones or subcarriers). In other words, the IM mode may be selectively applicable to a subset of RUs or MRUs (and not applicable to other RUs or MRUs), such as exclusively applicable to RUs or MRUs having a size greater than 242 tones or subcarriers.

Additionally, or alternatively, the wireless communication device may use a combination of one or more first bits within the U-SIG field 566 and/or the common field of the UHR-SIG field 568 and one or more second bits within the user information field 600 and/or the user information field 650 to indicate a state associated with the IM mode for the addressed wireless communication device. For example, a field that is applicable to multiple wireless communication devices (such as the U-SIG field 566 and/or the common field of the UHR-SIG field 568) may indicate whether the IM mode is associated with an ON state for at least one RU or MRU (and, likewise, for at least one wireless communication device addressed or allocated by the first PPDU 410). For example, a first value of one or more bits within the U-SIG field 566 and/or the common field of the UHR-SIG field 568 may indicate that the IM mode is associated with an ON state for at least one RU or MRU and a second value of the one or more bits within the U-SIG field 566 and/or the common field of the UHR-SIG field 568 may indicate that the IM mode is associated with an OFF state for (all of) the wireless communication devices addressed or allocated by the first PPDU 410. By way of further example, a single bit (such as a 1-bit subfield) within the U-SIG field 566 or the common field of the UHR-SIG field 568 may indicate that the IM mode is associated with an ON state for at least one RU or MRU.

A format or interpretation of a set of user information fields within the first PPDU 410 (including the user information field 600 and/or the user information field 650) may depend on, may be in accordance with, or may otherwise be associated with whether at least one RU or MRU allocated by the first PPDU 410 is associated with an IM mode ON state. For example, a format or interpretation of a set of user information fields may depend on a value of a 1-bit subfield within the U-SIG field 566 or the common field of the UHR-SIG field 568 (that indicates whether the IM mode is associated with an ON state for at least one RU or MRU). One or more wireless communication devices receiving the first PPDU 410 may interpret one or more user information fields of the set of user information fields in accordance with whether at least one RU or MRU allocated by the first PPDU 410 is associated with an IM mode ON state. In examples in which the IM mode is associated with an OFF state for (all of) the wireless communication devices addressed or allocated by the first PPDU 410, each user information field of the set of user information fields may exclude an indication of a state associated with the IM mode for a wireless communication device addressed by that user information field. Alternatively, in examples in which at least one RU or MRU allocated by the first PPDU 410 is associated with an IM mode ON state, each user information field of the set of user information fields may include a (1-bit) indication of a state associated with the IM mode for a wireless communication device addressed by that user information field.

In some of such examples in which the IM mode is associated with an ON state for at least one RU or MRU, a wireless communication device may use (such as re-purpose) the coding subfield 610 or the coding subfield 664 to indicate a state associated with the IM mode for another wireless communication device addressed by the user information field 600 or the user information field 650. The wireless communication device may use the coding subfield 610 or the coding subfield 664 to indicate a state associated with the IM mode in MU-MIMO and/or non-MU-MIMO with EQM. In such examples, various wireless communication devices may assume or expect (in accordance with a signaled or network specification-based rule) that, if the IM mode is associated with an ON state for at least one RU or MRU, the allocated RUs or MRUs (such as all allocated RUs or MRUs) use LDPC and do not use BCC. In examples of non-MU-MIMO with UEQM, the wireless communication device may use (such as re-purpose) one or more bits (such as an MSB) from the Nss subfield 656 to indicate a state associated with the IM mode for the wireless communication device addressed by the user information field 650.

In some others of such examples in which the IM mode is associated with an ON state for at least one RU or MRU, various wireless communication devices may assume or expect (in accordance with a signaled or network specification-based rule) that, if the IM mode is associated with an ON state for at least one RU or MRU, the allocated RUs or MRUs (such as all allocated RUs or MRUs) do not support MU-MIMO and, in non-MU-MIMO, there is support for up to 4 spatial streams. In such examples, a wireless communication device may use (such as re-purpose) one or more bits (such as an MSB) from an Nss subfield (such as the Nss subfield 656) to indicate a state associated with the IM mode for the wireless communication device addressed by that user information field.

In some others of such examples in which the IM mode is associated with an ON state for at least one RU or MRU, various wireless communication devices may assume or expect (in accordance with a signaled or network specification-based rule) that, if the IM mode is associated with an ON state for at least one RU or MRU, a set of (such as all) users use a 4-bit MCS table. In such examples, a wireless communication device may use (such as re-purpose) one or more bits (such as an MSB, such as bit 15 (B15)) of the MCS subfield 604 or the MCS subfield 654 to indicate a state associated with the IM mode for the wireless communication device addressed by the user information field 600 or the user information field 650. In examples in which the set of users use a 4-bit MCS table, the 4-bit MCS table may be associated with another (a different) generation MCS table (such as an EHT MCS table) or may be associated with a reduced size UHR MCS table. Such another generation MCS table is illustrated by Table 1 and such a reduced size UHR MCS table (associated with a 4-bit MCS field encoding design in IM) is illustrated by Table 2. The reduced size UHR MCS table may be associated with a replacement of MCS with DCM or 4 k QAM with four MCSs specifically associated with UHR (with 4 k QAM being less likely to be used in scenarios of uncoordinated OBSS interference).

TABLE 1
EHT MCS Field Encoding Design

| EHT-MCS Index | Code Rate | Modulation | DUP Mode |
|---|---|---|---|
| 0 | 1/2 | BPSK | No |
| 1 | 1/2 | QPSK | No |
| 2 | 3/4 | QPSK | No |
| 3 | 1/2 | 16QAM | No |
| 4 | 3/4 | 16QAM | No |
| 5 | 2/3 | 64QAM | No |
| 6 | 3/4 | 64QAM | No |
| 7 | 5/6 | 64QAM | No |
| 8 | 3/4 | 256QAM | No |
| 9 | 5/6 | 256QAM | No |
| 10 | 3/4 | 1024QAM | No |
| 11 | 5/6 | 1024QAM | No |
| 12 | 3/4 | 4096QAM | No |
| 13 | 5/6 | 4096QAM | No |
| 14 | 1/2 | BPSK-DCM | Yes |
| 15 | 1/2 | BPSK-DCM | No |

TABLE 2
4-bit MCS Field Encoding Design in IM

| UHR-MCS Index | Code Rate | Modulation | DUP Mode |
|---|---|---|---|
| 0 | 1/2 | BPSK | No |
| 1 | 1/2 | QPSK | No |
| 2 | 3/4 | QPSK | No |
| 3 | 1/2 | 16QAM | No |
| 4 | 3/4 | 16QAM | No |
| 5 | 2/3 | 64QAM | No |
| 6 | 3/4 | 64QAM | No |
| 7 | 5/6 | 64QAM | No |
| 8 | 3/4 | 256QAM | No |
| 9 | 5/6 | 256QAM | No |
| 10 | 3/4 | 1024QAM | No |
| 11 | 5/6 | 1024QAM | No |
| 12 | 2/3 | QPSK | No |
| 13 | 2/3 | 16QAM | No |
| 14 | 5/6 | 16QAM | No |
| 15 | 2/3 | 256QAM | No |

In some others of such examples in which the IM mode is associated with an ON state for at least one RU or MRU, various wireless communication devices may assume or expect (in accordance with a signaled or network specification-based rule) that, if the IM mode is associated with an ON state for at least one RU or MRU, 2×LDPC (using nominal LDPC codeword size of 3888) is disabled. In such examples, a wireless communication device may use (such as re-purpose) the 2×LDPC subfield 612 or the 2×LDPC subfield 666 to indicate a state associated with the IM mode for the wireless communication device addressed by the user information field 600 or the user information field 650.

In some aspects, each user information field within an MU-PPDU may be associated with a respective (single) wireless communication device. Alternatively, one or more user information fields within an MU-PPDU may be associated with one or more wireless communication devices. Additionally, or alternatively, one or more user information fields within an MU-PPDU may be unassociated with a specific wireless communication device. Such user information fields may indicate, for example, one or more RUs or MRUs for random access or one or more RUs or MRUs that are unallocated. Any one or more of such user information fields may include information indicative of a state associated with the IM mode for the corresponding RU(s) or MRU(s). Further, a user may be associated with (addressed by) multiple user information fields, with a first user information field providing a first portion of user-specific information and a second user information field providing a second portion of user-specific information (with, for example, the second portion including information indicative of a state associated with the IM mode for the user).

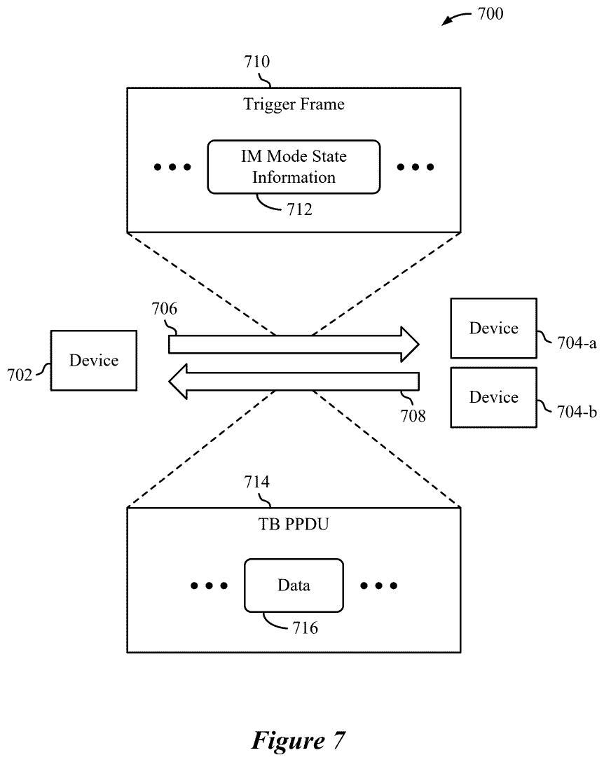

FIG. 7 shows an example signaling diagram 700 that supports IM mode signaling designs for a PPDU. The signaling diagram 700 may implement or be implemented to realize one or more aspects of the wireless communication network 100, the PDU 200, or the PPDU 300. For example, the signaling diagram 700 illustrates communication between a wireless communication device 702 and a wireless communication device 704-a and/or a wireless communication device 704-b. The wireless communication device 702 may be an example of a STA 104 or an AP 102, such as a STA 104 or an AP 102 as illustrated by and described with reference to FIG. 1. The wireless communication device 704-a and the wireless communication device 704-b may each be an example of a STA 104 or an AP 102, such as a STA 104 or an AP 102 as illustrated by and described with reference to FIG. 1.

The wireless communication device 702 and the wireless communication device 704-a and/or the wireless communication device 704-b may communicate with each other via a communication link 706 (which may be one of an UL or a DL, among other examples) and a communication link 708 (which may be the other of the UL or the DL, among other examples). In some examples, the wireless communication device 702 may transmit a trigger frame 710 to the wireless communication device 704-a and/or the wireless communication device 704-b via the communication link 706. The trigger frame 710 may be an example of a UHR trigger frame, such as a trigger frame soliciting a UHR-TB PPDU (which wireless communication devices may use for UL MU-MIMO and/or UL OFDMA transmission scenarios, among other examples). For example, the trigger frame 710 may solicit a TB PPDU 714 (or multiple TB PPDUs 714), which may be an example of a UHR-TB PPDU. In some examples, the TB PPDU 714 may include a U-SIG field and may exclude additional SIG fields. Further, in some examples, the wireless communication device 702 may potentially refrain from decoding the contents of the U-SIG field because the U-SIG field is carried by a triggered transmission.

To support an IM mode signaling indication in such scenarios of the trigger frame 710 soliciting the TB PPDU 714, the trigger frame 710 may carry the IM mode related signaling information. In other words, to solicit an UL MIMO or OFDMA transmission, the wireless communication device 702 may provide IM mode related signaling information within the trigger frame 710 that precedes (and solicits) the TB PPDU 714. For example, the wireless communication device 702 may include information 712 within the trigger frame 710, via which the wireless communication device 702 may signal to the wireless communication device 704-a and/or the wireless communication device 704-b how the IM mode is expected to be configured (including what a state associated with the IM mode is expected to be) for the upcoming TB PPDU 714. In such examples, and because the wireless communication device 702 may already know the state associated with the IM mode and operating parameter(s) associated with the IM mode, the wireless communication device 704-a and/or the wireless communication device 704-b may refrain from including IM mode related signaling information within the TB PPDU 714 itself. Alternatively, in some examples, the wireless communication device 704-a and/or the wireless communication device 704-b may include IM mode related signaling information (indicative of a state associated with the IM mode) within a TB PPDU 714.

In accordance with receiving the trigger frame 710 including the information 712 indicative of the state associated with the IM mode for the TB PPDU 714, the wireless communication device 704-a and/or the wireless communication device 704-b may generate and transmit at least a data field 716 of the TB PPDU 714 in accordance with the indicated state associated with the IM mode. The wireless communication device 702 may likewise receive (and decode, parse, or process) at least the data field 716 in accordance with the indicated state associated with the IM mode. For example, the wireless communication device 702 may use a first receive processing scheme or procedure to receive (and decode, parse, or process) the data field 716 in examples in which the state associated with the IM mode is an OFF state and may use a second receive processing scheme or procedure to receive (and decode, parse, or process) the data field 716 in examples in which the state associated with the IM mode is an ON state.

In examples in which the wireless communication device 702 solicits a TB PPDU 714 from each of the wireless communication device 704-a and the wireless communication device 704-b, the information 712 may indicate a respective state associated with the IM for each of the wireless communication device 704-a and the wireless communication device 704-b. For example, the information 712 may indicate a first state associated with the IM mode for the wireless communication device 704-a and may indicate a second state associated with the IM mode for the wireless communication device 704-b. The first state may be the same as or different than the second state, with each state (implicitly or explicitly) separately indicated.

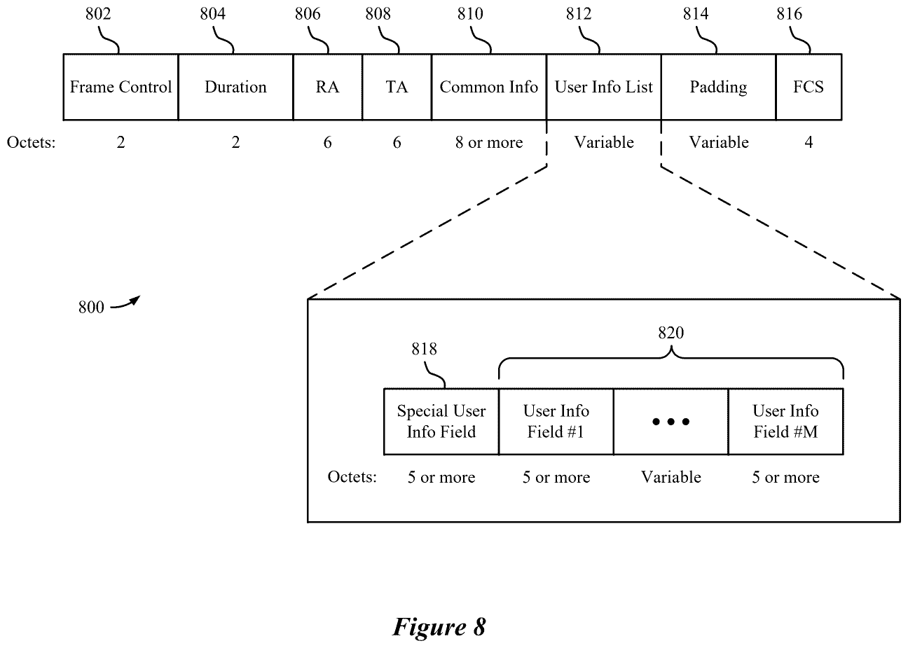

FIG. 8 shows an example trigger frame 800 that supports IM mode signaling designs for a PPDU. The trigger frame 800 may be an example of the trigger frame 710 as illustrated by and described with reference to FIG. 7. For example, the wireless communication device 702 may transmit the trigger frame 800 to solicit one or more TB PPDUs and may include, within the trigger frame 800, information 712 indicative of a state associated with the IM mode for the solicited TB PPDU(s).

The trigger frame 800 may include one or more of a frame control field 802 of 2 octets, a duration field 804 of 2 octets, a receiver address (RA) field 806 of 6 octets, a transmitter address (TA) field 808 of 6 octets, a common information field 810 (shown as a “common info” field in the example of FIG. 8) of 8 or more octets, a user information field list 812 (shown as a “user info list” in the example of FIG. 8) of a variable quantity of octets, a padding field 814 of a variable quantity of octets, and a frame check sequence (FCS) field 816 of 4 octets. In some examples, the trigger frame 800 may additionally include an information control field of a variable quantity of octets, which may be located between the padding field 814 and the FCS field 816. The RA field 806 may indicate whether the trigger frame 800 is individually addressed or a broadcast frame. The user information field list 812 may include any quantity of user information fields, including one or more special user information fields 818 and/or one more user information fields 820 (which may be user-specific fields). In the example of the trigger frame 800, the user information field list 812 may include a special user information field 818 (of 5 or more octets) and M user information fields 820 (each of 5 or more octets). In some networks, a special user information field 818 may be identified by a specific AID12 subfield value, such as an AID12 subfield value of 2007.

In accordance with some example implementations of the present disclosure, the common information field 810 and/or the special user information field 818 may include, carry, or otherwise provide information indicative of one or more states associated with an IM mode for one or more solicited TB PPDUs. For example, one or more bits or subfields of the common information field 810 and/or the special user information field 818 may include, carry, or otherwise provide the information 712 indicative of the state associated with the IM mode for the TB PPDU 714, as illustrated by and described with reference to FIG. 7. A wireless communication device that receives (and is addressed by) the trigger frame 800 may interpret the one or more bits or subfields of the common information field 810 and/or the special user information field 818 to determine or otherwise ascertain the state associated with the IM mode for the solicited TB PPDU and may transmit at least a data field of the TB PPDU in accordance with the state associated with the IM mode.

In some implementations, a wireless communication device (such as the wireless communication device 702, the wireless communication device 704-a, or the wireless communication device 704-b) may use (such as re-purpose) a single bit from the common information field 810 and/or the special user information field 818 to indicate whether the data field of the solicited TB PPDU has the IM mode enabled or disabled. In such implementations, a first value of the single bit may indicate that the IM mode is enabled (in an ON state) for the data field of the solicited TB PPDU and a second value of the single bit may indicate that the IM mode is disabled (in an OFF state) for the data field of the solicited TB PPDU. In some examples, the wireless communication device may select the single bit from a group of unallocated (such as available) reserved bits within the common information field 810 and/or the special user information field 818.

Additionally, or alternatively, the wireless communication device (such as the wireless communication device 702, the wireless communication device 704-a, or the wireless communication device 704-b) may use (such as re-purpose) two or more bits from the common information field 810 and/or the special user information field 818 to indicate, convey, or create a “UHR Protocols” field, with an encoding of the two or more bits representing (such as indicating) an ON/OFF status for at least one of a set of UHR protocols. Such a set of UHR protocols may include protocols that are unable or not expected to be simultaneously enabled or may include UHR protocols that are able to be simultaneously enabled. For example, the set of protocols may include the IM mode, coordinated UL MU-MIMO, FD UEQM, or CSR, among other examples.

Different codepoints associated with the two bits may indicate that a corresponding protocol within the set of protocols is enabled (and may, at least in some examples, implicitly indicate that other protocols of the set are disabled). For example, a first codepoint (such as “00”) may indicate that none of the set of protocols are enabled for the solicited TB PPDU, a second codepoint (such as “01”) may indicate that the IM mode is enabled for the solicited TB PPDU, a third codepoint (such as “10”) may indicate that coordinated UL MU-MIMO is enabled for the solicited TB PPDU, and a fourth codepoint (such as “11”) may indicate that FD UEQM is enabled for the solicited TB PPDU. In some examples, the wireless communication device may select the two or more bits from a group of unallocated (such as available) reserved bits within the common information field 810 and/or the special user information field 818.

Additionally, or alternatively, the wireless communication device (such as the wireless communication device 702, the wireless communication device 704-a, or the wireless communication device 704-b) may use (such as re-purpose) one or more bits from the common information field 810 and/or the special user information field 818 to indicate one or more parameters (such as one or more operational or operating parameters) associated with the IM mode. Such parameters may depend on a design associated with the IM mode and may include, for example, parameters indicating information associated with a pattern of pilot tones, a quantity of pilot tones, and/or a pilot tone occurrence periodicity, among other examples. In some examples, the wireless communication device may select the one or more bits from a group of unallocated (such as available) reserved bits within the common information field 810 and/or the special user information field 818. In some implementations, the wireless communication device may selectively or conditionally use such one or more bits to indicate the one or more parameters associated with the IM mode. For example, the wireless communication device may use the one or more bits to indicate the one or more parameters in examples in which the IM mode is enabled and may refrain from using the one or more bits to indicate the one or more parameters in examples in which the IM mode is disabled. In other words, a wireless communication device receiving the trigger frame 800 may disregard a setting of the one or more bits if the IM mode is indicated to be disabled.

Additionally, or alternatively, the wireless communication device (such as the wireless communication device 702, the wireless communication device 704-a, or the wireless communication device 704-b) may use (such as re-purpose) a quantity of bits from the common information field 810 and/or the special user information field 818 to indicate a specific (such as single) RU or MRU for which a state associated with the IM mode is an ON state. The quantity of bits may be, for example, 9 bits (such as to indicate an RU or MRU from a complete set of RUs or MRUs defined in the 802.11be and 802.11bn specification). Additionally, or alternatively, the quantity of bits (such as the 9 bits) may include or indicate one state that indicates that none of the RUs or MRUs (such as from a complete set of RUs or MRUs) is in an IM mode. Alternatively, if the IM mode is prohibited or not expected for some RUs or MRUs (such as in accordance with a signaled or network specification-based rule, or in accordance with a rule of size of RUs or MRUs that enable the IM mode), the quantity of bits may be less than 9 bits (such as, for example, 6, 7, or 8 bits). In such examples, the quantity of bits may indicate that the IM mode is associated with an ON state for a single RU or MRU, which may (separately) implicitly indicate that the IM mode is associated with an OFF state for a remainder of RUs or MRUs allocated by the trigger frame 800, or vice versa. Such an indication of a state associated with the IM mode on a per RU or MRU basis may indicate a state associated with the IM mode on a per wireless communication device basis in accordance with each RU or MRU allocated by the trigger frame 800 being allocated to one or more wireless communication devices (such that a wireless communication device may expect an IM mode state in accordance with (the same as) an IM mode state indicated for an RU or MRU allocated to the wireless communication device).

Additionally, or alternatively, the wireless communication device (such as the wireless communication device 702, the wireless communication device 704-a, and/or the wireless communication device 704-b) may use (such as re-purpose) one or more bits from the common information field 810 and/or the special user information field 818 to indicate a bitmap associated with a set of subbands. Each bit of the bitmap may be associated with a respective subband of the set of subbands and, in some implementations, each bit of the bitmap may indicate whether the IM mode for a corresponding subband is associated with an ON state or an OFF state. For example, a first bit of the bitmap may correspond to a first subband and a second bit of the bitmap may correspond to a second subband. A value of the first bit may indicate whether the IM mode for the first subband is associated with an ON state or an OFF state and a value of the second bit may indicate whether the IM mode for the second subband is associated with an ON state or an OFF state.

A size of the bitmap may depend on an operating or PPDU bandwidth and/or a granularity of the indicated subbands. For example, the bitmap may be a 4-bit bitmap to indicate IM mode ON/OFF for each 80 MHz subband within (up to) a 320 MHz PPDU bandwidth. By way of further example, the bitmap may be an 8-bit bitmap to indicate IM mode ON/OFF for each 40 MHz subband within (up to) a 320 MHz PPDU bandwidth. By way of further example, the bitmap may be a 16-bit bitmap to indicate IM mode ON/OFF for each 20 MHz subband within (up to) a 320 MHz PPDU bandwidth. In such examples in which the bitmap indicates a respective state associated with the IM mode for each subband of the set of subbands, an RU or MRU may inherit the state associated with the IM mode of the subband including at least a portion of the RU or MRU. In other words, a set of RUs or MRUs (at least partially) within a subband may have a same state associated with the IM as is indicated for the subband (such that, for example, the IM mode for all RU(s) or MRU(s) within a subband is either associated with an ON state or an OFF state). For instance, a union of one or more subbands for which the IM mode is associated with a same state (an ON state or an OFF state) may include one or more RUs or MRUs. In such examples, the wireless communication device 702 may indicate multiple RUs or MRUs having an IM mode associated with an ON state (via indications on a per subband basis). Therefore, RU allocations or assignments provided by the trigger frame 710 and the bitmap of IM mode indication may jointly indicate the RUs and MRUs in the IM mode in OFDMA.

Additionally, or alternatively, the wireless communication device (such as the wireless communication device 702, the wireless communication device 704-a, and/or the wireless communication device 704-b) may use (such as re-purpose) one or more bits from one or more user information fields 820 to indicate, carry, or otherwise provide the information 712 or a portion of the information 712. In some implementations, for example, the wireless communication device may use a coding subfield of a user information field 820 to indicate a state associated with the IM mode for another wireless communication device addressed by that user information field 820. For example, a coding subfield of a first user information field 820 associated with the wireless communication device 704-a may indicate a state associated with the IM mode for the wireless communication device 704-a and a coding subfield of a second user information field 820 associated with the wireless communication device 704-b may indicate a state associated with the IM mode for the wireless communication device 704-b. In such examples, the coding subfields may be used to indicate the states associated with the IM mode in accordance with the wireless communication device 704-a and the wireless communication device 704-b being allocated with one or more RUs or MRUs that satisfy at least a threshold size (such as greater than 242 tones or subcarriers). The coding subfield may not be used to indicate the states associated with the IM mode in accordance with the wireless communication device 704-a and the wireless communication device 704-b being allocated with one or more RUs or MRUs that fail to satisfy the threshold size (such as less than or equal to 242 tones or subcarriers).

Additionally, or alternatively, the wireless communication device may use a combination of one or more first bits within common information field 810 and/or the special user information field 818 and one or more second bits within a user information field 820 to indicate a state associated with the IM mode for an addressed wireless communication device. For example, a field that is applicable to multiple wireless communication devices (such as the common information field 810 and/or the special user information field 818) may indicate whether the IM mode is associated with an ON state for at least one RU or MRU (and, likewise, for at least one wireless communication device addressed, allocated, or triggered by the trigger frame 800). For example, a first value of one or more bits within the common information field 810 and/or the special user information field 818 may indicate that the IM mode is associated with an ON state for at least one RU or MRU and a second value of the one or more bits within the common information field 810 and/or the special user information field 818 may indicate that the IM mode is associated with an OFF state for (all of) the wireless communication devices addressed, allocated, or triggered by the trigger frame 800. By way of further example, a single bit (such as a 1-bit subfield) within the common information field 810 and/or the special user information field 818 may indicate that the IM mode is associated with an ON state for at least one RU or MRU.

A format or interpretation of the user information fields 820 within the trigger frame 800 may depend on, may be in accordance with, or may otherwise be associated with whether at least one RU or MRU allocated by the trigger frame 800 is associated with an IM mode ON state. For example, a format or interpretation of a set of user information fields 820 may depend on a value of a 1-bit subfield within the common information field 810 and/or the special user information field 818 (that indicates whether the IM mode is associated with an ON state for at least one RU or MRU). One or more wireless communication devices receiving the trigger frame 800 may interpret one or more user information fields 820 in accordance with whether at least one RU or MRU allocated by the trigger frame 800 is associated with an IM mode ON state. In examples in which the IM mode is associated with an OFF state for (all of) the wireless communication devices addressed or allocated by the trigger frame 800, each user information field 820 may exclude an indication of a state associated with the IM mode for a wireless communication device addressed by that user information field 820. Alternatively, in examples in which at least one RU or MRU allocated by the trigger frame 800 is associated with an IM mode ON state, each user information field 820 may include a (1-bit) indication of a state associated with the IM mode for a wireless communication device addressed by that user information field 820.

In some of such examples in which the IM mode is associated with an ON state for at least one RU or MRU, a wireless communication device may use (such as re-purpose) an uplink forward error correction (FEC) coding type subfield (bit 20 (B20)) of a user information field 820 to indicate a state associated with the IM mode for another wireless communication device addressed by the user information field 820. The wireless communication device may use the uplink FEC coding type subfield to indicate a state associated with the IM mode in accordance with assuming or expecting (in accordance with a signaled or network specification-based rule) that, if the IM mode is associated with an ON state for at least one RU or MRU, the allocated RUs or MRUs (such as all allocated RUs or MRUs) use LDPC and do not use BCC.

In some others of such examples in which the IM mode is associated with an ON state for at least one RU or MRU, various wireless communication devices may assume or expect (in accordance with a signaled or network specification-based rule) that, if the IM mode is associated with an ON state for at least one RU or MRU, the allocated RUs or MRUs (such as all allocated RUs or MRUs) do not support MU-MIMO. In such examples, a wireless communication device may use (such as re-purpose) one or more bits from a spatial stream (SS) allocation subfield of a user information field 820 to indicate a state associated with the IM mode for the wireless communication device addressed by the user information field 820. The one or more bits from the SS allocation subfield may include, for example, bit 2 (B2) of the SS allocation subfield. For example, a wireless communication device may use an MSB of the starting stream index subfield in regular RU (rRU) or a reserved bit in distributed RU (dRU) to indicate the state associated with the IM mode for the wireless communication device addressed by the user information field 820.

In some others of such examples in which the IM mode is associated with an ON state for at least one RU or MRU, various wireless communication devices may assume or expect (in accordance with a signaled or network specification-based rule) that, if the IM mode is associated with an ON state for at least one RU or MRU, a set of (such as all) users use a 4-bit MCS table. In such examples, a wireless communication device may use (such as re-purpose) one or more bits (such as an MSB, such as bit 25 (B25)) of an uplink UHR-MCS subfield of a user information field 820 to indicate a state associated with the IM mode for the wireless communication device addressed by the user information field 820. In examples in which the set of users use a 4-bit MCS table, the 4-bit MCS table may be associated with another (a different) generation MCS table (such as an EHT MCS table) or may be associated with a reduced size UHR MCS table. Such another generation MCS table is illustrated by Table 1 and such a reduced size UHR MCS table (associated with a 4-bit MCS field encoding design in IM) is illustrated by Table 2.

In some others of such examples in which the IM mode is associated with an ON state for at least one RU or MRU, various wireless communication devices may assume or expect (in accordance with a signaled or network specification-based rule) that, if the IM mode is associated with an ON state for at least one RU or MRU, 2×LDPC (using nominal LDPC codeword size of 3888) is disabled. In such examples, a wireless communication device may use (such as re-purpose) a 2×LDPC bit of a user information field 820 to indicate a state associated with the IM mode for the wireless communication device addressed by the user information field 820.

In some aspects, each user information field 820 within a trigger frame 800 may be associated with a respective (single) wireless communication device. Alternatively, one or more user information fields 820 within a trigger frame 800 may be associated with one or more wireless communication devices. Additionally, or alternatively, one or more user information fields 820 within a trigger frame 800 may be unassociated with a specific wireless communication device. Such user information fields 820 may indicate, for example, one or more RUs or MRUs for random access or one or more RUs or MRUs that are unallocated. Any one or more of such user information fields 820 may include information indicative of a state associated with the IM mode for the corresponding RU(s) or MRU(s). Further, a user may be associated with (addressed by) multiple user information fields, with a first user information field providing a first portion of user-specific information and a second user information field providing a second portion of user-specific information (with, for example, the second portion including information indicative of a state associated with the IM mode for the user).

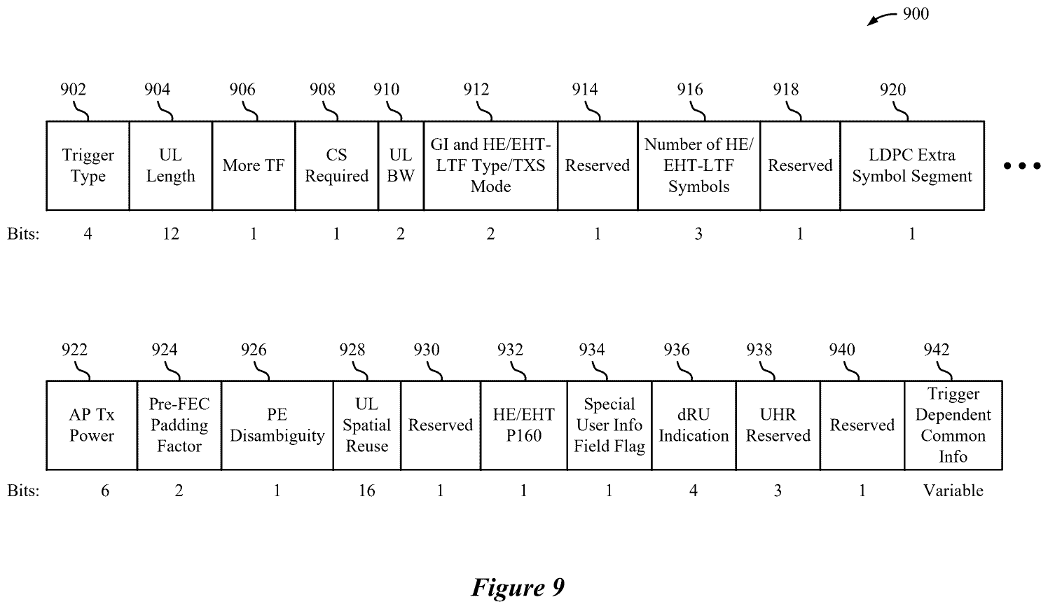

FIG. 9 shows an example common information field 900 that supports IM mode signaling designs for a PPDU. The common information field 900 may be an example of the common information field 810 as illustrated by and described with reference to FIG. 7. For example, the common information field 900 may include one or more bits and/or one or more subfields that indicate, carry, or otherwise provide information indicative of a state associated with an IM mode for a TB PPDU solicited by a trigger frame carrying the common information field 900.

The common information field 900 may include a trigger type subfield 902 of 4 bits, an UL length subfield 904 of 12 bits, a more trigger frame subfield 906 (shown as a “more TF” subfield in the example of FIG. 9) of 1 bit indicative of whether or not a subsequent Trigger frame is scheduled for transmission, a carrier sense (CS) required subfield 908 of 1 bit, an UL bandwidth subfield 910 of 2 bits, a guard interval (GI) and high efficiency (HE)/EHT-LTF type or TXOP sharing (TXS) mode subfield 912 of 2 bits, a reserved bits subfield 914 of 1 bit, a number of HE/EHT-LTF symbols subfield 916 of 3 bits, a reserved bits subfield 918 of 1 bit, an LDPC extra symbol segment subfield 920 of 1 bit, an AP transmit (Tx) power subfield 922 of 6 bits, a pre-FEC padding factor subfield 924 of 2 bits, a packet extension (PE) disambiguity subfield 926 of 1 bit, an UL spatial reuse subfield 928 of 16 bits, a reserved bits subfield 930 of 1 bit, an HE/EHT P160 subfield 932 of 1 bit, a special user information field flag subfield 934 (shown as a “special user info field flag” subfield in the example of FIG. 9) of 1 bit, a distributed RU (dRU) indication subfield 936 of 4 bits, a UHR reserved bits subfield 938 of 3 bits, a reserved bits subfield 940 of 1 bit, and a trigger dependent common information subfield 942 (shown as a “trigger dependent common info” subfield in the example of FIG. 9) of a variable quantity of bits.

In accordance with some example implementations of the present disclosure, a wireless communication device (such as the wireless communication device 702 or the wireless communication device 704) may use (such as re-purpose) any one or more of such fields and/or bits to include, carry, or otherwise provide information indicative of a state associated with an IM mode for a solicited TB PPDU. In other words, one or more bits or subfields of the common information field 900 may include, carry, or otherwise provide the information 712, or a portion of the information 712, indicative of the state associated with the IM mode for the TB PPDU 714, as illustrated by and described with reference to FIG. 7. For example, the wireless communication device may use one or more bits of one or more of the reserved bits subfield 914, the reserved bits subfield 918, the reserved bits subfield 930, the UHR reserved bits subfield 938, or the reserved bits subfield 940 to indicate, carry, or otherwise provide the information 712 or a portion of the information 712. By way of further example, the wireless communication device may use one or more bits from bit 56 (B56) to bit 63 (B63) (B56-B63), and especially from bit 60 (B60) to bit 63 (B63) (B60-B63), which may be (HE) backward compatible bits, of the common information field 900 to indicate, carry, or otherwise provide the information 712 or a portion of the information 712.

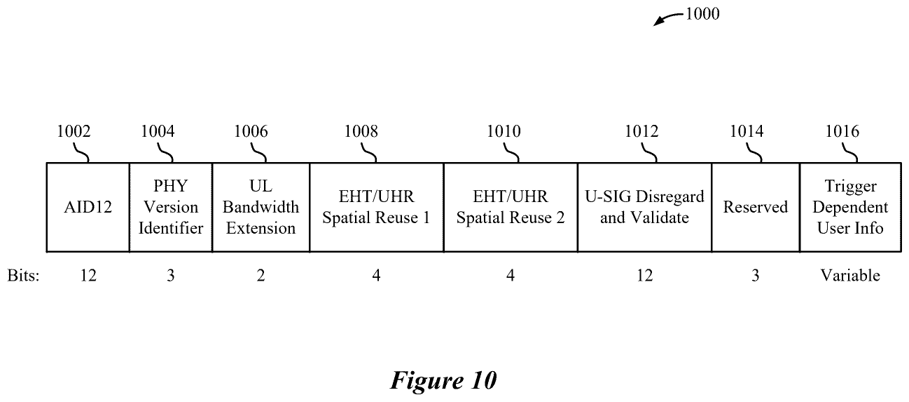

FIG. 10 shows an example special user information field 1000 that supports IM mode signaling designs for a PPDU. The special user information field 1000 may be an example of the special user information field 818 as illustrated by and described with reference to FIG. 8. For example, the special user information field 1000 may include one or more bits and/or one or more subfields that indicate, carry, or otherwise provide information indicative of a state associated with an IM mode for a TB PPDU solicited by a trigger frame carrying the special user information field 1000.

The special user information field 1000 may include an AID12 subfield 1002 (such as a 12-bit association identifier (AID) subfield) of 12 bits, a PHY version identifier subfield 1004 of 3 bits, an UL bandwidth extension subfield 1006 of 2 bits, a first EHT/UHR spatial reuse subfield 1008 (shown as an “EHT/UHR spatial reuse 1” subfield in the example of FIG. 10) of 4 bits, a second EHT/UHR spatial reuse subfield 1010 (shown as an “EHT/UHR spatial reuse 2” subfield in the example of FIG. 10) of 4 bits, a U-SIG disregard and validate subfield 1012 of 12 bits, a reserved bits subfield 1014 of 3 bits, and a trigger dependent user information subfield 1016 (shown as a “trigger dependent user info” subfield in the example of FIG. 10) of a variable quantity of bits.

In accordance with some example implementations of the present disclosure, a wireless communication device (such as the wireless communication device 702 or the wireless communication device 704) may use (such as re-purpose) any one or more of such fields and/or bits to include, carry, or otherwise provide information indicative of a state associated with an IM mode for a solicited TB PPDU. In other words, one or more bits or subfields of the special user information field 1000 may include, carry, or otherwise provide the information 712, or a portion of the information 712, indicative of the state associated with the IM mode for the TB PPDU 714, as illustrated by and described with reference to FIG. 7. For example, the wireless communication device may use one or more bits of the U-SIG disregard and validate subfield 1012 and/or the reserved bits subfield 1014 to indicate, carry, or otherwise provide the information 712 or a portion of the information 712. By way of further example, the wireless communication device may use one or more bits from bit 25 (B25) to bit 39 (B39) (B25-B39), which may be (EHT) backward compatible bits, of the special user information field 1000 to indicate, carry, or otherwise provide the information 712 or a portion of the information 712.

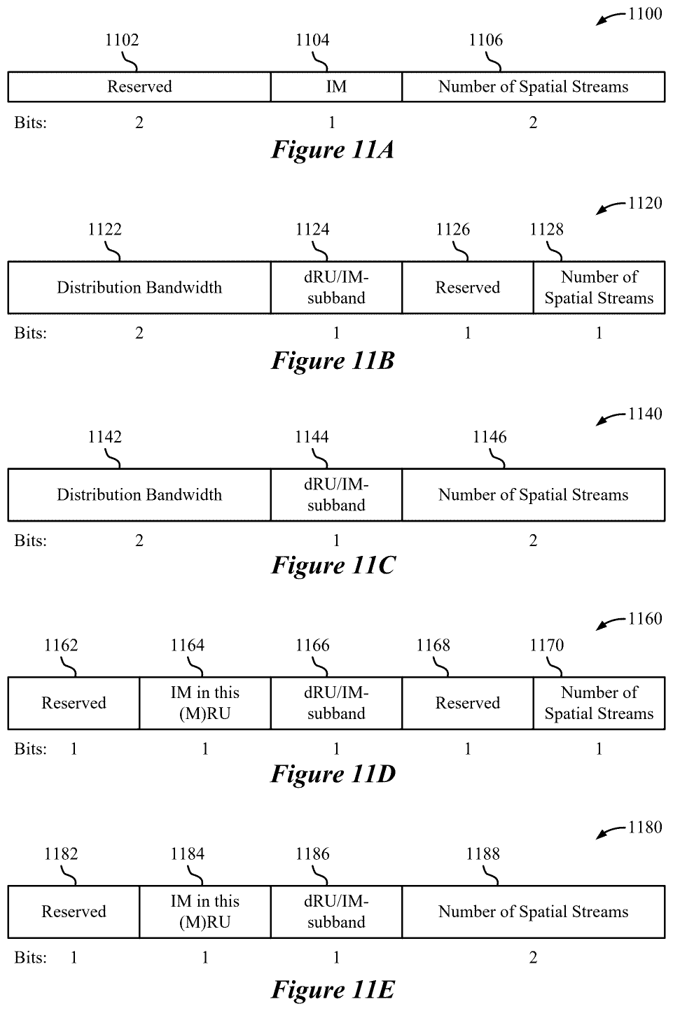

FIGS. 11A, 11B, 11C, 11D, and 11E show example subfield designs 1100, 1120, 1140, 1160, and 1180, respectively, that support IM mode signaling designs for a PPDU. The subfield designs 1100, 1120, 1140, 1160, and 1180 may be example designs of an SS allocation subfield within a user information field of a trigger frame, such as the trigger frame 710 as illustrated by and described with reference to FIG. 7. In accordance with the subfield design 1100, the subfield design 1120, the subfield design 1140, the subfield design 1160, or the subfield design 1180, an SS allocation subfield within a user information field may indicate, carry, or otherwise provide information indicative of a state associated with an IM mode for an RU or MRU assigned by that user information field within a TB PPDU solicited by a trigger frame.

In some implementations, the trigger frame may include a bitmap indication of an IM state for one or more triggered users (such as with a relatively coarser resolution) in a common information field of the trigger frame, such as the common information field 900 as illustrated by and described with reference to FIG. 9, or a special user information field of the trigger frame, such as the special user information field 1000 as illustrated by and described with reference to FIG. 10, and may include another indication (such as a 1-bit indication) of the IM state in one or more user information fields for an assigned RU or MRU and the corresponding one or more users. For example, the common information field or the special user information field of the trigger frame may include a 4-bit IM subband indication bitmap (with each bit corresponding to an 80 MHz subband, such as 1 bit per 80 MHz) to indicate whether the IM mode is associated with an ON state on a per-subband segment basis.

By way of further example, each bit of the 4-bit IM subband indication bitmap may indicate whether the IM mode is associated with an ON state for at least one user in a corresponding 80 MHz subband. In other words, in examples in which a bit of the bitmap indicates an ON state associated with the IM mode, the IM mode may be in an ON state for at least one RU or MRU within an 80 MHz subband corresponding to the bit. There may be one or more other RUs or MRUs within the 80 MHz subband with the IM mode associated with an OFF state.

In such implementations, in each user information field for which an assigned RU or MRU is at least partially overlapping with a subband (such as an 80 MHz subband) that is indicated by the bitmap to have at least one RU or MRU with the IM mode set to an ON state, MU-MIMO may be disabled, and a 5-bit SS allocation subfield may be associated with the subfield design 1100. In accordance with the subfield design 1100, the SS allocation subfield may include a 2-bit reserved bits subfield 1102, a 1-bit IM subfield 1104 indicative of a state associated with the IM mode for a user associated with the user information field in which the SS allocation subfield is present, and a 2-bit number of spatial streams subfield 1106 to indicate 1-4 spatial streams for a user associated with the user information field in which the SS allocation subfield is present.

Additionally, or alternatively, a wireless communication device may combine an IM subband indication bitmap (such as a 4-bit IM subband indication bitmap with 1 bit per 80 MHz subband) with a 4-bit dRU/rRU bitmap in B56-B59 of the common information field within the trigger frame, such as the common information field 900 as illustrated by and described with reference to FIG. 9. This 4-bit combined bitmap may be called a joint IM and dRU/rRU indication subfield. In such examples, a first value of a bit within the combined bitmap may indicate that a corresponding 80 MHz subband has rRU with the IM mode set to an OFF state and a second value of a bit within the combined bitmap may indicate that the corresponding 80 MHz subband has dRU or rRU with the IM mode set to an ON state for at least one RU or MRU within the 80 MHz subband.

In such implementations, in each user information field for which an assigned RU or MRU is at least partially overlapping with a subband (such as an 80 MHz subband) that is indicated by the bitmap to have at least one RU or MRU with the IM mode set to an ON state, MU-MIMO may be disabled and a bit (such as a single bit, such as B2) within a 5-bit SS allocation subfield may indicate dRU/IM-subband. A first value of the bit may indicate dRU is ON (such that all RUs or MRUs within the corresponding 80 MHz subband are dRUs but not rRUs) and a second value of the bit may indicate that IM subband is ON (such that all RUs or MRUs within the corresponding 80 MHz subband are rRUs but not dRUs, and at least one RU or MRU within the corresponding 80 MHz subband has the IM mode set to an ON state). In examples in which the bit indicates that IM subband is ON, another bit (such as B1, which may be the second bit within the SS allocation subfield) may indicate whether the RU or MRU assigned by the user information field within which the SS allocation field is present has the IM mode set to an ON state or an OFF state.

For example, and as illustrated by the subfield design 1120, an SS allocation subfield may include a distribution bandwidth subfield 1122, a 1-bit dRU/IM subband subfield 1124, a 1-bit reserved bits subfield 1126, and a 1-bit number of spatial streams subfield 1128 to indicate 1-2 spatial streams for a user associated with the user information field in which the SS allocation subfield is present. The subfield design 1120 illustrates an example SS allocation subfield design in examples in which a bit within the joint IM and dRU/rRU indication subfield in the common information field for the corresponding subband (such as an 80 MHz subband) is (such as indicates) ON and in which the dRU/IM subband subfield 1124 indicates “dRU.”

By way of further example, and as illustrated by the subfield design 1140, an SS allocation subfield may include a 2-bit distribution bandwidth subfield 1142, a 1-bit dRU/IM-subband subfield 1144, and a 2-bit number of spatial streams subfield 1146 to indicate 1-4 spatial streams for a user associated with the user information field in which the SS allocation subfield is present. The subfield design 1140 illustrates an example SS allocation subfield design in examples in which a bit within the joint IM and dRU/rRU indication subfield in the common information field for the corresponding subband (such as an 80 MHz subband) is (such as indicates) ON and in which the dRU/IM-subband subfield 1144 indicates “dRU.”

By way of further example, and as illustrated by the subfield design 1160, an SS allocation subfield may include a 1-bit reserved bits subfield 1162, a 1-bit IM in this (M)RU subfield 1164 indicative of a state associated with the IM mode for a user associated with the user information field in which the SS allocation subfield is present, a 1-bit dRU/IM-subband subfield 1166, a 1-bit reserved bits subfield 1168, and a 1-bit number of spatial streams subfield 1170 to indicate 1-4 spatial streams for a user associated with the user information field in which the SS allocation subfield is present. The subfield design 1160 illustrates an example SS allocation subfield design in examples in which a bit within the joint IM and dRU/rRU indication subfield in the common information field for the corresponding subband (such as an 80 MHz subband) is (such as indicates) ON and in which the dRU/IM-subband subfield 1166 indicates “IM subband.”

By way of further example, and as illustrated by the subfield design 1180, an SS allocation subfield may include a 1-bit reserved bits subfield 1182, a 1-bit IM in this (M)RU subfield 1184 indicative of a state associated with the IM mode for a user associated with the user information field in which the SS allocation subfield is present, a 1-bit dRU/IM-subband subfield 1186, and a 2-bit number of spatial streams subfield 1188 to indicate 1-4 spatial streams for a user associated with the user information field in which the SS allocation subfield is present. The subfield design 1180 illustrates an example SS allocation subfield design in examples in which a bit within the joint IM and dRU/rRU indication subfield in the common information field for the corresponding subband (such as an 80 MHz subband) is (such as indicates) ON and in which the dRU/IM-subband subfield 1186 indicates “IM subband.”

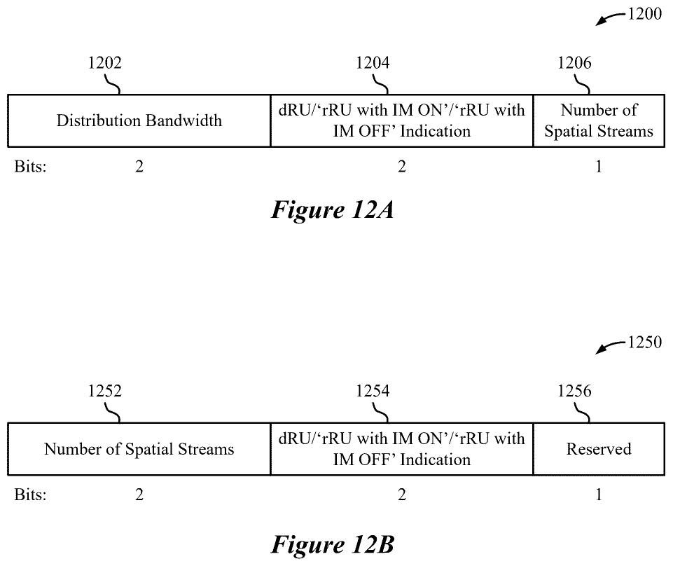

FIGS. 12A and 12B show example subfield designs 1200 and 1250, respectively, that support IM mode signaling designs for a PPDU. The subfield designs 1200 and 1250 may be example designs of an SS allocation subfield within a user information field of a trigger frame, such as the trigger frame 710 as illustrated by and described with reference to FIG. 7. In accordance with the subfield design 1200 or the subfield design 1250, an SS allocation subfield within a user information field may indicate, carry, or otherwise provide information indicative of a state associated with an IM mode for an RU or MRU assigned by that user information field within a TB PPDU solicited by a trigger frame.

In some implementations, and as illustrated by the subfield design 1200 and the subfield design 1250, in each user information field for which an assigned RU or MRU is at least partially overlapping with a subband (such as an 80 MHz subband) in which the a bit within the joint IM and dRU/rRU indication subfield in the common information field for the corresponding subband (such as an 80 MHz subband) is (such as indicates) ON, MU-MIMO may be disabled and a wireless communication device may use two bits (such as B2 and B3) in a 5-bit SS allocation subfield to indicate dRU/‘rRU with IM ON’/‘rRU with IM OFF’ for the currently assigned RU or MRU. For example, an SS allocation subfield may include a dRU/‘rRU with IM ON’/‘rRU with IM OFF’ indication subfield, with such a subfield indicating one of “dRU,” “rRU with IM ON,” or “rRU with IM OFF.”

For example, and as illustrated by the subfield design 1200, an SS allocation subfield may include a 2-bit distribution bandwidth subfield 1202, a 2-bit dRU/‘rRU with IM ON’/‘rRU with IM OFF’ indication subfield 1204, and a 1-bit number of spatial streams subfield 1206. The subfield design 1200 illustrates an example SS allocation subfield design in examples in which a bit within the joint IM and dRU/rRU indication subfield in the common information field for the corresponding subband (such as an 80 MHz subband) is (such as indicates) ON and in which the dRU/‘rRU with IM ON’/‘rRU with IM OFF’ indication subfield 1204 indicates “dRU.”

By way of further example, and as illustrated by the subfield design 1250, an SS allocation subfield may include a 2-bit number of spatial streams subfield 1252, a 2-bit dRU/‘rRU with IM ON’/‘rRU with IM OFF’ indication subfield 1254, and a 1-bit reserved bits subfield 1256. The subfield design 1250 illustrates an example SS allocation subfield design in examples in which a bit within the joint IM and dRU/rRU indication subfield in the common information field for the corresponding subband (such as an 80 MHz subband) is (such as indicates) ON and in which the dRU/‘rRU with IM ON’/‘rRU with IM OFF’ indication subfield 1254 indicates “rRU with IM ON” or indicates “rRU with IM OFF.”

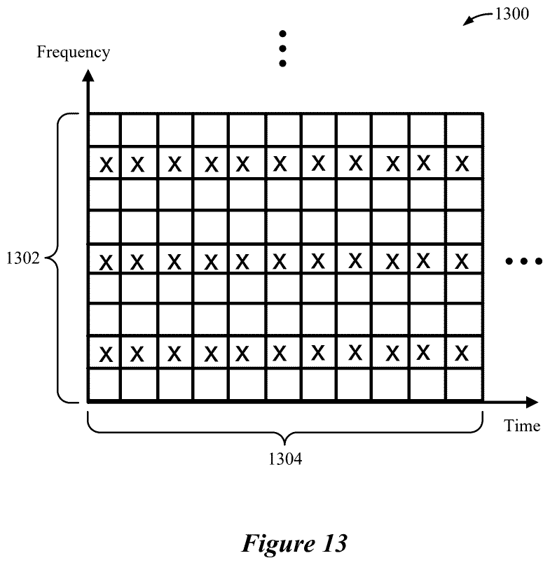

FIG. 13 shows an example pilot tone pattern 1300 that supports IM mode signaling designs for a PPDU. For example, a wireless communication device (such as any of the wireless communication device 402, the wireless communication device 404, the wireless communication device 702, and/or the wireless communication device 704) may transmit and/or receive a data portion (including one or more data fields) of a PPDU (such as a UHR-MU PPDU or a UHR-TB PPDU) in accordance with the pilot tone pattern 1300. The pilot tone pattern 1300 illustrates example pilot tone locations within a time-frequency resource grid associated with a data field of a PPDU. The time frequency resource grid includes a quantity of subcarriers 1302 (which may be equivalently referred to as “tones”) and a quantity of symbols 1304 (such as OFDM symbols). The pilot tones may be associated with, or may be examples of, null tones (having values of “0”) or tones having values of “+1” or “−1.” Pilot tones associated with the IM mode may be equivalently referred to as IM pilots or IM pilot sequences.

The pilot tone pattern 1300 may be an example of a “fixed position” pattern of pilot tones according to which pilot tones are located within a fixed set of non-contiguous subcarriers over a set of contiguous symbols. In other words, the pilots (or null valued) tones may be located at fixed subcarrier indices within the OFDM tone plan, throughout a set of (such as all) data OFDM symbols. The pilot tone locations may be interspersed across frequency, with some regular or approximately regular (such as even or approximately even) spacing between each subcarrier index carrying the pilots. In some implementations, multi-antenna receivers may estimate per-data-tone spatial covariances in accordance with pilot tone observations that are sparsely sampled across the PPDU bandwidth, such that a regular or approximately regular spacing between pilot locations in frequency may better facilitate a more accurate interpolation of covariance estimates at the in-between data tones. In some aspects, the pilots associated with the IM mode may be separate from additionally present CFO (phase tracking) pilots within the data field of the PPDU.

In some examples, a pilot allocation ratio (of a total quantity of available subcarriers) may be between approximately 15% and approximately 25%, with additional pilots being associated with a tradeoff between interference estimation resolution and overall data throughput, as IM mode pilots may reduce a quantity of available subcarriers to carry data in at least some OFDM symbols. In accordance with the IM mode signaling designs described herein, two or more communicating devices may more suitably coordinate on scenarios in which to enable the IM mode and scenarios in which to disable the IM mode. In other words, in accordance with the IM mode signaling designs described herein, two or more communicating devices may more dynamically or more suitably balance the tradeoff between interference estimation resolution and overall data throughput, such that the IM mode may be enabled in scenarios in which greater interference estimation resolution offers or is likely to offer greater system performance and such that the IM mode may be disabled in scenarios in which greater overall data throughput offers or is likely to offer greater system performance.

In some implementations, the two or more communicating devices may additionally support two or more options for pilot allocation ratios (in accordance with parameterizing one or more aspects associated with the pilot tones and/or the pilot tone locations) and dynamically (such as on a per-PPDU basis) switch between the different options for pilot allocation ratios. A parameter associated with the IM mode having the pilot tone pattern 1300 may indicate a spacing between each subcarrier index carrying pilots. For example, a spacing between subcarrier indices carrying pilots may be set to or indicated as one of a set of different (fixed or negotiated) values.

In some implementations, the two or more wireless communication devices may support a mapping between IM pilot locations and dRU tone mappings. In other words, IM pilot locations may be tied or correspond to dRU tone mappings. In some networks, for example, dRUs may be designed to have data tones interspersed at nearly or approximately equal intervals throughout a PPDU bandwidth, such that mapping the IM pilot locations to a dRU tone mapping may facilitate IM pilots to have pilot tones interspersed at nearly or approximately equal intervals throughout a PPDU bandwidth. In some aspects, different dRU sizes may have different “spreading/spacing” factors, and the IM pilot design may align pilot allocation ratios with the different dRU sizes. For example, and with reference to the pilot tone pattern 1300, the pilot locations may correspond to the dRU tone indices of a specific (such as single) RU index, for a set of (such as all) OFDM symbols.

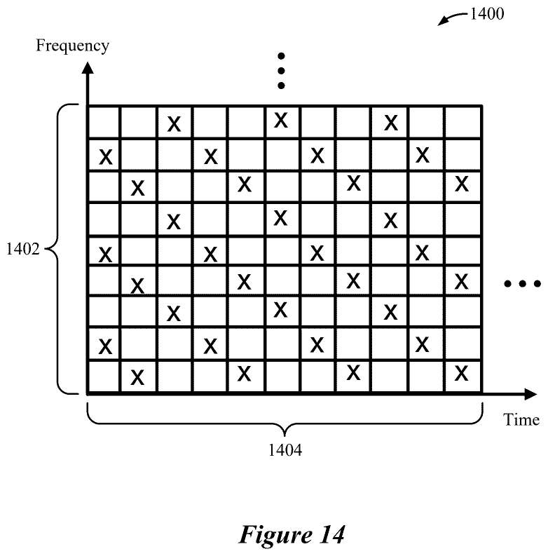

FIG. 14 shows an example pilot tone pattern 1400 that supports IM mode signaling designs for a PPDU. For example, a wireless communication device (such as any of the wireless communication device 402, the wireless communication device 404, the wireless communication device 702, and/or the wireless communication device 704) may transmit and/or receive a data portion (including one or more data fields) of a PPDU (such as a UHR-MU PPDU or a UHR-TB PPDU) in accordance with the pilot tone pattern 1400. The pilot tone pattern 1400 illustrates example pilot tone locations within a time-frequency resource grid associated with a data field of a PPDU. The time frequency resource grid includes a quantity of subcarriers 1402 (which may be equivalently referred to as “tones”) and a quantity of symbols 1404 (such as OFDM symbols). The pilot tones may be associated with, or may be examples of, null tones (having values of “0”) or tones having values of “+1” or “−1.”

The pilot tone pattern 1400 may be an example of “traveling” pattern of pilot tones according to which pilot tones are located within varying subcarriers over a set of contiguous symbols. In other words, in accordance with the pilot tone pattern 1400, the location of the pilot (or null) tones may change across OFDM symbols. For example, the pilot locations may circularly shift indices every OFDM symbol. In some implementations, an amount of the circular shift may be defined by a (signaled or configured) parameter and may include amounts such as 1, 2, or 3, among other examples. By way of example, the pilot tone pattern 1400 illustrates a circular shift of 1, according to which, for each next OFDM symbol, the subcarrier index carrying a pilot increments or decrements by 1 index. In other words, in the illustration of the pilot tone pattern 1400, the pilot location index may be circularly shifted “downwards” by 1 through time. By way of further example, a circular shift of 2 may indicate that, for each next OFDM symbol, the subcarrier index carrying a pilot increments or decrements by 2 indices. The amount of circular shift may be referred to as a shift value and, in some implementations, the shift value may indicate or determine a periodicity of the pilot tone pattern 1400 (which may refer to a quantity of OFDM symbols between times at which IM pilot indices repeat). A wireless communication device receiving a data field of a PPDU associated with the pilot tone pattern 1400 may perform covariance estimation interpolation in examples in which the pilot tones do not occupy a set of (such as every) subcarrier locations (such as every subcarrier location) in one complete “cycle” or “period.”

In some scenarios, such as in scenarios in which an interferer location and characteristics are (relatively) static relative to the OFDM symbol times, the pilot tone pattern 1400 may provide greater frequency resolution in the estimation of frequency selective interference (such as narrowband or wideband). Additionally, or alternatively, in some scenarios, the pilot tone pattern 1400 may allow for or otherwise facilitate lower pilot allocation ratios, which may incur less overhead due to IM mode pilots and may support higher data throughputs.

In some implementations, the two or more wireless communication devices may support a mapping between IM pilot locations and dRU tone mappings. In other words, IM pilot locations may be tied or correspond to dRU tone mappings. In such implementations, a set of dRUs may form possible sets of tones usable for IM pilots within a given OFDM symbol. To realize the pilot tone pattern 1400, a wireless communication device may select a first set of tones (which may correspond to a first dRU index) for a first OFDM symbol, a second set of tones (which may correspond to a second dRU index), for a second OFDM symbol, and so on. By way of further example, for a given OFDM symbol, the IM pilot locations may correspond to tone locations associated with (defined by) a dRU index 0 and, for a next OFDM symbol, the IM pilot locations may correspond to tone locations associated with (defined by) a dRU index 1 (which may mean that the pilot locations have cyclically shifted by 1 tone index from the previous symbol) and, for a further next OFDM symbol, the IM pilot locations may correspond to tone locations associated with (defined by) a dRU index 2, and so on. In other words, realizing IM pilot locations that travel with OFDM symbol index may be effectively similar to a wireless communication device selecting different dRU indices (for a given or same dRU size) for each OFDM symbol index.

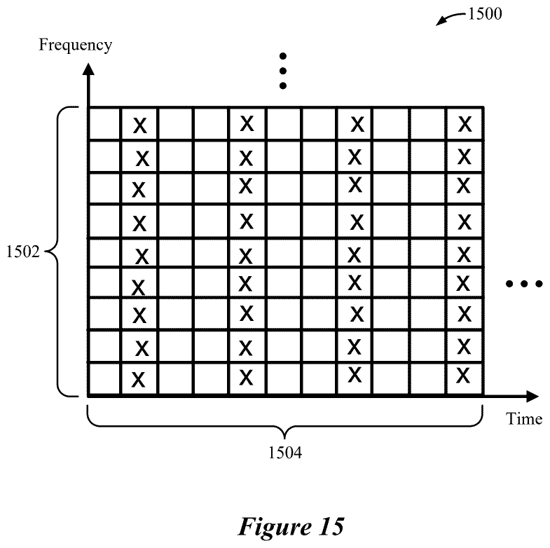

FIG. 15 shows an example pilot tone pattern 1500 that supports IM mode signaling designs for a PPDU. For example, a wireless communication device (such as any of the wireless communication device 402, the wireless communication device 404, the wireless communication device 702, and/or the wireless communication device 704) may transmit and/or receive a data portion (including one or more data fields) of a PPDU (such as a UHR-MU PPDU or a UHR-TB PPDU) in accordance with the pilot tone pattern 1500. The pilot tone pattern 1500 illustrates example pilot tone locations within a time-frequency resource grid associated with a data field of a PPDU. The time frequency resource grid includes a quantity of subcarriers 1502 (which may be equivalently referred to as “tones”) and a quantity of symbols 1504 (such as OFDM symbols). The pilot tones may be associated with, or may be examples of, tones having values of “+1” or“−1.” In some implementations, a wireless communication device may not use null tones for pilot tones associated with the pilot tone pattern 1500, as some networks may expect an average OFDM symbol power to be maintained across time.

The pilot tone pattern 1500 may be an example of “midamble” pattern of pilot tones according to which pilot tones are located within a fixed set of contiguous subcarriers that spans a full bandwidth over a fixed set of non-contiguous symbols. In other words, in accordance with the pilot tone pattern 1500, IM pilots may be located within a set of one or more dedicated OFDM symbols (inserted or occurring periodically within the data OFDM symbols) such that, for the set of one or more dedicated OFDM symbols, all tones (such as all normal data tones) are used as pilot tones that may be used to estimate the spatial covariance of the interference across the entire PPDU bandwidth. In some implementations, the set of one or more dedicated OFDM symbols may additionally include one or more CFO pilots, which may be mapped separately. In some examples, CFO pilots may take priority over IM pilots. In such examples, if a CFO pilot and an IM pilot are expected to be mapped to a same time-frequency location, two or more communicating wireless communication devices may expect that the time-frequency location is used for the CFO pilot (and that the IM pilot is dropped or not included).

In some implementations, a parameter associated with the pilot tone pattern 1500 may indicate a periodicity according to which OFDM symbols dedicated to IM pilots occur. In such implementations, two or more wireless communication devices may signal the parameter, such as via a preamble of a PPDU or via a trigger frame. In some aspects, the periodicity of the OFDM symbols dedicated to IM pilots may influence an overhead associated with the IM pilots (such as the actual overhead on data throughput caused by using the IM Mode pilots).

In accordance with the pilot tone pattern 1500, from both a transmitter and a receiver point of view, a data OFDM symbol processing may be unaffected by the IM mode. For example, because the pilot tones associated with the IM mode are not interspersed with data in accordance with the pilot tone pattern 1500, an OFDM symbol may either be a data OFDM symbol (excluding pilot tones associated with the IM mode) or may be a dedicated midamble OFDM symbol (including, such as exclusively including, pilot tones associated with the IM mode, potentially along with one or more CFO pilot tones).

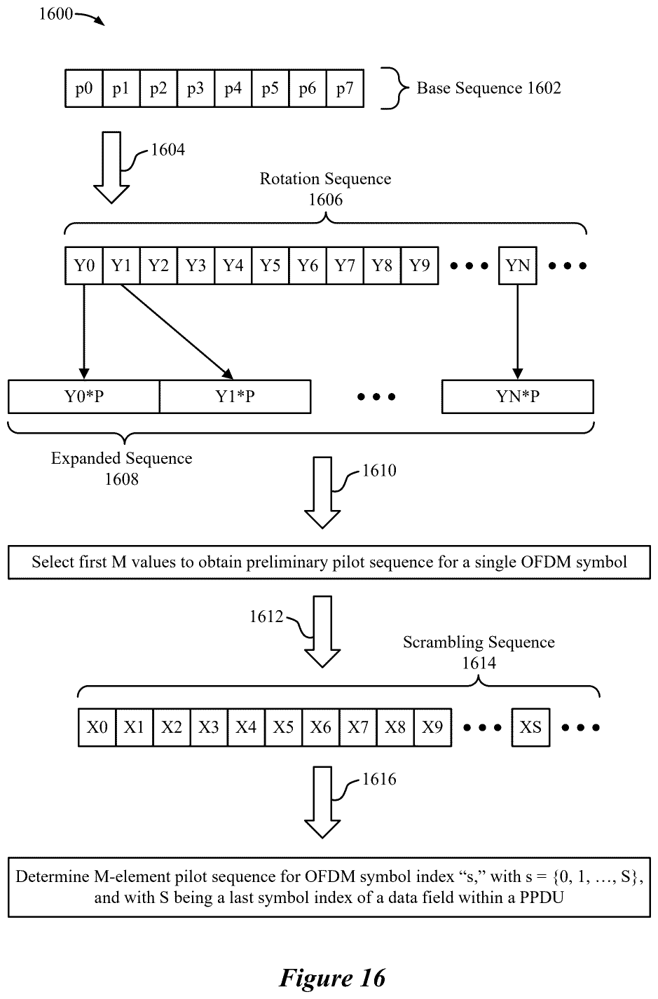

FIG. 16 shows an example pilot tone sequence generation procedure 1600 that supports IM mode signaling designs for a PPDU. A wireless communication device (such as any of the wireless communication device 402, the wireless communication device 404-a, the wireless communication device 404-b, the wireless communication device 702, the wireless communication device 704-a, and/or the wireless communication device 704-b) may select, identify, calculate, or otherwise determine values for the pilot tones associated with the IM mode. For example, in association with determining pilot subcarrier locations, the wireless communication device may determine the values carried by the IM pilots at the determined locations.

In some implementations, the wireless communication device may use or expect null tone values at the IM pilot locations. Such implementations may be applicable at least for the pilot tone pattern 1300 and the pilot tone pattern 1400. By using or expecting null tone values at the IM pilot locations, the wireless communication device may avoid applying an additional rotation sequence and/or pn-sequence spreading/scrambling, which may simplify both transmitter- and receiver-side operations associated with the IM mode. Further, if the IM pilot tones are given null values (which may be akin to the IM pilot tones being unmodulated), a transmitter of a PPDU for which the IM mode is enabled may be able to increase a transmit power of data subcarriers within an OFDM symbol that includes one or more IM pilot tones, which may support greater reliability by way of facilitating greater signal strength.

In some other implementations, the wireless communication device may use or expect +1/−1 values at the IM pilot locations. In such implementations, the wireless communication device may maintain similarly with LTF and/or CFO pilot construction schemes and apply rotations and pn-sequence scrambling to base sequences, which may avoid issues with powerlines in a transmission spectrum and/or issues with a transmission peak-to-average power ratio (PAPR) that might arise with straight (such as non-rotated and/or non-scrambled) periodic repetitions in frequency over time.

In some examples, the wireless communication device may use or expect +1/−1 values at the IM pilot locations by starting with a sequence (such as an LTF sequence) of +1/−1 values corresponding to a PPDU bandwidth and assigning, generating, selecting, or determining an M-element IM pilot sequence (in examples in which a quantity of the IM pilots for a given OFDM symbol is M) to be the sequence (such as the LTF sequence) sampled at tone indices corresponding to the IM pilot locations (in increasing frequency order). In examples in which the pilot tone pattern 1300 is used, the wireless communication device may be expected to apply a pn-sequence scrambling to the M-element IM pilot sequence per OFDM symbol. In examples in which the pilot tone pattern 1400 is used, the wireless communication device may optionally apply a pn-sequence to the M-element IM pilot sequence per OFDM symbol.

In some other examples, the wireless communication device may use or expect +1/−1 values at the IM pilot locations by assigning, generating, selecting, or determining an M-element pilot sequence as an M-element dRU LTF sequence. In such examples, the M-element dRU LTF sequence may be an M-element dRU LTF sequence used at a dRU index for a dRU size, with M being selected to correspond to the dRU size. M also may be a quantity of IM pilots within each OFDM symbol. The IM pilot locations may correspond to the tone indices of a defined or indicated dRU index (for the dRU size). In other words, in examples in which the quantity of IM pilots within a given OFDM symbol is M, M may be selected to correspond to a defined or indicated dRU size, with the IM pilot locations corresponding to the tone indices of a defined or indicated dRU index (for that dRU size), and with the IM pilot sequence being defined to be the same as the M-element dRU LTF sequence used at that dRU index for that dRU size. In examples in which the pilot tone pattern 1400 is used, the dRU index may change over or across OFDM symbols. In further examples in which the pilot tone pattern 1400 is used, the wireless communication device may optionally apply a pn-sequence scrambling to the IM pilot sequence per OFDM symbol. In examples in which the pilot tone pattern 1300 is used, the wireless communication device may be expected to apply a pn-sequence scrambling to the IM pilot sequence per OFDM symbol.

In some other examples, and in examples in which the pilot tone pattern 1300 is used, the wireless communication device may use or expect +1/−1 values at the IM pilot locations by using the +1/−1 value on that subcarrier index from a sequence (such as an LTF sequence) matching the PPDU bandwidth. In other words, the wireless communication device may use a sequence (such as an LTF sequence) of +1/−1 values corresponding to the PPDU bandwidth and map each value from the sequence to a respective subcarrier index across the PPDU bandwidth. In some aspects, to avoid disrupting CFO pilot tracking across the PPDU (such as a data portion of the PPDU), for the subcarrier indices of the OFDM midamble symbol corresponding to CFO pilot indices, the wireless communication device may use the CFO pilot value as if that OFDM symbol within the PPDU data field were a regular data symbol (such as an OFDM symbol that is not dedicated to IM pilots).

In some other examples, and as illustrated in the example of the pilot tone sequence generation procedure 1600, the wireless communication device may use or expect +1/−1 values at the IM pilot locations by starting with a base sequence 1602 of +1/−1 values. The base sequence 1602 may be denoted as a sequence P. The wireless communication device may obtain, generate, determine, or select the base sequence 1602 in accordance with various ways. In some examples, base sequence 1602 may be an 8-element +1/−1 base sequence used for CFO pilots in RU242. In examples in which a single OFDM symbol includes M pilots, with M being known and a fixed or variable quantity (such as controlled by signaling) for a given PPDU bandwidth, the wireless communication device may, for each OFDM symbol in the data portion of the PPDU, repeat the base sequence 1602 with each repetition chunk being applied with an overall +1/−1 rotation multiplier until a sequence of equal to or greater than M total+1/−1 values is constructed.

For example, the wireless communication device may obtain an expanded sequence 1608 by applying each +1/−1 value of a rotation sequence 1606 to a respective repetition of the base sequence 1602. In other words, the wireless communication device may obtain the expanded sequence 1608 by performing a multiplication 1604 of the base sequence 1602 by a rotation value from the overall rotation sequence 1606. The rotation sequence 1606 may be denoted as a sequence Y and may include +1/−1 values of Y0, Y1, . . . , YN. The wireless communication device may obtain the expanded sequence 1608 by determining Y0*P, P1*P, . . . , YN*P and concatenating the resulting sequences together. In some examples, N*8 may be greater than M, with M being the quantity of IM pilots per OFDM symbol. The wireless communication device may perform a selection 1610 of the first (such as initial) M values of the expanded sequence 1608 to obtain a preliminary M-element sequence. The preliminary M-element sequence may be the same for a set of (such as all) OFDM symbols of the PPDU bandwidth using M IM pilots.

The wireless communication device may perform a multiplication 1612 of the preliminary M-element sequence (the pilot sequence for a single OFDM symbol) by a scrambling value from a scrambling sequence 1614 (which may be a pn-sequence). The scrambling sequence 1614 may be denoted as a sequence X. In some aspects, the element of the scrambling sequence 1614 from which the scrambling value is selected may be a function of the OFDM symbol index in the data field of the PPDU. For example, the scrambling sequence 1614 may include elements of X0, X1, . . . , XS, . . . , and, by way of further example, X0 may correspond to a first OFDM symbol index of the data field, X1 may correspond to a second OFDM symbol index of the data field, and so on. In accordance with performing the multiplication 1612, the wireless communication device may perform a determination 1616 of an M-element pilot sequence for OFDM symbol “s,” with s={0, 1, . . . , S}, and with S being a last (such as final) symbol index of the data field within the PPDU. In other words, the pn-sequence scrambled M-element sequence may be the IM pilot values (ordered by increasing tone index) in an OFDM data symbol. In some aspects, the pilot tone sequence generation procedure 1600 may be applicable to scenarios in which the IM pilots are interspersed with data tones within a set of (such as each) OFDM symbol within the data field of the PPDU, and in scenarios in which the quantity of IM pilots per OFDM symbol is fixed or static for a given PPDU. The pilot tone sequence generation procedure 1600 may be at least applicable to scenarios in which the pilot tone pattern 1300 or the pilot tone pattern 1400 is used.

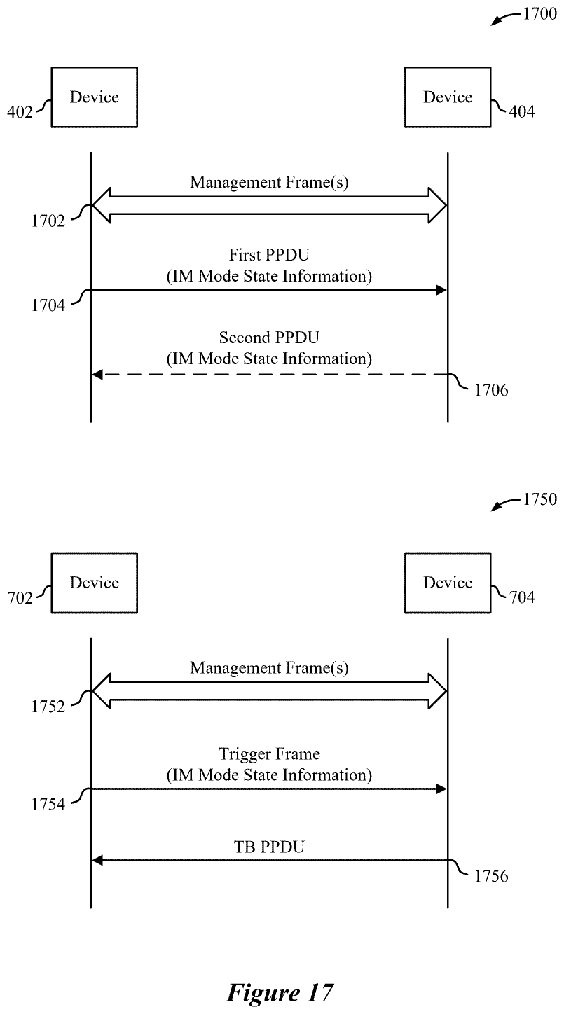

FIG. 17 shows example process flows 1700 and 1750 that support IM mode signaling designs for a PPDU. The process flows 1700 and 1750 may implement or be implemented to realize one or more aspects of the wireless communication network 100, the PDU 200, the PPDU 300, the signaling diagram 400, the PPDU 550, the signaling diagram 700, the trigger frame 800, the common information field 900, the special user information field 1000, the subfield designs 1100, 1120, 1140, 1160, 1180, 1200, and 1250, the pilot tone pattern 1300, the pilot tone pattern 1400, the pilot tone pattern 1500, or the pilot tone sequence generation procedure 1600. For example, the process flow 1700 illustrates communication between a wireless communication device 402 and a wireless communication device 404 (which may refer to one of the wireless communication device 404-a or the wireless communication device 404-b), which may be examples of corresponding devices as illustrated and described herein. By way of further example, the process flow 1750 illustrates communication between a wireless communication device 702 and a wireless communication device 704 (which may refer to one of the wireless communication device 704-a or the wireless communication device 704-b), which also may be examples of corresponding devices as illustrated and described herein.

Alternative examples of the following may be implemented. Some steps are performed in a different order than described or are not performed at all. In some implementations, steps may include additional features not mentioned below, or further steps may be added. Further, although example devices are shown performing the operations of the process flows 1700 and 1750, some aspects of some operations also may be performed by one or more other wireless communication devices without exceeding the scope of the present disclosure.

In the example of the process flow 1700, at 1702, the wireless communication device 402 and the wireless communication device 404 may communicate (such as transmit and/or receive) one or more management frames. The management frame(s) may include one or more beacon frames, one or more (re)association frames, and/or one or more (re)authentication frames. In some examples, at least one of the management frame(s) may include a capability element, which may indicate a capability of a device transmitting the management frame. For example, a capability element may indicate a capability of a device to support an IM mode for one or more PPDUs. In some implementations, in accordance with the communication of the management frame(s) at 1702, the wireless communication device 402 and the wireless communication device 404 may signal to each other that each device is capable of supporting the IM mode for PPDUs communicated between the wireless communication device 402 and the wireless communication device 404. Each device may indicate such a capability explicitly or implicitly, such as by indicating another capability (such as a capability to support UHR signaling protocols).

At 1704, the wireless communication device 402 may transmit a first PPDU to the wireless communication device 404. The first PPDU may be an example of the first PPDU 410 as illustrated by and described with reference to FIG. 4. In some implementations, the first PPDU may include a preamble portion and a data portion, and the preamble portion may include information indicative of a state associated with the IM mode for the first PPDU or for a second PPDU transmitted by the wireless communication device 404 to the wireless communication device 402. For example, the preamble portion may include first information indicative of a first state associated with the IM mode for the first PPDU and/or second information indicative of a second state associated with the IM mode for the second PPDU. In some aspects, the preamble portion of the first PPDU may additionally indicate one or more parameters associated with the IM mode (if the IM mode is enabled), the indicated parameter(s) being associated with the first PPDU and/or requested or commanded to be used for the second PPDU. Additionally, or alternatively, the preamble portion may include information indicative of a respective state associated with the IM mode for each wireless communication device of a set of multiple wireless communication devices including the wireless communication device 404 (as part of, for example, an OFDMA communication scheme or transmission). The wireless communication device 402 may transmit the first PPDU in accordance with the indicated state associated with the IM mode for the first PPDU (and in accordance with the parameter(s), if indicated). In some implementations, the wireless communication device 404 may receive at least a data field of the first PPDU in accordance with the state associated with the IM mode for the first PPDU (and in accordance with the one or more parameters, if indicated).

At 1706, the wireless communication device 404 may transmit the second PPDU to the wireless communication device 402 the second PPDU may be an example of the second PPDU 420 as illustrated by and described with reference to FIG. 4. In some implementations, the wireless communication device 404 may transmit at least a data field of the second PPDU in accordance with a requested or commanded state associated with the IM mode for the second PPDU. The second PPDU may include a preamble portion and a data portion, and the preamble portion may include information indicative of a state associated with the IM mode for the second PPDU. In some aspects, the preamble portion of the second PPDU may additionally indicate one or more parameters associated with the IM mode (if the IM mode is enabled). The wireless communication device 404 may transmit the second PPDU in accordance with the indicated state associated with the IM mode for the second PPDU (and in accordance with the parameter(s), if indicated). In some implementations, the wireless communication device 402 may receive at least a data field of the second PPDU in accordance with the state associated with the IM mode for the second PPDU (and in accordance with the one or more parameters, if indicated).

In the example of the process flow 1750, at 1752, the wireless communication device 702 and the wireless communication device 704 may communicate (such as transmit and/or receive) one or more management frames. The management frame(s) may include one or more beacon frames, one or more (re)association frames, and/or one or more (re)authentication frames. In some examples, at least one of the management frame(s) may include a capability element, which may indicate a capability of a device transmitting the management frame. For example, a capability element may indicate a capability of a device to support an IM mode for one or more PPDUs. In some implementations, in accordance with the communication of the management frame(s) at 1752, the wireless communication device 702 and the wireless communication device 704 may signal to each other that each device is capable of supporting the IM mode for PPDUs communicated between the wireless communication device 702 and the wireless communication device 704. Each device may indicate such a capability explicitly or implicitly, such as by indicating another capability (such as a capability to support UHR signaling protocols).

At 1754, the wireless communication device 702 may transmit a trigger frame to the wireless communication device 704, the trigger frame soliciting a TB PPDU from the wireless communication device 704. The trigger frame may be an example of the trigger frame 710 as illustrated by and described with reference to FIG. 7. In some examples, the trigger frame may include information indicative of a state associated with the IM mode for the TB PPDU. In some aspects, the trigger frame may additionally indicate one or more parameters associated with the IM mode (if the IM mode is enabled). Additionally, or alternatively, the trigger frame may include information indicative of a respective state associated with the IM mode for each wireless communication device of a set of multiple wireless communication devices including the wireless communication device 404 solicited by the trigger frame (as part of, for example, an OFDMA communication scheme or transmission).

At 1756, the wireless communication device 704 may transmit the TB PPDU to the wireless communication device 702. The wireless communication device 704 may transmit at least a data field of the TB PPDU in accordance with the state associated with the IM mode indicated by the trigger frame. In examples in which the IM mode is enabled and in which the trigger frame indicates one or more parameters associated with the IM mode, the wireless communication device 704 may transmit the data field of the TB PPDU in accordance with the one or more parameters. The wireless communication device 702 may receive the data field of the TB PPDU in accordance with the state associated with the IM mode indicated by the trigger frame (and in accordance with the one or more parameters, if indicated).

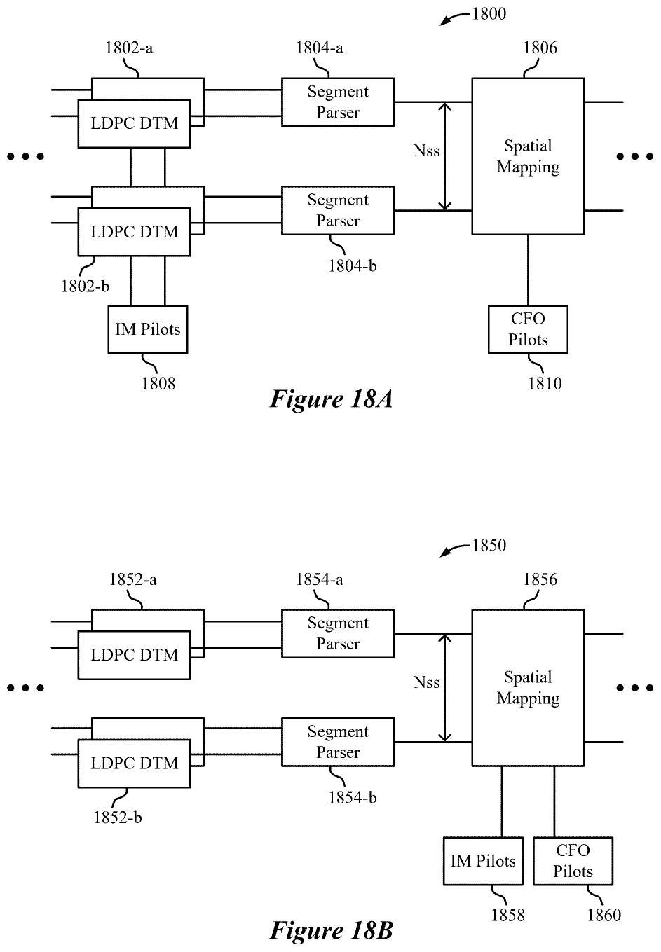

FIGS. 18A and 18B show transmit flows 1800 and 1850, respectively, that support IM mode signaling designs for a PPDU. In some examples, a wireless communication device may use (such as perform, apply, or employ) the transmit flow 1800 or the transmit flow 1850 to generate at least a data portion of a PPDU for which an IM mode is set to an ON state. The data portion may include pilot tones associated with the IM mode, such as in accordance with a pilot tone pattern 1300. The wireless communication device may use the transmit flow 1800 or the transmit flow 1850 to support one or more mechanisms according to which the wireless communication device may determine a location in a PPDU transmit flow at which the IM pilots may be inserted, a quantity of IM pilots to be included for each RU size, which OFDM symbol tones (such as tones in an RU) will carry the IM pilots, and changes to other aspects of PPDU transmit flows to account for the addition of the IM pilots, among other examples.

In some implementations, and as illustrated by the transmit flow 1800, the wireless communication device may interleave IM pilot locations within an RU in a manner that is relative and determined by LDPC tone mapping (such as via a DTM or interleaving operation). For example, the transmit flow 1800 may include one or more LDPC DTM stages including an LDPC DTM 1802-a and an LDPC DTM 1802-b, one or more segment parsers including a segment parser 1804-a and a segment parser 1804-b, and a spatial mapping 1806. The wireless communication device may add IM pilot tones 1808 prior to the LDPC DTM stage and, in some examples, may add CFO pilot tones 1810 prior to the spatial mapping 1806. In such implementations in which IM pilots are inserted prior to the LDPC DTM stage, N_{SD for Dtm}=N_{SD,original}=N_{SD,IM}+N_{IMP}, with N_{SD for Dtm} denoting the tones inserted into the LDPC DTM stage, N_{SD,original} may denote the tones inserted into the LDPC DTM stage in examples in which the IM mode was set to an OFF state, N_{SD,IM} may denote a quantity of data tones inserted into the LDPC DTM stage in examples in which the IM mode is set to an ON state, and N_{IMP} may denote a quantity of the IM pilot tones 1808. In accordance with the transmit flow 1800, packet length calculations may use N_{SD,IM} and the wireless communication device may refrain from changing D_{TM} because the LDPC interleaver block length (such as N_{SD for Dtm}) has not changed.

In such implementations, the wireless communication device may concatenate the IM pilot tones 1808 with data tones at the input to the LDPC DTM. Within an 80 MHz segment, the LDPC DTM may expect N_{SD} total tones and, for IM mode operation, the input to the LDPC DTM may be N_{SD}=N_{IMP}+N_{SD,IM}. The LDPC DTM may interleave the input tones according to the defined DTM parameter for the (M)RU, and the net result may be the IM pilot tones 1808 distributed across frequency subcarrier indices. By way of example, N_{SD}=16 with 4 IM pilot tones 1808 and 12 data tones, with a D_{TM} value equal to 4, may result in the IM pilot tones 1808 having a 4 tone spacing at the DTM output. Pilot tone locations may be relative within the subcarriers spanned by the (M)RU.

The wireless communication device may add IM pilots to facilitate accurate estimation of the interference profile across the frequency domain. In some examples, the wireless communication device may locate the IM pilot tones 1808 to be relatively evenly distributed across the OFDM tone plan, to allow for greater resolution in observing the interference. Pilot occupancy percentage may be a direct overhead on max PHY data rate, so the wireless communication device may support mechanisms to avoid unnecessarily defining high occupancy percentages or to avoid distributing pilots at tone locations that do not result in greater interference estimation. In some examples, the wireless communication device may evenly distribute N_{SD}/D_{TM} IM pilots at a pilot occupancy percentage of 1/D_{TM}, with an IM pilot occupancy percentage of greater than 1/D_{TM} resulting in wraparound effects in the DTM output (such that the IM pilot tones 1808 may no longer be regularly or evenly distributed and instead may be clustered within an RU).

In some implementations, the wireless communication device may select a value of N_{IMP} to be a multiple of N_{SD}/D_{TM} and such that IM pilot tones 1808 achieve a pilot occupancy percentage of between approximately 8% and approximately 20%. The wireless communication device may select a value of N_{SD} in accordance with the selection of the value of N_{IMP}. Some example values that the wireless communication device may select to support such operation are illustrated in Tables 3 and 4, shown below.

TABLE 3
Target Pilot Occupancy Range of between
approximately 16% and approximately 20%

| | RU | | | MRU |
|---|---|---|---|---|
| RU size | 242 | 484 | 996 | 484 + 242 |
| Nsd (orig.) | 234 | 468 | 980 | 702 |
| Dtm | 9 | 12 | 20 | 18 |
| 1/Dtm | 0.111 | 0.083 | 0.050 | 0.056 |
| Nsd/Dtm | 26 | 39 | 49 | 39 |
| 1/Dtm | 2 | 2 | 4 | 3 |
| “multiplier” | | | | |
| Nimp | 52 | 78 | 196 | 117 |
| Nsd, IM | 182 | 390 | 784 | 585 |
| Pilot Occ. % | 0.222 | 0.167 | 0.2 | 0.167 |

TABLE 4
Target Pilot Occupancy Range of between
approximately 8% and approximately 12%

| | RU | | | MRU |
|---|---|---|---|---|
| RU size | 242 | 484 | 996 | 484 + 242 |
| Nsd (orig.) | 234 | 468 | 980 | 702 |
| Dtm | 9 | 12 | 20 | 18 |
| 1/Dtm | 0.111 | 0.083 | 0.050 | 0.056 |
| Nsd/Dtm | 26 | 39 | 49 | 39 |
| 1/Dtm | 1 | 1 | 2 | 2 |
| “multiplier” | | | | |
| Nimp | 26 | 39 | 98 | 78 |
| Nsd, IM | 208 | 429 | 882 | 624 |
| Pilot Occ. % | 0.11 | 0.0833 | 0.1 | 0.0833 |

In some aspects, in an example of an RU size of 996 and a 20% target IM pilot occupancy percentage, the IM pilot tones 1808 may be spread across the RU in groups of 4 with 16 data tones between each group of 4 IM pilot tones 1808 (such that the IM pilot tones 1808 are “bunched” in groups of 4). Such a “bunching” of the IM pilot tones 1808 together may result in worse performance as compared to scenarios in which the IM pilot tones 1808 were more evenly distributed across the RU, such as in scenarios in which the IM pilot tones 1808 were located in 1 out of every 5 tones (which may result in a more accurate sampling of the frequency domain).

In some implementations, the wireless communication device may achieve such more even distribution by segmenting and re-arranging the IM pilot+data input prior to the LDPC DTM operation in a manner that leverages the “jump” interleaving properties of the LDPC DTM operation. In such implementations, a quantity of re-arranged input segments may equal the multiplier used to achieve a target pilot occupancy percentage (pilot occupancy percentage=multiplier*1/D_{TM}). The wireless communication device may segment and re-arrange the DTM input in accordance with RU size. In other words, the wireless communication device may perform a first segmenting and re-arranging operation for a first RU size and may perform a second segmenting and re-arranging operation for a second RU size. Such RU sizes may include RU996, RU484, RU242, and RU484+242, potentially among other examples. The wireless communication device may input the re-arranged tones into the LDPC DTM operation to obtain an output associated with a relatively more even spacing between the IM pilot tones 1808 across the RU.

For example, for an RU996 with a target pilot occupancy percentage of approximately 20%, the wireless communication device may re-arrange the input to the LDPC DTM stage such that the input includes multiple groups of 49 IM pilots with 196 data tones between each group of 49 IM pilots. By way of further example, for an RU996 with a target pilot occupancy percentage of approximately 10%, the wireless communication device may re-arrange the input to the LDPC DTM stage such that the input includes multiple groups of 49 IM pilots with 441 data tones between each group of 49 IM pilots.

By way of further example, for an RU484 with a target pilot occupancy percentage of approximately 16.7%, the wireless communication device may re-arrange the input to the LDPC DTM stage such that the input includes multiple groups of 39 IM pilots with 196 data tones between each group of 39 IM pilots. By way of further example, for an RU242 with a target pilot occupancy percentage of approximately 22%, the wireless communication device may re-arrange the input to the LDPC DTM stage such that the input includes multiple groups of 26 IM pilots with 104 data tones between each group of 26 IM pilots.

By way of further example, for an RU484+242 (an MRU484+242) with a target pilot occupancy percentage of approximately 16.7%, the wireless communication device may re-arrange the input to the LDPC DTM stage such that the input includes multiple groups of 39 IM pilots with 195 data tones between each group of 39 IM pilots. By way of further example, for an RU484+242 with a target pilot occupancy percentage of approximately 11%, the wireless communication device may re-arrange the input to the LDPC DTM stage such that the input includes multiple groups of 39 IM pilots with 312 data tones between each group of 39 IM pilots.

In some implementations, and as illustrated by the transmit flow 1850, the wireless communication device may insert IM pilots such that the IM pilots have fixed locations. The transmit flow 1850 may include one or more LDPC DTM stages including an LDPC DTM 1852-a and an LDPC DTM 1852-b, one or more segment parsers including a segment parser 1854-a and a segment parser 1854-b, and a spatial mapping 1856. The wireless communication device may add IM pilot tones 1858 and CFO pilot tones 1860 prior to the spatial mapping 1856. In accordance with the transmit flow 1850, IM pilot locations within an RU may be at fixed indices, such as indices defined by a network specification. In examples in which the IM pilot tones 1858 are inserted after the LDPC DTM stage, the tones for LDPC DTM interleaving may be N_{SD for Dtm}=N_{SD,IM}=N_{SD,original}−N_{IMP}. In such examples, packet length calculations may use N_{SD,IM} and an LDPC interleaver block length may change to N_{SD,IM}. Further, the wireless communication device may support one or more mechanisms to manage the LDPC DTM procedure in scenarios in which N_{SD for Dtm} is not evenly divisible by D_{TM}.

In such implementations, each RU or MRU may have a pre-defined subcarrier indices (such as tones) for IM pilots in scenarios in which the IM mode is set to an ON state. The pre-defined subcarrier indices may be chosen so that the IM pilot locations have an approximately fixed and even spacing across an entire channel bandwidth. In some implementations, a fixed IM pilot spacing of 6 tones within an RU may correspond to an approximate IM pilot overhead of 16.7%. In some implementations, a fixed IM pilot spacing of 9 tones within an RU may correspond to an approximate IM pilot overhead of 11.1%. In some implementations, a fixed IM pilot spacing of X tones within an RU may correspond to an approximate IM pilot overhead of 1/X %. In some implementations, the IM pilot tones 1858 may be selected to avoid conflicting with the CFO pilot tones 1860 defined for a set of (such as any) RU size.

In some aspects, IM pilot subcarrier locations may be selected such that a set of (M)RUs of a same size have the same N_{IMP} and N_{SD,IM}. In some aspects, the wireless communication device may define the IM pilot locations for (M)RUs such that they are common (such as overlap) with IM pilot locations of other (M)RU sizes in a same channel bandwidth. For each (M)RU, N_{SD} may be redefined as N_{SD,IM} in scenarios in which the IM mode is associated with an ON state. An input vector size, N_{SD,IM}, to the LDPC DTM may be smaller than an input vector size that is used in scenarios in which the IM mode is set to an OFF state for at least one (M)RU size (such as for every (M)RU size). The wireless communication device may use a different D_{TM} value for one or more (M)RU sizes (such as every (M)RU size) in scenarios in which the IM mode is set to an ON state as compared to scenarios in which the IM mode is set to an OFF state or may use a same D_{TM} value independent of the ON/OFF state of the IM mode.

In some implementations, the wireless communication device may select a value of N_{IMP} and a new D_{TM,IM} (which may be relatively similar to D_{TM} for RU), such that (N_{SD,IMP}% D_{TM,IM})=0. In some implementations, one or more extra IM pilot tones 1858 may be defined to enable the resulting N_{SD,IMP} to be evenly divisible by D_{TM,IM} (a D_{TM} exclusively used in scenarios in which the IM mode is set to an ON state). Examples of such values that the wireless communication device may select from are illustrated in Table 5, shown below.

TABLE 5
IM Pilot Locations Across Various RU Sizes, with a Target
IM Pilot Occupancy Percentage of Approximately 16.7%

| | RU996 | RU484 | RU242 | MRU484 + 242 |
|---|---|---|---|---|
| Npilot, cfo | 16 | 16 | 8 | 24 |
| Nsd, original | 980 | 468 | 234 | 702 |
| Nsd, im | 810 | 384 | 192 | 576 |
| Nimp | 170 | 84 | 42 | 126 |
| IM Pilots | {[−499:6:−7], | {[−499:6:−13]} | {[−499:6:−259]} | Union of |
| SCidx | [7:6:499]} | or | or | adjacent RU242 |
| | (166 total) | {[13:6:499]} | {[−253:6:−13]} | and RU484 |
| | | (82 total per | or | pilot indices, |
| | | RU) | {[13:6:253]} | per RU idx |
| | | | or | (123 total per |
| | | | {[259:6:499]} | RU) |
| | | | (41 total per | |
| | | | RU) | |
| Extra IM | {−500, −12, 12, | {−500, −12} | {−500}, | Union of |
| Pilots | 500} (4 extra) | or {12, 500} | {−12}, {12}, | adjacent RU242 |
| SCidx | | (2 extra per | {500} (1 | and RU484 |
| | | RU) | extra per RU) | pilot indices, |
| | | | | per RU idx (3 |
| | | | | extra per RU) |
| Original | 20 | 12 | 9 | 18 |
| Dtm | | | | |
| New Dtm | 18 | 12 | 8 | 16 |

By way of example for an RU996 size, in an 80 MHz segment, there may be one RU996. The wireless communication device may assign a total of 170 IM pilots at subcarrier locations not already assigned to CFO pilots, such as at 166 equally spaced 1 out of every 6 tones, at subcarrier indices [−499:6:7] and [7:6:499], with 4 extra at subcarrier indices −500, −12, 12, 500. In some implementations, IM pilot locations within all RUs of size 484, 242, and 484+242 in this 80 MHz segment may be a subset of the 170 IM pilots defined for this RU996. In some aspects, assigning 170 IM pilots corresponds to Nsd=810 as seen by the LDPC Interleaver. The original D_{TM}=20 may no longer be appropriate as 810 is not evenly divisible by this value, such that the wireless communication device may use a new D_{TM}=18 value will be specified for RU996, in scenarios in which the IM mode is enabled for the PPDU.

By way of further example for an RU484 size, in an 80 MHz segment, there may be two RU484s (such as RU_idx=0 and RU idx=1, within the segment). Table 6, below, shows the subcarrier indices for the regularly spaced IM pilots and the extra IM pilots for each of the two RUs in the segment. In some aspects, IM Pilot locations in an RU484 may be common with those of larger RU996 within their overlapping subcarrier indices. Additionally, each RU484 may fully contain two RU242s, and the IM pilot locations of each RU242 may overlap with the defined RU484 IM pilot locations.

TABLE 6
IM Pilot Locations for RU484 in an 80 MHz Segment

| | RU484 |
|---|---|
| Npilot, cfo | 16 |
| Nsd, original | 468 |
| Nsd, im | 384 |
| Nimp | 84 |

| | For RU_idx = 0 | For RU_idx = 1 |
|---|---|---|
| IM Pilots SCidx | [−499:6:−13] | [13:6:499] |
| (82 total per RU) | | |
| Extra IM Pilots | {−500, −12} | {12, 500} |
| SCidx | | |
| (2 total per RU) | | |

| | |
|---|---|
| Original Dtm | 12 |
| New Dtm | 12 |

By way of further example for an RU242 size, in an 80 MHz segment, there may be 4 RU242s (such as RU_idx=(0, 1, 2, 3) within the segment). Table 7, below, shows the subcarrier indices for the regularly spaced IM pilots and the extra IM pilots for each of the four RUs in the segment. In some aspects, for each RU242, the IM pilot locations may be common with those of larger RU484 and RU996 that overlap with the same subcarriers.

TABLE 7
IM Pilot Locations for RU242 in an 80 MHz Segment

| | RU242 | | | |
|---|---|---|---|---|
| Npilot, cfo | 8 | | | |
| Nsd, original | 234 | | | |
| Nsd, im | 192 | | | |
| Nimp | 42 | | | |
| | RU idx = 0 | RU idx = 1 | RU idx = 2 | RU idx = 3 |
| IM Pilots | [−499:6:−259] | [−253:6:−13] | [13:6:253] | [259:6:499] |
| SCidx | | | | |
| (41 total per | | | | |
| RU) | | | | |
| Extra IM | −500 | −12 | 12 | 500 |
| Pilots SCidx | | | | |
| (1 extra per | | | | |
| RU) | | | | |

| | |
|---|---|
| Original Dtm | 9 |
| New Dtm | 8 |

By way of further example for an RU484+242 size, in an 80 MHz segment, there may be 4 MRU484+242s (such as RU_idx (which may denote an “RU index”)={0, 1, 2, 3} within the segment). Table 8, below, shows the subcarrier indices for the regularly spaced IM pilots and the extra IM pilots for each of the four RUs in the segment. Location of IM pilots within each MRU484+242 may be the union of the IM pilot locations of the RU242 and RU484 that compose that MRU.

TABLE 8
IM Pilot Locations for RU484 + 242 in an 80 MHz Segment

| | MRU484 + 242 | | | |
|---|---|---|---|---|
| Npilot, cfo | 24 | | | |
| Nsd, original | 702 | | | |
| Nsd, im | 576 | | | |
| Nimp | 126 | | | |
| | RU idx = 0 | RU idx = 1 | RU idx = 2 | RU idx = 3 |
| | (RU484 idx1 + | (RU484 idx1 + | (RU484 idx0 + | (RU484 idx0 + |
| | RU242 idx1) | RU242 idx0) | RU242 idx3) | RU242 idx2) |
| IM Pilots | [13:6:499] | [13:6:499] | [−499:6:−13] | [−499:6:−13] |
| SCidx | and | and | and | and |
| (123 total per | [−253:6:−13] | [−499:6:−259] | [259:6:499] | [13:6:253] |
| RU) | | | | |
| Extra IM Pilots | −12, 12, 500 | −500 | −500, −12, 500 | −500, −12, 12 |
| SCidx | | | | |
| (3 extra per | | | | |
| RU) | | | | |

| | |
|---|---|
| Original Dtm | 18 |
| New Dtm | 16 |

The wireless communication device may support other target IM pilot occupancy percentages, such as a target IM pilot occupancy percentage of approximately 10%, approximately 13%, or approximately 9%, among other examples. Tables 9-11, below, illustrate example values to facilitate such target IM pilot occupancy percentages.

TABLE 9
IM Pilot Locations Across Various RU Sizes, with a Target
IM Pilot Occupancy Percentage of Approximately 10%

| | RU996 | RU484 | RU242 | MRU484 + 242 |
|---|---|---|---|---|
| Npilot, cfo | 16 | 16 | 8 | 24 |
| Nsd, original | 980 | 468 | 234 | 702 |
| Nsd, im | 874 | 416 | 208 | 624 |
| Nimp | 106 | 52 | 26 | 78 |
| IM Pilots | {[−491:10:−11], | {[−491:10:−21]} | {[−491:10:−261]} | Union of |
| SCidx | [11:10:491]} | or | or | adjacent |
| | (98 total) | {[21:10:491]} | {[−251:10:−21]} | RU242 and |
| | | (48 total per | or | RU484 pilot |
| | | RU) | {[21:6:251]} | indices, per |
| | | | or | RU idx |
| | | | {[261:10:491]} | (72 total per |
| | | | (24 total per | RU) |
| | | | RU) | |
| Extra IM | {−500, −259, −253, −12, | {−500, −259, −253, −12} | {−500, −259}, | Union of |
| Pilots | 12, 253, 259, | or | {−253, −12}, | adjacent |
| SCidx | 500} (8 extra) | {12, 253, 259, 500} | {12, 253} | RU242 and |
| | | (4 extra per RU) | {259, 500} (2 | RU484 pilot |
| | | | extra per RU) | indices, per |
| | | | | RU idx (6 |
| | | | | extra per RU) |
| Original | 20 | 12 | 9 | 18 |
| Dtm | | | | |
| New Dtm | 19 | 13 | 8 | 16 |

TABLE 10
IM Pilot Locations Across Various RU Sizes, with a Target
IM Pilot Occupancy Percentage of Approximately 13%

| | RU996 | RU484 | RU242 | MRU484 + 242 |
|---|---|---|---|---|
| Npilot, cfo | 16 | 16 | 8 | 24 |
| Nsd, original | 980 | 468 | 234 | 702 |
| Nsd, im | 850 | 406 | 203 | 609 |
| Nimp | 130 | 62 | 31 | 93 |
| IM Pilots | {[−497:8:−9], | {[−497:8:−265] | {[−497:8:−265]} | Union of |
| SCidx | [9:8:497]} | and | or | adjacent |
| | (124 total) | [−249:8:−17]} | {[−249:8:−17]} or | RU242 and |
| | | or | {[17:8:249]} | RU484 pilot |
| | | {[17:8:249] | or | indices, per RU |
| | | and | {[265:8:497]} | idx |
| | | [265:8:497]} | (30 total per | (90 total per |
| | | (60 total per | RU) | RU) |
| | | RU) | | |
| Extra IM | {−500, −257, −12, | {−500, −12} | {−500}, {−12}, | Union of |
| Pilots SCidx | 12, 257, 500} (6 | or {12, 500} | {12}, {500} (1 | adjacent |
| | extra) | (2 extra per | extra per RU) | RU242 and |
| | | RU) | | RU484 pilot |
| | | | | indices, per RU |
| | | | | idx (3 extra per |
| | | | | RU) |
| Original Dtm | 20 | 12 | 9 | 18 |
| New Dtm | 17 | 14 | 7 | 21 |

TABLE 11
IM Pilot Locations Across Various RU Sizes, with a Target
IM Pilot Occupancy Percentage of Approximately 9%

| | RU996 | RU484 | RU242 | MRU484 + 242 |
|---|---|---|---|---|
| Npilot, cfo | 16 | 16 | 8 | 24 |
| Nsd, original | 980 | 468 | 234 | 702 |
| Nsd, im | 882 | 420 | 210 | 630 |
| Nimp | 98 | 48 | 24 | 72 |
| IM Pilots | {[−496:11:−12], | {[−496:11:−265] | {[−496:11:−265]} | Union of |
| SCidx | [12:11:496]} | and | or | adjacent |
| | (90 total) | [−243:11:−12]} | {[−243:11:−12]} | RU242 and |
| | | or | or | RU484 pilot |
| | | {[12:11:243] | {[12:11:243]} | indices, per |
| | | and | or | RU idx |
| | | [265:11:496]} | {[265:11:496]} | (66 total per |
| | | (44 total per | (22 total per | RU) |
| | | RU) | RU) | |
| Extra IM | {−500, −259, −253, −13, | {−500, −259, −253, −13} | {−500, −259}, | Union of |
| Pilots | 13, 253, | or | {−253, −13}, | adjacent |
| SCidx | 259, 500} (8 | {13, 253, 259, 500} (4 | {13, 253}, | RU242 and |
| | extra) | extra per RU) | {259, 500} (2 | RU484 pilot |
| | | | extra per RU) | indices, per |
| | | | | RU idx (6 |
| | | | | extra per RU) |
| Original | 20 | 12 | 9 | 18 |
| Dtm | | | | |
| New Dtm | 18 | 12 | 7 | 18 |

In some implementations, the wireless communication device may support one or more additional interleavers, such as one or more additional interleaver equations, that are exclusively used in scenarios in which the IM mode is set to an ON state for a PPDU. Interleavers may be equivalently referred to as tone interleavers. Such an interleaver associated with the IM mode may be associated with an equation of (N_{SD}% D_{TM})≠0. In some implementations, the wireless communication device may use a D_{TM} value that is independent of whether the IM mode is ON or OFF. In some other implementations, the wireless communication device may support multiple D_{TM} values and, from the multiple D_{TM} values, may select a D_{TM} value that is exclusively used scenarios in which the IM mode is set to an ON state for a PPDU. Such a D_{TM} value that is associated with the IM mode may account for additional spacing introduced by IM pilot insertion.

In such implementations, a first interleaver may be associated with the IM mode (such as an IM mode state of ON) and a second interleaver may be associated with a non-IM mode (such as an IM mode state of OFF). The first interleaver may be associated with (such as defined by) Equations 1 and 2, shown below, with k=0, . . . , N_{SD}−1 (tone index in the RU without CFO pilots before interleaving) and t(k) being the tone index after LDPC interleaving.

$$t ( k ) = \{ \begin{matrix}{D}_{TM} ( k \% β ) + ( {N}_{SD} \% β ) + ⌊ \frac{k}{β} ⌋ , & ( k \% β ) > ( {N}_{SD} \% β ) \\ ( {D}_{TM} + 1 ) \cdot ( k \% β ) + ⌊ \frac{k}{β} ⌋ , & otherwise\end{matrix} \qquad ( 1 )$$

$$β = ⌊ \frac{{N}_{SD}}{{D}_{TM}} ⌋ \qquad ( 2 )$$

In the context of Equations 1 and 2, N_{SD} may be N_{SD,IM}. β may be a distribution parameter that defines a quantity of regions or bins over which the wireless communication device distributes tones. In some aspects, N_{SD}% β may be a threshold associated with a condition of the first interleaver. In such aspects, in examples in which the condition is satisfied for a given input tone index, such as in examples in which (k % β)>(N_{SD}% β), the wireless communication device may use a first tone mapping operation to convert that input tone index into an output tone index, such as D_{TM} (k % β)+(N_{SD}% β). In examples in which the condition is not satisfied for a given input tone index, such as in examples in which (k % β)≤(N_{SD}% β), the wireless communication device may use a second tone mapping operation to convert that input tone index into an output tone index, such as

$$( {D}_{T M} + 1 ) \cdot ( k \% β ) + ⌊ \frac{k}{β} ⌋ .$$

In other words, N_{SD}% β may be a threshold value associated with the condition (with the condition being satisfied in examples in which (k % β)>(N_{SD}% β). In some aspects, (N_{SD}% β) also may be understood as a tone adjustment, such as an adjustment term that may be specific to the first tone mapping operation. Additionally, or alternatively, N_{SD}% β may denote or correspond to a threshold bin index.

The second interleaver may be associated with (such as defined by) Equations 3 and 4, shown below, with k=0, . . . , N_{SD}−1 (tone index in the RU without CFO pilots before interleaving) and t(k) being the tone index after LDPC interleaving.

$$t ( k ) = {D}_{TM} ( k \% \frac{{N}_{SD}}{{D}_{TM}} ) + ⌊ \frac{k \cdot {D}_{TM}}{{N}_{SD}} ⌋ = {D}_{TM} ( k \% β ) + ⌊ \frac{k}{β} ⌋ \qquad ( 3 )$$

$$β = \frac{{N}_{SD}}{{D}_{TM}} \qquad ( 4 )$$

The first and second interleavers may be understood as jump interleavers via which incoming consecutive tones are round-robin distributed across different bins. The first interleaver may support scenarios in which

$$\frac{{N}_{SD}}{{D}_{TM}}$$

is not an integer and the second interleaver may specify that

$$\frac{{N}_{SD}}{{D}_{TM}}$$

is an integer. For example, using the first interleaver, some output bins may have different quantities of elements and, using the second interleaver, all output bins may have the same quantity of elements.

For example, using the first interleaver with N_{SD}=14, D_{TM}=3, and

$$β = ⌊ \frac{{N}_{SD}}{{D}_{T M}} ⌋ = 4 total output bins ,$$

input tone indices of K={0, 1, 2, . . . , 13} may be distributed across the four output bins such that a first output bin includes input tone indices {0, 4, 8, 12}, a second output bin includes input tone indices {1, 5, 9, 13}, a third output bin includes input tone indices {2, 6, 10}, and a fourth output bin includes tone indices {3, 7, 11}. The first interleaver may convert the input tone indices to output tone indices in accordance with distributing the input tone indices across the output bins and re-numbering the tone indices. For example, input tone index 0 may be converted to output tone index 0, input tone index 4 may be converted to output tone index 1, input tone index 8 may be converted to output tone index 2, input tone index 12 may be converted to output tone index 3, input tone index 1 may be converted to output tone index 4, input tone index 5 may be converted to output tone index 5, input tone index 9 may be converted to output tone index 6, and so on.

In implementations in which the wireless communication device uses the first interleaver to interleave data tones and in which the wireless communication device inserts the IM pilot tones 1858 at fixed locations, the wireless communication device may select the fixed locations of the IM pilot tones 1858 from a table, such as in accordance with a network specification. Tables 12-15 illustrate example fixed locations for the IM pilot tones 1858 in accordance with RU size and a target IM pilot occupancy percentage. In accordance with a lack of a divisibility constraint related to D_{TM}, Tables 12-15 may exclude “extra IM pilots.” The “New Dtm” may be optionally used, such as in examples in which the wireless communication device uses a D_{TM} value that is specific or dedicated to scenarios in which the IM mode is set to an ON state.

TABLE 12
IM Pilot Locations Across Various RU Sizes, with a Target
IM Pilot Occupancy Percentage of Approximately 16.7%
(1 out of every 6 tones being an IM Pilot Tone)

| | RU996 | RU484 | RU242 | MRU484 + 242 |
|---|---|---|---|---|
| Npilot, cfo | 16 | 16 | 8 | 24 |
| Nsd, original | 980 | 468 | 234 | 702 |
| Nsd, im | 814 | 386 | 193 | 579 |
| Nimp | 166 | 82 | 41 | 123 |
| IM Pilots | {[−499:6:−7], | {[−499:6:−13]} | {[−499:6:−259]} | Union of |
| SCidx | [7:6:499]} | or | or | adjacent |
| | (166 total) | {[13:6:499]} | {[−253:6:−13]} | RU242 and |
| | | (82 total per | or | RU484 pilot |
| | | RU) | {[13:6:253]} | indices, per |
| | | | or | RU idx |
| | | | {[259:6:499]} | (123 total per |
| | | | (41 total per | RU) |
| | | | RU) | |
| Original | 20 | 12 | 9 | 18 |
| Dtm | | | | |
| New Dtm | 17 | 10 | 8 | 15 |

TABLE 13
IM Pilot Locations Across Various RU Sizes, with a Target
IM Pilot Occupancy Percentage of Approximately 10%
(1 out of every 10 tones being an IM Pilot Tone)

| | RU996 | RU484 | RU242 | MRU484 + 242 |
|---|---|---|---|---|
| Npilot, cfo | 16 | 16 | 8 | 24 |
| Nsd, original | 980 | 468 | 234 | 702 |
| Nsd, im | 882 | 420 | 210 | 630 |
| Nimp | 98 | 48 | 24 | 72 |
| IM Pilots | {[−491:10:−11], | {[−491:10:−21]} | {[−491:10:−261]} | Union of |
| SCidx | [11:10:491]} | or | or | adjacent |
| | (98 total) | {[21:10:491]} | {[−251:10:−21]} | RU242 and |
| | | (48 total per | or | RU484 pilot |
| | | RU) | {[21:6:251]} | indices, per |
| | | | or | RU idx |
| | | | {[261:10:491]} | (72 total per |
| | | | (24 total per | RU) |
| | | | RU) | |
| Original | 20 | 12 | 9 | 18 |
| Dtm | | | | |
| New Dtm | 18 | 11 | 8 | 16 |

TABLE 14
IM Pilot Locations Across Various RU Sizes, with a Target
IM Pilot Occupancy Percentage of Approximately 13%
(1 out of every 8 tones being an IM Pilot Tone)

| | RU996 | RU484 | RU242 | MRU484 + 242 |
|---|---|---|---|---|
| Npilot, cfo | 16 | 16 | 8 | 24 |
| Nsd, original | 980 | 468 | 234 | 702 |
| Nsd, im | 856 | 408 | 204 | 612 |
| Nimp | 124 | 60 | 30 | 90 |
| IM Pilots | {[−497:8:−9], | {[−497:8:−265] | {[−497:8:−265]} | Union of |
| SCidx | [9:8:497]} | and | or | adjacent |
| | (124 total) | [−249:8:−17]} | {[−249:8:−17]} | RU242 and |
| | | or | or | RU484 pilot |
| | | {[17:8:249] | {[17:8:249]} | indices, per |
| | | and | or | RU idx |
| | | [265:8:497]} | {[265:8:497]} | (90 total per |
| | | (60 total per | (30 total per | RU) |
| | | RU) | RU) | |
| Original Dtm | 20 | 12 | 9 | 18 |
| New Dtm | 18 | 11 | 8 | 16 |

TABLE 15
IM Pilot Locations Across Various RU Sizes, with a Target
IM Pilot Occupancy Percentage of Approximately 9% (1
out of every 11 tones being an IM Pilot Tone)

| | RU996 | RU484 | RU242 | MRU484 + 242 |
|---|---|---|---|---|
| Npilot, cfo | 16 | 16 | 8 | 24 |
| Nsd, original | 980 | 468 | 234 | 702 |
| Nsd, im | 890 | 424 | 212 | 636 |
| Nimp | 90 | 44 | 22 | 66 |
| IM Pilots | {[−496:11:−12], | {[−496:11:−265] | {[−496:11:−265]} | Union of |
| SCidx | [12:11:496]} | and | or | adjacent |
| | (90 total) | [−243:11:−12]} | {[−243:11:−12]} | RU242 and |
| | | or | or | RU484 |
| | | {[12:11:243] | {[12:11:243]} | indices, per |
| | | and | or | RU idx |
| | | [265:11:496]} | {[265:11:496]} | (66 total per |
| | | (44 total per | (22 total per | RU) |
| | | RU) | RU) | |
| Original Dtm | 20 | 12 | 9 | 18 |
| New Dtm | 19 | 11 | 9 | 17 |

In some implementations, the wireless communication device may use an interleaver that is associated with the IM mode and that is associated with a single tone mapping operation. Such an interleaver may be associated with (such as defined by), Equation 5, shown below, with k=0, . . . , N_{SD}−1 (tone index in the RU without CFO pilots before interleaving) and t(k) being the tone index after LDPC interleaving. The wireless communication device may select the interleaver from multiple available interleavers, such as in accordance with the IM mode being set to an ON state.

$$t ( k ) = ( k \cdot {D}_{T M} ) + {N}_{SD} \qquad ( 5 )$$

In the context of Equation 5, N_{SD} may be N_{SD,IM}. In some aspects, a use of the single tone mapping operation (such as t(k)=(k·D_{TM})+N_{SD}) may be associated with a condition. In such aspects, the wireless communication device may select one or more values in accordance with the condition, such as to satisfy the condition. For example, the condition associated with the single tone mapping operation may be that a greatest common factor (GCF) between N_{SD} and D_{TM} may be restricted to be 1. In such examples, the wireless communication device may select values for D_{TM}, N_{SD,IM}, and N_{IMP} such that the GCF between N_{SD} and D_{TM} is equal to 1. In some implementations, the wireless communication device may select the values such that at least one of N_{SD} or D_{TM} is a prime number. In some aspects, a selected D_{TM} value may be specific or dedicated to scenarios in which the IM mode is set to an ON state and may be common across different potential target IM pilot occupancy percentages. In some aspects, the D_{TM} values may be prime numbers that are closest to a D_{TM} value used for non-IM mode PPDUs, which may be referred to herein as an “original D_{TM} value.” Some example D_{TM} values are illustrated in Table 16, shown below.

TABLE 16
Example D_{TM} Values associated with
Single Tone Mapping Operation

| | RU996 | RU484 | RU242 | MRU484 + 242 |
|---|---|---|---|---|
| Original Dtm | 20 | 12 | 9 | 18 |
| New Dtm | 17 | 11 | 7 | 17 |

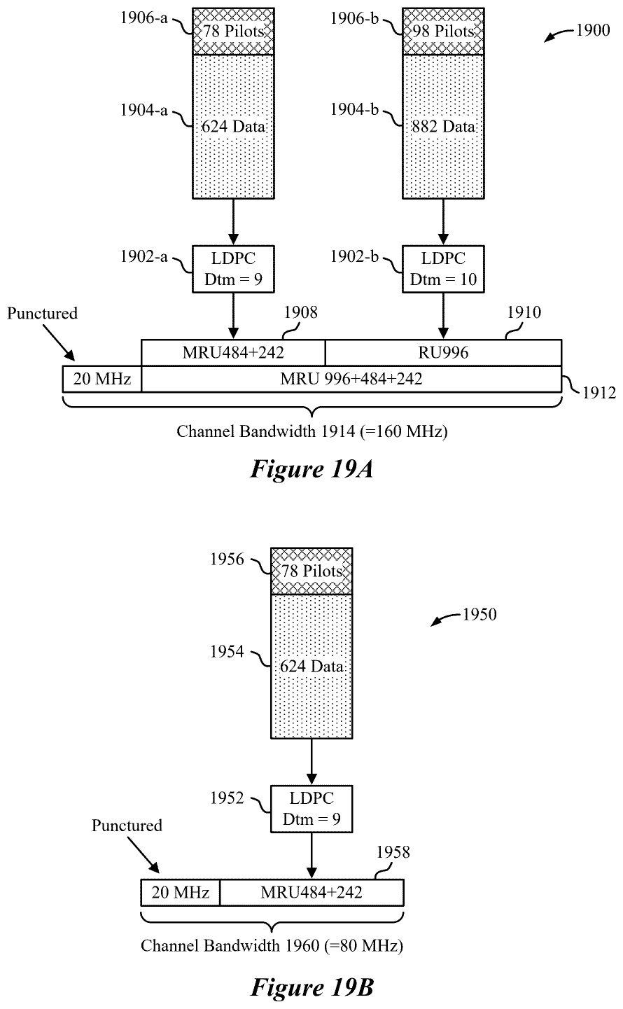

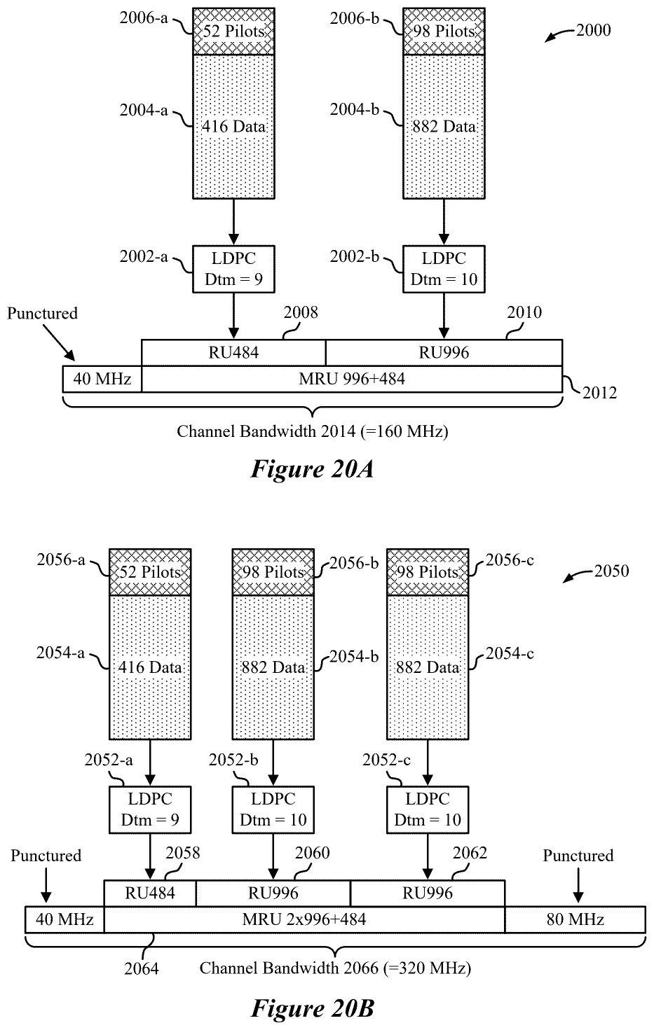

FIGS. 19A, 19B, 20A, and 20B show examples of a punctured transmission 1900, a punctured transmission 1950, a punctured transmission 2000, and a punctured transmission 2050, respectively, that support IM mode signaling designs for a PPDU. A wireless communication device may implement one or more of the punctured transmission 1900, the punctured transmission 1950, the punctured transmission 2000, and the punctured transmission 2050 as part of transmitting a punctured PPDU, such as a punctured SU PPDU.

In some examples, a wireless communication device may transmit the punctured PPDU via a channel bandwidth of greater than or equal to 80 MHz. In examples of a PPDU bandwidth of greater than or equal to 80 MHz in SU, larger RUs may be made up of constituent RUs (such as constituent RU996s) and a wireless communication device may perform an LDPC Dtm procedure (including IM pilot insertion) per 80 MHz segment. A wireless communication device may use an RU996 for an 80 MHz PPDU (or for an 80 MHz portion of a PPDU), may use an RU484 for a 40 MHz PPDU (or for a 40 MHz portion of a PPDU), and/or may use an RU242 for a 20 MHz PPDU (or for a 20 MHz portion of a PPDU). Each of RU242, RU484, and RU96 may be defined with different parameters (such as LDPC interleaving parameters) depending on whether the IM mode has an ON state or an OFF state. An example of such parameters is illustrated in Table 17, shown below.

TABLE 17
Example Parameters for RU242, RU484, and RU996

| | RU242 | RU484 | RU996 |
|---|---|---|---|
| Input size to Tone Interleaver | 234 | 468 | 980 |
| (quantity of data tones in | | | |
| scenarios in which IM mode | | | |
| is OFF) | | | |
| Original Dtm (IM mode is | 9 | 12 | 20 |
| OFF) | | | |
| New Dtm in scenarios in | 9 | 9 | 10 |
| which IM mode is ON | | | |
| Quantity of Data tones in | 208 | 416 | 882 |
| scenarios in which IM mode | | | |
| is ON | | | |
| Quantity of IM pilots | 26 | 52 | 98 |

In some implementations, one or more wireless communication devices may expand IM mode pilot definitions to include punctured SU operation, including in scenarios in which a PPDU bandwidth is greater than or equal to 80 MHz. A wireless communication device may support puncturing at one or more of various granularities, including at a 20 MHz puncturing granularity, a 40 MHz puncturing granularity, an 80 MHz puncturing granularity, and/or an 80+40 MHz puncturing granularity. A wireless communication device may support such puncturing for non-OFDMA 80 MHz bandwidths and above. A wireless communication device may form an SU punctured transmission from combinations of RU242, RU484, RU996, and/or MRU484+242. In some aspects, to enable IM pilots in punctured modes, a wireless communication device may support a numerology definition for MRU484+242 such that the MRU484+242 also has different parameters (such as LDPC interleaving parameters) depending on whether the IM mode has an ON state or an OFF state. An example of such parameters for MRU484+242 is illustrated in Table 18, shown below.

TABLE 18
Example Tone Plan Parameters for MRU484 + 242

| | MRU484 + 242 |
|---|---|
| Input size to Tone Interleaver (quantity of | 702 |
| data tones in scenarios in which IM mode is | |
| OFF) | |
| Original Dtm (IM mode is OFF) | 18 |
| New Dtm in scenarios in which IM mode is | 9 |
| ON | |
| Quantity of Data tones in scenarios in which | 624 |
| IM mode is ON | |
| Quantity of IM pilots | 78 |

Such tone plans for MRU484+242 may satisfy one or more criteria, the criteria including that an input size to an LDPC tone interleaver is divisible by the Dtm value and a relatively even distribution of IM pilots. For example, 702/9=78, which also may be the quantity of IM pilots defined for MRU484+242. By way of further example, using a Dtm value of 9, 78 IM pilots may be evenly distributed by a tone interleaver without wraparound (corresponding to 11% IM pilot overhead in data tones, which may satisfy a target balance between IM and throughput).

In accordance with the punctured transmission 1900, which may illustrate a channel bandwidth 1914 of 160 MHz with a 20 MHz puncture, a wireless communication device may input IM pilot tones 1906-a and data tones 1904-a of an MRU484+242 1908 into an LDPC interleaver 1902-a and may input IM pilot tones 1906-b and data tones 1904-b of an RU996 1910 into an LDPC interleaver 1902-b. The LDPC interleaver 1902-a and the LDPC interleaver 1902-b may be a same interleaver used at different times or may be different interleavers. The MRU484+242 1908 may be output from the LDPC interleaver 1902-a and the RU996 1910 may be output from the LDPC interleaver 1902-b. The LDPC interleaver 1902-a may use a first Dtm value (such as a Dtm value of 9) and the LDPC interleaver 1902-b may use a second Dtm value (such as a Dtm value of 10). A combination of the MRU484+242 1908 and the RU996 1910 may be an MRU 996+484+242 1912.

In accordance with the punctured transmission 1950, which may illustrate a channel bandwidth 1960 of 80 MHz with a 20 MHz puncture, a wireless communication device may input IM pilot tones 1956 and data tones 1954 of an MRU484+242 1958 into an LDPC interleaver 1952. The MRU484+242 1958 may be output from the LDPC interleaver 1952. The LDPC interleaver 1952 may use a first Dtm value (such as a Dtm value of 9).

In accordance with the punctured transmission 2000, which may illustrate a channel bandwidth 2014 of 160 MHz with a 40 MHz puncture, a wireless communication device may input IM pilot tones 2006-a and data tones 2004-a of an RU484 2008 into an LDPC interleaver 2002-a and may input IM pilot tones 2006-b and data tones 2004-b of an RU996 2010 into an LDPC interleaver 2002-b. The LDPC interleaver 2002-a and the LDPC interleaver 2002-b may be a same interleaver used at different times or may be different interleavers. The RU484 2008 may be output from the LDPC interleaver 2002-a and the RU996 2010 may be output from the LDPC interleaver 2002-b. The LDPC interleaver 2002-a may use a first Dtm value (such as a Dtm value of 9) and the LDPC interleaver 2002-b may use a second Dtm value (such as a Dtm value of 10). A combination of the RU484 2008 and the RU996 2010 may be an MRU 996+484 2012.

In accordance with the punctured transmission 2050, which may illustrate a channel bandwidth 2066 of 320 MHz with an 80+40 MHz puncture, a wireless communication device may input IM pilot tones 2056-a and data tones 2054-a of an RU484 2058 into an LDPC interleaver 2052-a, may input IM pilot tones 2056-b and data tones 2054-b of an RU996 2060 into an LDPC interleaver 2052-b, and may input IM pilot tones 2056-c and data tones 2054-c of an RU996 2062 into an LDPC interleaver 2052-c. The LDPC interleaver 2052-a, the LDPC interleaver 2002-b, and the LDPC interleaver 2052-c may be a same interleaver used at different times or may be different interleavers. The RU484 2058 may be output from the LDPC interleaver 2002-a, the RU996 2060 may be output from the LDPC interleaver 2052-b, and the RU996 2062 may be output from the LDPC interleaver 2052-c. The LDPC interleaver 2052-a may use a first Dtm value (such as a Dtm value of 9) and the LDPC interleaver 2052-b and the LDPC interleaver 2052-c may use a second Dtm value (such as a Dtm value of 10). A combination of the RU484 2058, the RU996 2060, and the RU996 2062 may be an MRU 2×996+484 2064.

In some implementations, a wireless communication device may support one or more definitions of N_{SD,short} for an MRU, including a definition of N_{SD,short} that is specific for an MRU with the IM mode set to an ON state. The parameter N_{SD,short} may refer to or be an example of a parameter value for a quantity of data tones in a fractional RU increment to use in a pre-FEC padding calculation. For example, because an IM mode having an ON state may change a quantity of data-carrying tones in an RU/MRU (such that a new or different N_{SD} value may be used in scenarios in which the IM mode is ON), an upstream PPDU pre-FEC padding procedure may use a new or different N_{SD,short} value for calculating an a-factor (a parameter used in padding calculations and signaled to a receiving wireless communication device). Each RU/MRU size may be defined with a respective set of N_{SD,short} values, with at least one N_{SD,short} value in each respective set corresponding to an IM mode in an ON state for that RU/MRU size. Example N_{SD,short} values for various RU sizes are illustrated in Table 19, shown below. Example N_{SD,short} values for various MRU sizes are illustrated in Tables 20 and 21, also shown below.

TABLE 19
Example N_{SD, short} Values for Various RU Sizes

| | N_{SD, short} for MCS 0-13 |
|---|---|
| | in scenarios in which IM |
| RU size | mode is ON |
| 242-tone | 48 |
| 484-tone | 108 |
| 996-tone | 216 |
| 2 × 996 tone | 444 |
| 4 × 996 tone | 888 |

TABLE 20
Example N_{SD, short} Values for Various MRU Sizes

| | N_{SD, short} |
|---|---|
| | for MCS 0-13 in |
| | scenarios in which IM mode |
| MRU size | is ON |
| 484 + 242 tone | 156 |
| 996 + 484 tone | 324 |
| 996 + 484 + 242 tone | 372 |
| 2 × 996 + 484 tone | 552 |
| 3 × 996 tone | 660 |
| 3 × 996 + 484 tone | 768 |

TABLE 21
Additional example N_{SD, short} Values for Various MRU Sizes

| | N_{SD, short} |
|---|---|
| | for MCS 0-13 in |
| | scenarios in which IM mode |
| MRU size | is ON |
| 484 + 242 tone | 156 |
| 996 + 484 tone | 324 |
| 996 + 484 + 242 tone | 372 |
| 2 × 996 + 484 tone | 540 |
| 3 × 996 tone | 660 |
| 3 × 996 + 484 tone | 768 |

In some implementations, a wireless communication device may select the N_{SD,short} values for an MRU size such that the N_{SD,short} value is defined as the sum of the N_{SD,short} for constituent N_{SD,short} values for the closest regular RUs. Table 20 illustrates examples of N_{SD,short} values derived in such a manner. In some other implementations, a wireless communication device may select N_{SD,short} values for an MRU size such that the N_{SD,short} value is derived by taking ¼ the total quantity of data subcarriers (such as data tones) in the MRU in scenarios in which the IM mode is ON, and rounding up or down to a nearest integer multiple of a defined numeric value (such as 12). In some aspects, the defined numeric value may be equal to a least common multiple of a set of potential FEC coding rate denominators, such as a set of potential 802.11 FEC coding rate denominators. In examples in which the potential 802.11 FEC coding rate denominators are 2, 4, and 6, the defined numeric value may be equal to 12 (as 12 is the least common multiple of 2, 4, and 6). Table 21 illustrates examples of N_{SD,short} values derived with this criteria.

In some aspects, N_{SD,short} values for the various RU/MRU sizes in scenarios in which the IM mode is OFF may be backwards compatible with one or more other generations of devices or 802.11 amendments. For example, N_{SD,short} values for the various RU/MRU sizes in scenarios in which the IM mode is OFF may be the same as the N_{SD,short} values for the various RU/MRU sizes specified by the 802.11be amendment. In such aspects, a set of N_{SD,short} values defined for MRU484+242 may include 180 (for an MCS of 0-13 and in scenarios in which the IM mode is OFF), 90 (for an MCS of 15 and in scenarios in which the IM mode is OFF), and 156 (for an MCS of 0-13 and in scenarios in which the IM mode is ON). By way of further example, a set of N_{SD,short} values defined for MRU996+484 may include 360 (for an MCS of 0-13 and in scenarios in which the IM mode is OFF), 180 (for an MCS of 15 and in scenarios in which the IM mode is OFF), and 324 (for an MCS of 0-13 and in scenarios in which the IM mode is ON). By way of further example, a set of N_{SD,short} values defined for MRU996+484+242 may include 420 (for an MCS of 0-13 and in scenarios in which the IM mode is OFF), 210 (for an MCS of 15 and in scenarios in which the IM mode is OFF), and 372 (for an MCS of 0-13 and in scenarios in which the IM mode is ON). By way of further example, a set of N_{SD,short} values defined for MRU2×996+484 may include 612 (for an MCS of 0-13 and in scenarios in which the IM mode is OFF) and 552 or 540 (for an MCS of 0-13 and in scenarios in which the IM mode is ON). By way of further example, a set of N_{SD,short} values defined for MRU3×996 may include 732 (for an MCS of 0-13 and in scenarios in which the IM mode is OFF) and 660 (for an MCS of 0-13 and in scenarios in which the IM mode is ON). By way of further example, a set of N_{SD,short} values defined for MRU3×996+484 may include 852 (for an MCS of 0-13 and in scenarios in which the IM mode is OFF) and 768 (for an MCS of 0-13 and in scenarios in which the IM mode is ON).

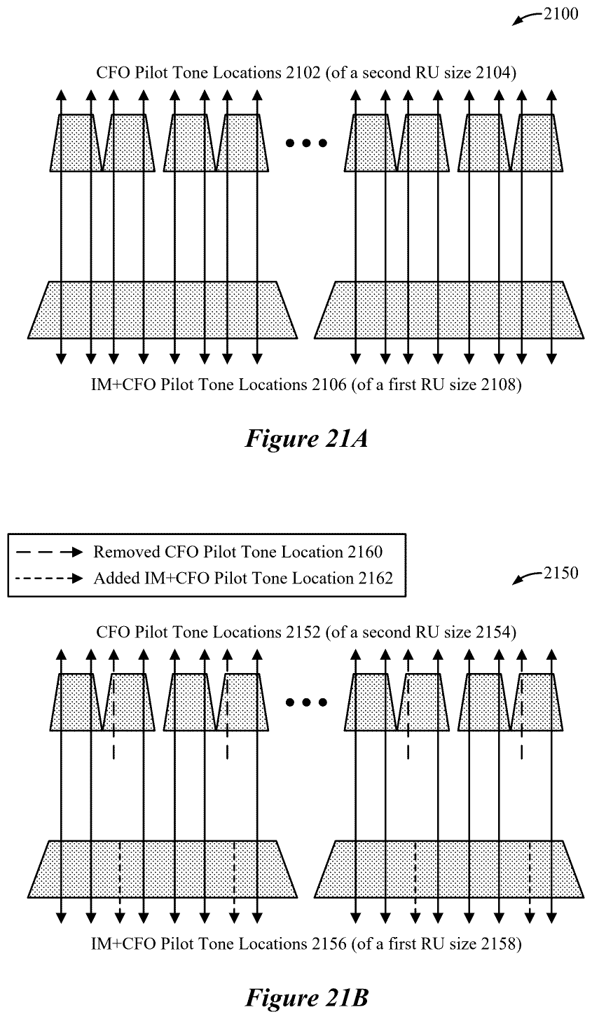

FIGS. 21A and 21B show examples of a pilot tone plan 2100 and a pilot tone plan 2150, respectively, for pilot tones usable as IM pilot tones and usable as CFO pilot tones that support IM mode signaling designs for a PPDU. In the examples of the pilot tone plan 2100 and the pilot tone plan 2150, IM pilot locations may overlap or coincide with CFO pilot locations such that pilot tones within an RU/MRU may be used for IM and/or CFO measurement (in accordance with an autonomous decision or a signaled instruction/request). The pilot tone plan 2100 and the pilot tone plan 2150 may illustrate examples of, or define, fixed IM pilot tone locations.

In some implementations, a wireless communication device may define IM pilot locations within a given channel bandwidth as a union of all CFO pilots of a smaller RU size, as a subset of CFO pilots of a smaller RU size, or as at least a subset of CFO pilots of a smaller RU size with one or more additional pilots at their corresponding RU locations within that channel bandwidth. By way of example, the wireless communication device may define IM pilot locations within a given channel bandwidth as the union of all (or some subset of) RU26 CFO pilots at respective RU locations within that channel bandwidth. In such implementations, the IM pilots may be unequally spaced. In some aspects, additional pilots may be defined in addition to the RU26 set of CFO pilots, such as to fill one or more gaps in frequency in which pilot coverage is relatively sparse, and/or to support an LDPC Dtm numerology that satisfies one or more criteria pertaining to (such as associated with, corresponding to, based on, or a function of) LDPC Dtm operations. In this way, a receiving wireless communication device may use IM pilots as CFO pilots, or vice-versa. Such “IM+CFO pilots” may be single-stream pilots and may have tone locations in one or more UHR-LTF symbols that receive first-row P-matrix multiplication.

The pilot tone plan 2100 illustrates an example in which IM+CFO pilot tone locations 2106 of an RU having a first RU size 2108 correspond to a full union of all CFO pilot tone locations 2102 of RUs having a second RU size 2104. The first RU size 2108 and the second RU size 2104 may be examples of any RU sizes disclosed herein, with the second RU size 2104 being smaller than the first RU size 2108. The pilot tone plan 2150 illustrates an example in which IM+CFO pilot tone locations 2156 of an RU having a first RU size 2158 correspond to a subset of the CFO pilot tone locations 2152 of RUs having a second RU size 2154 and/or in which the IM+CFO pilot tone locations 2156 of an RU having a first RU size 2158 correspond to one or more IM+CFO pilot tone locations 2162 that are additional to the CFO pilot tone locations 2152. In examples in which the IM+CFO pilot tone locations 2156 correspond to the subset of the CFO pilot tone locations 2152, the CFO pilot tone locations 2152 may include one or more CFO pilot tone locations 2160 that are removed or otherwise absent from the IM+CFO pilot tone locations 2156. The first RU size 2158 and the second RU size 2154 may be examples of any RU sizes disclosed herein, with the second RU size 2154 being smaller than the first RU size 2158.

In examples in which a channel bandwidth is 20 MHz, a full bandwidth transmission may use an RU242, which may include 9 defined RU26s within the 20 MHz channel bandwidth, each with 2 CFO pilots. The RU242 may include 18 IM pilots (in examples in which the IM+CFO pilot tone locations correspond to the full union of the CFO pilots within the 9 defined RU26s). Example parameters (such as LDPC interleaving parameters) defined for a 20 MHz channel bandwidth and an RU242 are illustrated in Table 22, shown below.

TABLE 22
Example Parameters Defined for a 20
MHz Channel Bandwidth and an RU242

| | RU242 |
|---|---|
| Quantity of CFO pilots | 8 |
| (originally) | |
| Quantity of data tones (originally) | 234 |
| Quantity of new IM + CFO pilots | 18 |
| in scenarios in which IM mode is | |
| ON | |
| Quantity of data tones in scenarios | 224 |
| in which IM mode is ON | |
| New Dtm in scenarios in which | 8 |
| IM mode is ON | |

In examples in which a channel bandwidth is 40 MHz, a full bandwidth transmission may use an RU484, which may include 18 defined RU26s within the 40 MHz channel bandwidth, each with 2 CFO pilots. The RU484 may include 36 IM pilots (in examples in which the IM+CFO pilot tone locations correspond to the full union of the CFO pilots within the 18 defined RU26s). Example parameters (such as LDPC interleaving parameters) defined for a 40 MHz channel bandwidth and an RU484 are illustrated in Table 23, shown below.

TABLE 23
Example Parameters Defined for a 40
MHz Channel Bandwidth and an RU484

| | RU484 |
|---|---|
| Quantity of CFO pilots | 16 |
| (originally) | |
| Quantity of data tones | 468 |
| (originally) | |
| Quantity of new IM + CFO | 36 |
| pilots in scenarios in which IM | (18 RU26s defined in a channel |
| mode is ON | bandwidth of 40 MHz, with 2 |
| | pilots each) |
| Quantity of data tones in | 448 |
| scenarios in which IM mode is | |
| ON | |
| New Dtm in scenarios in which | 8 |
| IM mode is ON | |

In examples in which a channel bandwidth is 80 MHz, a full bandwidth transmission may use an RU996, which may include 36 defined RU26s within the 80 MHz channel bandwidth, each with 2 CFO pilots. The RU996 may include 84 IM pilots (in examples in which the IM+CFO pilot tone locations correspond to the full union of the CFO pilots within the 36 defined RU26s plus 12 additional IM+CFO pilot tone locations 2162). Example parameters (such as LDPC interleaving parameters) defined for an 80 MHz channel bandwidth and an RU996 are illustrated in Table 24, shown below.

TABLE 24
Example Parameters Defined for an 80 MHz Channel Bandwidth and an RU996

| | RU996 |
|---|---|
| Quantity of CFO pilots (originally) | 16 |
| Quantity of data tones (originally) | 980 |
| Quantity of new IM + CFO pilots in | 72 (36 RU26s defined in a channel |
| scenarios in which IM mode is ON | bandwidth of 80 MHz, with 2 pilots |
| | each) + |
| | 12 (additional tone locations, to fill |
| | gaps in frequency coverage) = |
| | 84 total combined IM + CFO pilots |
| Quantity of data tones in scenarios | 896 |
| in which IM mode is ON | |
| New Dtm in scenarios in which IM | 16 |
| mode is ON | |

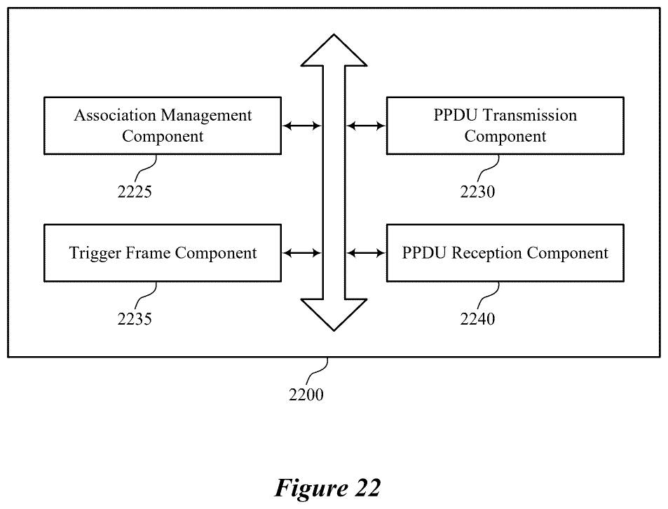

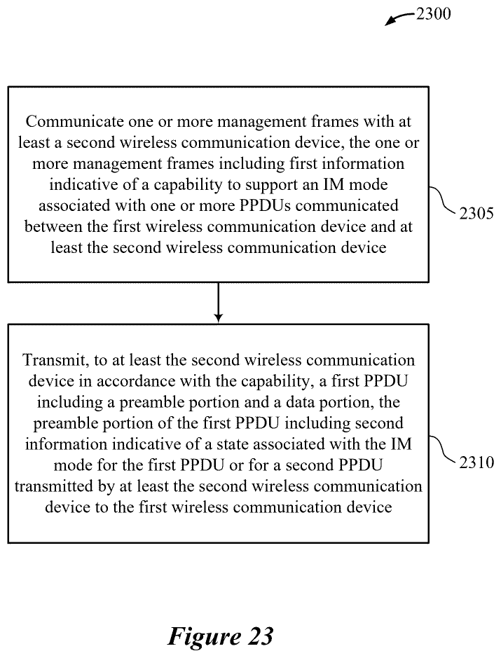

FIG. 22 shows a block diagram of an example wireless communication device 2200 that supports IM mode signaling designs for a PPDU. In some examples, the wireless communication device 2200 is configured to perform the processes 2300, 2400, 2500, 2600, 2700, 2800, 2900, 3000, 3100, and 3200 described with reference to FIGS. 23, 24, 25, 26, 27, 28, 29, 30, 31, and 32, respectively. The wireless communication device 2200 may include one or more chips, SoCs, chipsets, packages, components or devices that individually or collectively constitute or include a processing system. The processing system may interface with other components of the wireless communication device 2200, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 2200 may transmit the information output from the chip. In such an example, the second interface may refer to an interface between the processing system of the chip and a reception component, such that the wireless communication device 2200 may receive information that is passed to the processing system. In some such examples, the first interface also may obtain information, such as from the transmission component, and the second interface also may output information, such as to the reception component.

The processing system of the wireless communication device 2200 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 2200 can be configurable or configured for use in an AP or STA, such as the AP 102 or the STA 104 described with reference to FIG. 1. In some other examples, the wireless communication device 2200 can be an AP or STA that includes such a processing system and other components including multiple antennas. The wireless communication device 2200 is capable of transmitting and receiving wireless communication in the form of, for example, wireless packets. For example, the wireless communication device 2200 can be configurable or configured to transmit and receive packets in the form of physical layer PPDUs and MPDUs conforming to one or more of the IEEE 802.11 family of wireless communication protocol standards. In some other examples, the wireless communication device 2200 can be configurable or configured to transmit and receive signals and communication conforming to one or more 3GPP specifications including those for 5G NR or 6G. In some examples, the wireless communication device 2200 also includes or can be coupled with one or more application processors which may be further coupled with one or more other memories. In some examples, the wireless communication device 2200 further includes a user interface (UI) (such as a touchscreen or keypad) and a display, which may be integrated with the UI to form a touchscreen display that is coupled with the processing system. In some examples, the wireless communication device 2200 may further include one or more sensors such as, for example, one or more inertial sensors, accelerometers, temperature sensors, pressure sensors, or altitude sensors, that are coupled with the processing system. In some examples, the wireless communication device 2200 further includes at least one external network interface coupled with the processing system that enables communication with a core network or backhaul network that enables the wireless communication device 2200 to gain access to external networks including the Internet.

The wireless communication device 2200 includes an association management component 2225, a PPDU transmission component 2230, a trigger frame component 2235, and a PPDU reception component 2240. Portions of one or more of the association management component 2225, the PPDU transmission component 2230, the trigger frame component 2235, and the PPDU reception component 2240 may be implemented at least in part in hardware or firmware. For example, one or more of the association management component 2225, the PPDU transmission component 2230, the trigger frame component 2235, and the PPDU reception component 2240 may be implemented at least in part by at least a processor or a modem. In some examples, portions of one or more of the association management component 2225, the PPDU transmission component 2230, the trigger frame component 2235, and the PPDU reception component 2240 may be implemented at least in part by a processor and software in the form of processor-executable code stored in memory.

The wireless communication device 2200 may support wireless communication in accordance with examples as disclosed herein. The association management component 2225 is configurable or configured to communicate one or more management frames with at least a second wireless communication device, the one or more management frames including first information indicative of a capability to support an IM mode associated with one or more PPDUs communicated between the first wireless communication device and at least the second wireless communication device. The PPDU transmission component 2230 is configurable or configured to transmit, to at least the second wireless communication device in accordance with the capability, a first PPDU including a preamble portion and a data portion, the preamble portion of the first PPDU including second information indicative of a state associated with the IM mode for the first PPDU or for a second PPDU transmitted by at least the second wireless communication device to the first wireless communication device.

In some examples, the second information is indicative of the state associated with the IM mode for the first PPDU. In some examples, a data field within the data portion of the first PPDU is in accordance with the state associated with the IM mode.

In some examples, the second information is indicative of the state associated with the IM mode for the second PPDU, and the PPDU reception component 2240 is configurable or configured to receive the second PPDU from at least the second wireless communication device. In some examples, a data field of the second PPDU is in accordance with the state associated with the IM mode. In some examples, the second information includes a request or a command for the state associated with the IM mode for the second PPDU.

In some examples, the preamble portion of the first PPDU includes a universal signal (U-SIG) field and an ultra-high reliability signal (UHR-SIG) common field. In some examples, one or more first bits within a version-dependent portion of the U-SIG field or within the UHR-SIG common field indicate the second information.

In some examples, the second information is indicative of the state associated with the IM mode for the first PPDU. In some examples, the one or more first bits consist of a single bit. In some examples, a first value of the single bit indicates that the state associated with the IM mode for the first PPDU is an ON state and a second value of the single bit indicates that the state associated with the IM mode for the first PPDU is an OFF state.

In some examples, the second information is indicative of a requested or commanded state associated with the IM mode for the second PPDU. In some examples, the one or more first bits consist of a single bit. In some examples, a first value of the single bit indicates that the requested or commanded state associated with the IM mode for the second PPDU is an ON state and a second value of the single bit indicates that the requested or commanded state associated with the IM mode for the second PPDU is an OFF state.

In some examples, the one or more first bits include two or more bits. In some examples, a first codepoint associated with the two or more bits indicates that the state associated with the IM mode is an ON state. In some examples, another codepoint associated with the two or more bits different than the first codepoint indicates that the state associated with the IM mode is an OFF state.

In some examples, the version-dependent portion of the U-SIG field or the UHR-SIG common field further includes one or more second bits. In some examples, the one or more second bits indicate one or more parameters associated with the IM mode for the first PPDU or the second PPDU.

In some examples, the one or more first bits within the version-dependent portion of the U-SIG field or within the UHR-SIG common field include at least a first bit indicating a first state associated with the IM mode for the first PPDU and include at least a second bit indicating a second state associated with the IM mode for the second PPDU.

In some examples, the first PPDU or the second PPDU is associated with a full bandwidth transmission. In some examples, the first PPDU or the second PPDU is associated with an orthogonal frequency division multiple access (OFDMA) transmission. In some examples, each receiver of a set of receivers of the first PPDU or the second PPDU has the capability to support the IM mode. In some examples, the state associated with the IM mode is either an ON state or an OFF state for the set of receivers of the first PPDU or the second PPDU in association with the first PPDU or the second PPDU being associated with the OFDMA transmission.

In some examples, the IM mode is associated with a set of multiple pilot tones. In some examples, the set of multiple pilot tones is distributed over a set of multiple time-frequency locations within a resource grid associated with a data field of the first PPDU or the second PPDU in accordance with a pattern. In some examples, the pattern defines that the set of multiple pilot tones is located within a fixed set of multiple non-contiguous subcarriers over a set of multiple contiguous symbols associated with the data field; varying subcarriers over the set of multiple contiguous symbols associated with the data field; or a fixed set of multiple contiguous subcarriers that spans a full bandwidth over a fixed set of multiple non-contiguous symbols associated with the data field. In some examples, the set of multiple pilot tones is associated with null-tone values. In some examples, the set of multiple pilot tones is associated with a sequence of plus-one or minus-one values.

In some examples, at least one management frame of the one or more management frames includes a capability element. In some examples, the capability element includes the first information indicative of the capability to support the IM mode.

Additionally, or alternatively, the wireless communication device 2200 may support wireless communication in accordance with examples as disclosed herein. In some examples, the association management component 2225 is configurable or configured to communicate one or more management frames with at least a second wireless communication device, the one or more management frames including first information indicative of a capability to support an IM mode associated with one or more PPDUs communicated between the first wireless communication device and at least the second wireless communication device. The trigger frame component 2235 is configurable or configured to transmit, to at least the second wireless communication device in accordance with the capability, a trigger frame soliciting a trigger-based PPDU (TB PPDU), the trigger frame including second information indicative of a state associated with the IM mode for the TB PPDU.

In some examples, the PPDU reception component 2240 is configurable or configured to receive the TB PPDU from at least the second wireless communication device. In some examples, a data field of the TB PPDU is in accordance with the state associated with the IM mode.

In some examples, the trigger frame includes one or both of a common information field or a special user information field. In some examples, one or more first bits within the common information field or the special user information field indicate the second information.

In some examples, the one or more first bits consist of a single bit. In some examples, a first value of the single bit indicates that the state associated with the IM mode is an ON state and a second value of the single bit indicates that the state associated with the IM mode is an OFF state.

In some examples, the one or more first bits include two or more bits. In some examples, a first codepoint associated with the two or more bits indicates that the state associated with the IM mode is an ON state. In some examples, another codepoint associated with the two or more bits different than the first codepoint indicates that the state associated with the IM mode is an OFF state.

In some examples, the common information field or the special user information field further includes one or more second bits. In some examples, the one or more second bits indicate one or more parameters associated with the IM mode for the TB PPDU. In some examples, the TB PPDU is associated with a full bandwidth transmission.

In some examples, the IM mode is associated with a set of multiple pilot tones. In some examples, the set of multiple pilot tones is distributed over a set of multiple time-frequency locations within a resource grid associated with a data field of the TB PPDU in accordance with a pattern. In some examples, the pattern defines that the set of multiple pilot tones is located within a fixed set of multiple non-contiguous subcarriers over a set of multiple contiguous symbols associated with the data field; varying subcarriers over the set of multiple contiguous symbols associated with the data field; or a fixed set of multiple contiguous subcarriers that spans a full bandwidth over a fixed set of multiple non-contiguous symbols associated with the data field. In some examples, the set of multiple pilot tones is associated with null-tone values. In some examples, the set of multiple pilot tones is associated with a sequence of plus-one or minus-one values.

In some examples, at least one management frame of the one or more management frames includes a capability element. In some examples, the capability element includes the first information indicative of the capability to support the IM mode.

Additionally, or alternatively, the wireless communication device 2200 may support wireless communication in accordance with examples as disclosed herein. In some examples, the association management component 2225 is configurable or configured to communicate one or more management frames with a second wireless communication device, the one or more management frames including first information indicative of a capability to support an IM mode associated with one or more PPDUs communicated between the first wireless communication device and the second wireless communication device. The PPDU reception component 2240 is configurable or configured to receive, from the second wireless communication device in accordance with the capability, a first PPDU including a preamble portion and a data portion, the preamble portion of the first PPDU including second information indicative of a state associated with the IM mode for the first PPDU or for a second PPDU transmitted by the first wireless communication device to the second wireless communication device.

In some examples, the second information is indicative of the state associated with the IM mode for the first PPDU. In some examples, a data field within the data portion of the first PPDU is in accordance with the state associated with the IM mode.

In some examples, the second information is indicative of the state associated with the IM mode for the second PPDU, and the PPDU transmission component 2230 is configurable or configured to transmit the second PPDU to the second wireless communication device. In some examples, a data field of the second PPDU is in accordance with the state associated with the IM mode.

Additionally, or alternatively, the wireless communication device 2200 may support wireless communication in accordance with examples as disclosed herein. In some examples, the association management component 2225 is configurable or configured to communicate one or more management frames with a second wireless communication device, the one or more management frames including first information indicative of a capability to support an IM mode associated with one or more PPDUs communicated between the first wireless communication device and the second wireless communication device. In some examples, the trigger frame component 2235 is configurable or configured to receive, from the second wireless communication device in accordance with the capability, a trigger frame soliciting a trigger-based PPDU (TB PPDU), the trigger frame including second information indicative of a state associated with the IM mode for the TB PPDU.

In some examples, the PPDU transmission component 2230 is configurable or configured to transmit the TB PPDU to the second wireless communication device. In some examples, a data field of the TB PPDU is in accordance with the state associated with the IM mode.

Additionally, or alternatively, the wireless communication device 2200 may support wireless communication in accordance with some other examples as disclosed herein. In some examples, the association management component 2225 is configurable or configured to communicate (such as transmit and/or receive) one or more management frames with a set of multiple wireless communication devices, the one or more management frames including first information indicative of a capability to support an IM mode associated with one or more PPDUs communicated between the wireless communication device and the set of multiple wireless communication devices. In some examples, the trigger frame component 2235 or the PPDU transmission component 2230 is configurable or configured to transmit, to the set of multiple wireless communication devices in accordance with the capability, a message including second information indicative of a respective state associated with the IM mode for each wireless communication device of the set of multiple wireless communication devices.

In some examples, the message includes a field that is applicable to the set of multiple wireless communication devices. In some examples, the field that is applicable to the set of multiple wireless communication devices includes the second information indicative of the respective state associated with the IM mode for each wireless communication device of the set of multiple wireless communication devices.

In some examples, the field that is applicable to the set of multiple wireless communication devices includes a subfield associated with the IM mode. In some examples, the subfield associated with the IM mode indicates a single RU or MRU, of a set of multiple RUs or MRUs allocated by the message, for which the IM mode is associated with an ON state.

In some examples, the field that is applicable to the set of multiple wireless communication devices includes a set of multiple RU allocation subfields. In some examples, the set of multiple RU allocation subfields allocates a set of multiple RUs or MRUs to the set of multiple wireless communication devices. In some examples, the set of multiple RU allocation subfields indicates the respective state associated with the IM mode for each wireless communication device of the set of multiple wireless communication devices.

In some examples, the set of multiple RU allocation subfields includes a first RU allocation subfield that allocates a first RU or MRU and that indicates a first state associated with the IM mode for the first RU or MRU and includes a second RU allocation subfield that allocates a second RU or MRU and that indicates a second state associated with the IM mode for the second RU or MRU.

In some examples, the set of multiple RU allocation subfields indicates the respective state associated with the IM mode for each wireless communication device of the set of multiple wireless communication devices in association with indicating the respective state associated with the IM mode for each RU or MRU of the set of multiple RUs or MRUs, each RU or MRU allocated to one or more wireless communication devices of the set of multiple wireless communication devices.

In some examples, the field that is applicable to the set of multiple wireless communication devices includes a bitmap corresponding to a set of multiple subbands, each bit of the bitmap corresponding to a respective subband of the set of multiple subbands. In some examples, the bitmap corresponding to the set of multiple subbands indicates the respective state associated with the IM mode for each wireless communication device of the set of multiple wireless communication devices.

In some examples, a first bit of the bitmap corresponds to a first subband of the set of multiple subbands and indicates a first state associated with the IM mode for the first subband. In some examples, a second bit of the bitmap corresponds to a second subband of the set of multiple subbands and indicates a second state associated with the IM mode for the second subband.

In some examples, the bitmap corresponding to the set of multiple subbands indicates the respective state associated with the IM mode for each wireless communication device of the set of multiple wireless communication devices in accordance with indicating the respective state associated with the IM mode for each subband of the set of multiple subbands, a union of one or more subbands for which the IM mode is associated with a same state including one or more RUs or MRUs allocated to one or more wireless communication devices of the set of multiple wireless communication devices.

In some examples, the field that is applicable to the set of multiple wireless communication devices is a U-SIG field, a common field in a UHR-SIG field, a common information field, or a special user information field.

In some examples, the message includes a set of multiple user information fields. In some examples, the set of multiple user information fields indicates the respective state associated with the IM mode for each wireless communication device of the set of multiple wireless communication devices.

In some examples, the set of multiple user information fields includes a first user information field associated with a first wireless communication device of the set of multiple wireless communication devices that indicates a first state associated with the IM mode for the first wireless communication device and includes a second user information field associated with a second wireless communication device of the set of multiple wireless communication devices that indicates a second state associated with the IM mode for the second wireless communication device.

In some examples, the message includes a field that is applicable to the set of multiple wireless communication devices and includes a set of multiple user information fields associated with the set of multiple wireless communication devices. In some examples, the field that is applicable to the set of multiple wireless communication devices indicates whether the IM mode is associated with an ON state for at least one wireless communication device of the set of multiple wireless communication devices or is associated with an OFF state for the set of multiple wireless communication devices. In some examples, a format or an interpretation of the set of multiple user information fields is in accordance with whether the IM mode is associated with the ON state for the at least one wireless communication device of the set of multiple wireless communication devices or is associated with the OFF state for the set of multiple wireless communication devices.

In some examples, in accordance with the format or the interpretation of the set of multiple user information fields, the set of multiple user information fields indicates the respective state associated with the IM mode for each wireless communication device of the set of multiple wireless communication devices in association with the field that is applicable to the set of multiple wireless communication devices indicating that the IM mode is associated with the ON state for the at least one wireless communication device of the set of multiple wireless communication devices.

In some examples, the set of multiple user information fields includes a first user information field associated with a first wireless communication device of the set of multiple wireless communication devices that, in accordance with the format or the interpretation of the set of multiple user information fields, indicates a first state associated with the IM mode for the first wireless communication device and includes a second user information field associated with a second wireless communication device of the set of multiple wireless communication devices that, in accordance with the format or the interpretation of the set of multiple user information fields, indicates a second state associated with the IM mode for the second wireless communication device.

In some examples, the field that is applicable to the set of multiple wireless communication devices is a U-SIG field, a common field in a UHR-SIG field, a common information field, or a special user information field.

In some examples, the PPDU transmission component 2230 or the PPDU reception component 2240 is configurable or configured to communicate (such as transmit and/or receive), with each wireless communication device of the set of multiple wireless communication devices, respective data in accordance with the respective state associated with the IM mode corresponding to each wireless communication device of the set of multiple wireless communication devices.

In some examples, the message includes an MU PPDU. In such examples, the respective data is communicated with (such as transmitted to and/or received from) each wireless communication device of the set of multiple wireless communication devices via a respective RU or MRU of the MU PPDU in accordance with an SU communication scheme, a non-OFDMA MU-MIMO communication scheme, or an OFDMA communication scheme.

In some examples, the message includes a trigger frame. In such examples, the respective data is received from each wireless communication device of the set of multiple wireless communication devices via a respective RU or MRU within a respective TB PPDU in accordance with an SU communication scheme, a non-OFDMA MU-MIMO communication scheme, or an OFDMA communication scheme.

Additionally, or alternatively, the wireless communication device 2200 may support wireless communication in accordance with some other examples as disclosed herein. In some examples, The association management component 2225 is configurable or configured to communicate information indicative of an ON state associated with an IM mode for a physical layer protocol data unit (PPDU). The PPDU transmission component 2230 is configurable or configured to transmit, in accordance with the information, the PPDU including a data portion associated with the IM mode, the data portion associated with a first resource unit (RU) size and including a set of multiple pilot tones associated with the IM mode, the set of multiple pilot tones at fixed tone locations associated with the first RU size, and including a set of multiple data tones interleaved within the data portion in accordance with a first tone separation distance that corresponds to the ON state associated with the IM mode.

In some examples, the PPDU transmission component 2230 is configurable or configured to interleave the set of multiple data tones in accordance with the first tone separation distance that corresponds to the ON state associated with the IM mode. In some examples, transmitting the PPDU is in association with interleaving the set of multiple data tones.

In some examples, the PPDU transmission component 2230 is configurable or configured to determine the first tone separation distance from a set of multiple tone separation distances associated with the first RU size in accordance with the ON state associated with the IM mode for the PPDU. In some examples, the set of multiple tone separation distances associated with the first RU size includes the first tone separation distance that corresponds to the ON state associated with the IM mode and a second tone separation distance that corresponds to an OFF state associated with the IM mode.

In some examples, each RU size of a set of multiple RU sizes is associated with a respective set of multiple tone separation distances, each respective set of multiple tone separation distances including a respective first tone separation distance that corresponds to the ON state associated with the IM mode and a respective second tone separation distance that corresponds to the OFF state associated with the IM mode.

In some examples, at least a portion of the set of multiple pilot tones associated with the IM mode are evenly spaced within the data portion.

In some examples, the data portion of the PPDU further includes a second set of multiple pilot tones associated with a carrier frequency offset (CFO) measurement. In some examples, the fixed tone locations of the set of multiple pilot tones associated with the IM mode are non-overlapping with the second set of multiple pilot tones associated with the CFO measurement.

In some examples, each RU of a complete set of RUs associated with the first RU size includes a same quantity of pilot tones associated with the IM mode and a same quantity of data tones. In some examples, the fixed tone locations of the set of multiple pilot tones associated with the IM mode are shared across a first RU associated with the first RU size and a second RU associated with a second RU size in accordance with the first RU and the second RU having tone locations in common.

Additionally, or alternatively, the wireless communication device 2200 may support wireless communication in accordance with some other examples as disclosed herein. In some examples, the association management component 2225 is configurable or configured to communicate information indicative of an ON state associated with an IM mode for a physical layer protocol data unit (PPDU). In some examples, the PPDU transmission component 2230 is configurable or configured to transmit, in accordance with the information, the PPDU including a data portion associated with the IM mode, the data portion associated with a first resource unit (RU) size and including a set of multiple pilot tones associated with the IM mode, the set of multiple pilot tones at fixed tone locations associated with the first RU size, and including a set of multiple data tones interleaved within the data portion in accordance with a first tone interleaver that corresponds to the ON state associated with the IM mode.

In some examples, the PPDU transmission component 2230 is configurable or configured to interleave the set of multiple data tones in accordance with the first tone interleaver that corresponds to the ON state associated with the IM mode in association with inputting, into the first tone interleaver, a first set of multiple tone indexes and obtaining, as an output of the first tone interleaver, a second set of multiple tone indexes. In some examples, transmitting the PPDU is in association with interleaving the set of multiple data tones.

In some examples, the first tone interleaver converts a first tone index of the first set of multiple tone indexes to a second tone index of the second set of multiple tone indexes in accordance with a first tone mapping operation in association with the first tone index satisfying a condition or a second tone mapping operation in association with the first tone index failing to satisfy the condition.

In some examples, the first tone index satisfies the condition in association with a modulo between the first tone index and a distribution parameter being greater than a threshold value. In some examples, the first tone index fails to satisfy the condition in association with the modulo between the first tone index and the distribution parameter being less than or equal to the threshold value.

In some examples, the distribution parameter is equal to a value determined from a floor function of a quotient between the set of multiple data tones and a tone separation distance. In some examples, the threshold value is equal to a modulo between the set of multiple data tones and the distribution parameter.

In some examples, the PPDU transmission component 2230 is configurable or configured to determine the tone separation distance independent of whether a state associated with the IM mode for the PPDU is the ON state or an OFF state.

In some examples, the PPDU transmission component 2230 is configurable or configured to determine the tone separation distance from a set of multiple tone separation distances associated with the first RU size in accordance with the ON state associated with the IM mode for the PPDU. In some examples, the set of multiple tone separation distances associated with the first RU size includes a first tone separation distance that corresponds to the ON state associated with the IM mode and a second tone separation distance that corresponds to an OFF state associated with the IM mode.

In some examples, the distribution parameter corresponds to a quantity of output bins into which the first tone interleaver distributes the first set of multiple tone indexes.

In some examples, the first tone mapping operation is associated with a tone adjustment and the second tone mapping operation is associated with an absence of the tone adjustment.

In some examples, the first tone interleaver converts a first tone index of the first set of multiple tone indexes to a second tone index of the second set of multiple tone indexes in accordance with a single tone mapping operation commonly applicable to each tone index of the first set of multiple tone indexes.

In some examples, the PPDU transmission component 2230 is configurable or configured to determine a tone separation distance, a first quantity of the set of multiple data tones, and a second quantity of the set of multiple pilot tones in accordance with a condition associated with the single tone mapping operation.

In some examples, the PPDU transmission component 2230 is configurable or configured to determine the first tone interleaver from a set of multiple tone interleavers in accordance with the ON state associated with the IM mode for the PPDU. In some examples, the set of multiple tone interleavers includes the first tone interleaver that corresponds to the ON state associated with the IM mode and a second tone interleaver that corresponds to an OFF state associated with the IM mode.

In some examples, at least a portion of the set of multiple pilot tones associated with the IM mode are evenly spaced within the data portion.

In some examples, the data portion of the PPDU further includes a second set of multiple pilot tones associated with a carrier frequency offset (CFO) measurement. In some examples, the fixed tone locations of the set of multiple pilot tones associated with the IM mode are non-overlapping with the second set of multiple pilot tones associated with the CFO measurement.

In some examples, each RU of a complete set of RUs associated with the first RU size includes a same quantity of pilot tones associated with the IM mode and a same quantity of data tones. In some examples, the fixed tone locations of the set of multiple pilot tones associated with the IM mode are shared across a first RU associated with the first RU size and a second RU associated with a second RU size in accordance with the first RU and the second RU having tone locations in common.

Additionally, or alternatively, the wireless communication device 2200 may support wireless communication in accordance with some other examples as disclosed herein. In some examples, the association management component 2225 is configurable or configured to communicate information indicative of an ON state associated with an IM mode for a PPDU. The PPDU reception component 2240 is configurable or configured to receive, in accordance with the information, the PPDU including a data portion associated with the IM mode, the data portion associated with a first RU size and including a set of multiple pilot tones associated with the IM mode, the set of multiple pilot tones at fixed tone locations associated with the first RU size, and including a set of multiple data tones interleaved within the data portion in accordance with a first tone separation distance that corresponds to the ON state associated with the IM mode.

In some examples, the PPDU reception component 2240 is configurable or configured to deinterleave the set of multiple data tones in accordance with the first tone separation distance that corresponds to the ON state associated with the IM mode. In some examples, receiving the PPDU is in association with deinterleaving the set of multiple data tones.

Additionally, or alternatively, the wireless communication device 2200 may support wireless communication in accordance with some other examples as disclosed herein. In some examples, the association management component 2225 is configurable or configured to communicate information indicative of an ON state associated with an IM mode for a PPDU. In some examples, the PPDU reception component 2240 is configurable or configured to receive, in accordance with the information, the PPDU including a data portion associated with the IM mode, the data portion associated with a first RU size and including a set of multiple pilot tones associated with the IM mode, the set of multiple pilot tones at fixed tone locations associated with the first RU size, and including a set of multiple data tones interleaved within the data portion in accordance with a first tone interleaver that corresponds to the ON state associated with the IM mode.

In some examples, the PPDU reception component 2240 is configurable or configured to deinterleave the set of multiple data tones in accordance with the first tone interleaver that corresponds to the ON state associated with the IM mode in association with inputting, into the first tone interleaver, a first set of multiple tone indexes and obtaining, as an output of the first tone interleaver, a second set of multiple tone indexes. In some examples, receiving the PPDU is in association with deinterleaving the set of multiple data tones.

Additionally, or alternatively, the wireless communication device 2200 may support wireless communication in accordance with some other examples as disclosed herein. The association management component 2225 is configurable or configured to communicate first information indicative of an ON state of an IM mode for a PPDU. The PPDU transmission component 2230 is configurable or configured to communicate second information indicative of at least one punctured subchannel within a channel bandwidth of the PPDU. In some examples, the PPDU transmission component 2230 is configurable or configured to transmit the PPDU via a subset of the channel bandwidth in accordance with the at least one punctured subchannel within the channel bandwidth. In some examples, the PPDU includes a data portion based on (such as associated with, as a function of, or otherwise in accordance with) the IM mode in accordance with the first information. In some examples, the data portion includes at least an MRU in accordance with the second information. In some examples, the MRU includes a set of multiple pilot tones corresponding to the IM mode and a set of multiple data tones that are interleaved within the MRU in accordance with a first tone separation distance, of a set of multiple tone separation distances defined for the MRU, that corresponds to the ON state of the IM mode. A data portion that is based on the IM mode may be a data portion (including one or more data fields) that includes at least one pilot tone usable for an interference (such as an IM) measurement.

In some examples, the PPDU transmission component 2230 is configurable or configured to interleave the set of multiple pilot tones corresponding to the IM mode and the set of multiple data tones in accordance with the first tone separation distance that corresponds to the ON state of the IM mode. In some examples, transmitting the PPDU is in accordance with interleaving the set of multiple pilot tones corresponding to the IM mode and the set of multiple data tones.

In some examples, the PPDU transmission component 2230 is configurable or configured to determine the first tone separation distance from the set of multiple tone separation distances defined for the MRU in accordance with the ON state of the IM mode for the PPDU. In some examples, the set of multiple tone separation distances defined for the MRU includes the first tone separation distance that corresponds to the ON state of the IM mode and includes a second tone separation distance that corresponds to an OFF state of the IM mode.

In some examples, the first tone separation distance is equal to 9 tones. In some examples, the second tone separation distance is equal to 18 tones.

In some examples, the MRU is an MRU484+242.

In some examples, in accordance with the ON state of the IM mode, the set of multiple pilot tones corresponding the IM mode includes 78 pilot tones and the set of multiple data tones includes 624 data tones.

In some examples, the channel bandwidth is equal to 160 MHz. In some examples, the data portion further includes an RU996 in accordance with the channel bandwidth being equal to 160 MHz and in accordance with the at least one punctured subchannel including a 20 MHz subchannel.

In some examples, the RU996 includes a second set of multiple pilot tones corresponding to the IM mode and a second set of multiple data tones that are interleaved within the RU996 in accordance with a second tone separation distance, of a second set of multiple tone separation distances defined for the RU996, that corresponds to the ON state of the IM mode.

In some examples, the channel bandwidth is equal to 80 MHz. In some examples, the data portion exclusively includes the MRU484+242 in accordance with the channel bandwidth being equal to 80 MHz and in accordance with the at least one punctured subchannel including a 20 MHz subchannel.

In some examples, the PPDU is a punctured SU PPDU. In some examples, the channel bandwidth is greater than or equal to 80 MHz.

In some examples, the data portion of the PPDU further includes a second set of multiple pilot tones corresponding to a CFO measurement.

In some examples, the MRU is based on a parameter value for a quantity of data tones in a fractional RU increment to use in a pre-FEC padding calculation, of a set of multiple parameter values defined for the MRU for the quantity of data tones in the fractional RU increment to use in pre-FEC padding calculations, that corresponds to the ON state of the IM mode. In some examples, the MRU is an MRU484+242. In such examples, the parameter value is equal to 156.

In some examples, each MRU of a set of multiple MRUs (such as each MRU size of a set of multiple MRU sizes) is defined with a respective parameter value of a set of multiple parameter values, for the quantity of data tones in the fractional RU increment to use in the pre-FEC padding calculation, that corresponds to the ON state of the IM mode.

In some examples, the set of parameter values includes a first parameter value defined for MRU484+242 and equal to 156, a second parameter value defined for MRU996+484 and equal to 324, a third parameter value defined for MRU996+484+242 and equal to 372, a fourth parameter value defined for MRU2×996+484 and equal to 552, a fifth parameter value defined for MRU3×996 and equal to 660, and a sixth parameter value defined for MRU3×996+484 and equal to 768.

In some examples, the set of parameter values includes a first parameter value defined for MRU484+242 and equal to 156, a second parameter value defined for MRU996+484 and equal to 324, a third parameter value defined for MRU996+484+242 and equal to 372, a fourth parameter value defined for MRU2×996+484 and equal to 540, a fifth parameter value defined for MRU3×996 and equal to 660, and a sixth parameter value defined for MRU3×996+484 and equal to 768.

Additionally, or alternatively, the wireless communication device 2200 may support wireless communication in accordance with some other examples as disclosed herein. In some examples, the association management component 2225 is configurable or configured to communicate information indicative of an ON state of an IM mode for a PPDU. In some examples, the PPDU transmission component 2230 is configurable or configured to transmit the PPDU via a channel bandwidth. In some examples, the PPDU includes a data portion based on (such as associated with, a function of, or otherwise in accordance with) the IM mode in accordance with the information. In some examples, the data portion includes a first RU that includes a set of multiple pilot tones usable as IM pilot tones corresponding to the IM mode and usable as CFO pilot tones in accordance with the ON state of the IM mode, the set of multiple pilot tones at fixed tone locations within the first RU, and includes a set of multiple data tones interleaved within the first RU in accordance with a first tone separation distance, of a set of multiple tone separation distances defined for the first RU, that corresponds to the ON state of the IM mode. A data portion that is based on the IM mode may be a data portion (including one or more data fields) that includes at least one pilot tone usable for an interference (such as an IM) measurement.

In some examples, the PPDU transmission component 2230 is configurable or configured to interleave the set of multiple data tones in accordance with the first tone separation distance that corresponds to the ON state of the IM mode. In some examples, transmitting the PPDU is in accordance with interleaving the set of multiple data tones.

In some examples, the PPDU transmission component 2230 is configurable or configured to determine the first tone separation distance from the set of multiple tone separation distances defined for the first RU in accordance with the ON state of the IM mode for the PPDU. In some examples, the set of multiple tone separation distances defined for the first RU includes the first tone separation distance that corresponds to the ON state of the IM mode and includes a second tone separation distance that corresponds to an OFF state of the IM mode.

In some examples, the first RU has a first RU size. In some examples, the fixed tone locations within the first RU correspond, at least in part, to CFO pilot tone locations of a set of multiple RUs having a second RU size smaller than the first RU size.

In some examples, the fixed tone locations within the first RU correspond to a full union of all the CFO pilot tone locations of the set of multiple RUs having the second RU size.

In some examples, the fixed tone locations within the first RU correspond to a subset of the CFO pilot tone locations of the set of multiple RUs having the second RU size.

In some examples, the fixed tone locations within the first RU correspond to at least a subset of the CFO pilot tone locations of the set of multiple RUs having the second RU size and to one or more additional tone locations within the first RU.

In some examples, the second RU size is RU26.

In some examples, the channel bandwidth is equal to 20 MHz and the first RU is an RU242. In some examples, the set of multiple pilot tones includes 18 pilot tones. In some examples, the set of multiple data tones includes 224 data tones. In some examples, the first tone separation distance is equal to 8 tones.

In some examples, the channel bandwidth is equal to 40 MHz and the first RU is an RU484. In some examples, the set of multiple pilot tones includes 36 pilot tones. In some examples, the set of multiple data tones includes 448 data tones. In some examples, the first tone separation distance is equal to 8 tones.

In some examples, the channel bandwidth is equal to 80 MHz and the first RU is an RU996. In some examples, the set of multiple pilot tones includes 84 pilot tones. In some examples, the set of multiple data tones includes 896 data tones. In some examples, the first tone separation distance is equal to 16 tones.

Additionally, or alternatively, the wireless communication device 2200 may support wireless communication in accordance with some other examples as disclosed herein. In some examples, the association management component 2225 is configurable or configured to communicate first information indicative of an ON state of an IM mode for a PPDU. The PPDU reception component 2240 is configurable or configured to communicate second information indicative of at least one punctured subchannel within a channel bandwidth of the PPDU. In some examples, the PPDU reception component 2240 is configurable or configured to receive the PPDU via a subset of the channel bandwidth in accordance with the at least one punctured subchannel within the channel bandwidth. In some examples, the PPDU includes a data portion based on (such as associated with, a function of, or otherwise in accordance with) the IM mode in accordance with the first information. In some examples, the data portion includes at least an MRU in accordance with the second information. In some examples, the MRU includes a set of multiple pilot tones corresponding to the IM mode and a set of multiple data tones that are interleaved within the MRU in accordance with a first tone separation distance, of a set of multiple tone separation distances defined for the MRU, that corresponds to the ON state of the IM mode. A data portion that is based on the IM mode may be a data portion (including one or more data fields) that includes at least one pilot tone usable for an interference (such as an IM) measurement.

In some examples, the PPDU reception component 2240 is configurable or configured to deinterleave the set of multiple pilot tones corresponding to the IM mode and the set of multiple data tones in accordance with the first tone separation distance that corresponds to the ON state of the IM mode. In some examples, receiving the PPDU is in accordance with deinterleaving the set of multiple pilot tones corresponding to the IM mode and the set of multiple data tones.

Additionally, or alternatively, the wireless communication device 2200 may support wireless communication in accordance with examples as disclosed herein. In some examples, the association management component 2225 is configurable or configured to communicate information indicative of an ON state of an IM mode for a PPDU. In some examples, the PPDU reception component 2240 is configurable or configured to receive the PPDU via a channel bandwidth. In some examples, the PPDU includes a data portion based on (such as associated with, a function of, or otherwise in accordance with) the IM mode in accordance with the information. In some examples, the data portion includes a first RU that includes a set of multiple pilot tones usable as IM pilot tones corresponding to the IM mode and usable as CFO pilot tones in accordance with the ON state of the IM mode, the set of multiple pilot tones at fixed tone locations within the first RU, and includes a set of multiple data tones interleaved within the first RU in accordance with a first tone separation distance, of a set of multiple tone separation distances defined for the first RU, that corresponds to the ON state of the IM mode. A data portion that is based on the IM mode may be a data portion (including one or more data fields) that includes at least one pilot tone usable for an interference (such as an IM) measurement.

In some examples, the PPDU reception component 2240 is configurable or configured to deinterleave the set of multiple data tones in accordance with the first tone separation distance that corresponds to the ON state of the IM mode. In some examples, receiving the PPDU is in accordance with deinterleaving the set of multiple data tones.

FIG. 23 shows a flowchart illustrating an example process 2300 performable by or at a wireless communication device that supports IM mode signaling designs for a PPDU. The operations of the process 2300 may be implemented by a first wireless communication device or its components. For example, the process 2300 may be performed by a wireless communication device, such as the wireless communication device 2200 described with reference to FIG. 22, operating as or within a wireless AP or a wireless STA. In some examples, the process 2300 may be performed by a wireless AP or a wireless STA, such as one of the APs 102 or the STAs 104 described with reference to FIG. 1.

In some examples, in 2305, the first wireless communication device may communicate one or more management frames with at least a second wireless communication device, the one or more management frames including first information indicative of a capability to support an IM mode associated with one or more PPDUs communicated between the first wireless communication device and at least the second wireless communication device. The operations of 2305 may be performed in accordance with examples as disclosed herein. In some implementations, aspects of the operations of 2305 may be performed by an association management component 2225 as described with reference to FIG. 22.

In some examples, in 2310, the first wireless communication device may transmit, to at least the second wireless communication device in accordance with the capability, a first PPDU including a preamble portion and a data portion, the preamble portion of the first PPDU including second information indicative of a state associated with the IM mode for the first PPDU or for a second PPDU transmitted by at least the second wireless communication device to the first wireless communication device. The operations of 2310 may be performed in accordance with examples as disclosed herein. In some implementations, aspects of the operations of 2310 may be performed by a PPDU transmission component 2230 as described with reference to FIG. 22.

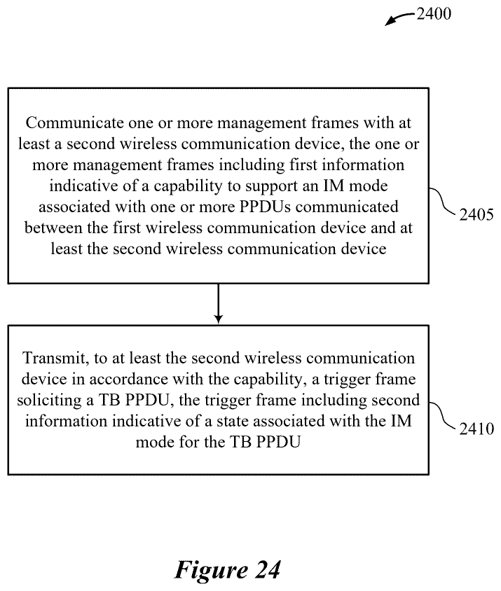

FIG. 24 shows a flowchart illustrating an example process 2400 performable by or at a wireless communication device that supports IM mode signaling designs for a PPDU. The operations of the process 2400 may be implemented by a first wireless communication device or its components. For example, the process 2400 may be performed by a wireless communication device, such as the wireless communication device 2200 described with reference to FIG. 22, operating as or within a wireless AP or a wireless STA. In some examples, the process 2400 may be performed by a wireless AP or a wireless STA, such as one of the APs 102 or the STAs 104 described with reference to FIG. 1.

In some examples, in 2405, the first wireless communication device may communicate one or more management frames with at least a second wireless communication device, the one or more management frames including first information indicative of a capability to support an IM mode associated with one or more PPDUs communicated between the first wireless communication device and at least the second wireless communication device. The operations of 2405 may be performed in accordance with examples as disclosed herein. In some implementations, aspects of the operations of 2405 may be performed by an association management component 2225 as described with reference to FIG. 22.

In some examples, in 2410, the first wireless communication device may transmit, to at least the second wireless communication device in accordance with the capability, a trigger frame soliciting a TB PPDU, the trigger frame including second information indicative of a state associated with the IM mode for the TB PPDU. The operations of 2410 may be performed in accordance with examples as disclosed herein. In some implementations, aspects of the operations of 2410 may be performed by a trigger frame component 2235 as described with reference to FIG. 22.

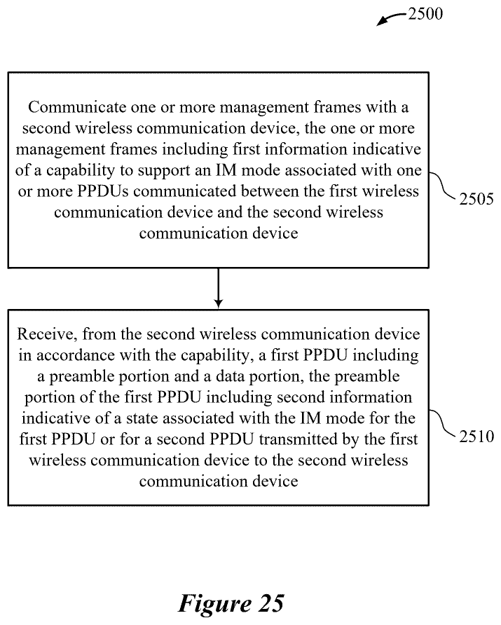

FIG. 25 shows a flowchart illustrating an example process 2500 performable by or at a wireless communication device that supports IM mode signaling designs for a PPDU. The operations of the process 2500 may be implemented by a first wireless communication device or its components. For example, the process 2500 may be performed by a wireless communication device, such as the wireless communication device 2200 described with reference to FIG. 22, operating as or within a wireless AP or a wireless STA. In some examples, the process 2500 may be performed by a wireless AP or a wireless STA, such as one of the APs 102 or the STAs 104 described with reference to FIG. 1.

In some examples, in 2505, the first wireless communication device may communicate one or more management frames with a second wireless communication device, the one or more management frames including first information indicative of a capability to support an IM mode associated with one or more PPDUs communicated between the first wireless communication device and the second wireless communication device. The operations of 2505 may be performed in accordance with examples as disclosed herein. In some implementations, aspects of the operations of 2505 may be performed by an association management component 2225 as described with reference to FIG. 22.

In some examples, in 2510, the first wireless communication device may receive, from the second wireless communication device in accordance with the capability, a first PPDU including a preamble portion and a data portion, the preamble portion of the first PPDU including second information indicative of a state associated with the IM mode for the first PPDU or for a second PPDU transmitted by the first wireless communication device to the second wireless communication device. The operations of 2510 may be performed in accordance with examples as disclosed herein. In some implementations, aspects of the operations of 2510 may be performed by a PPDU reception component 2240 as described with reference to FIG. 22.

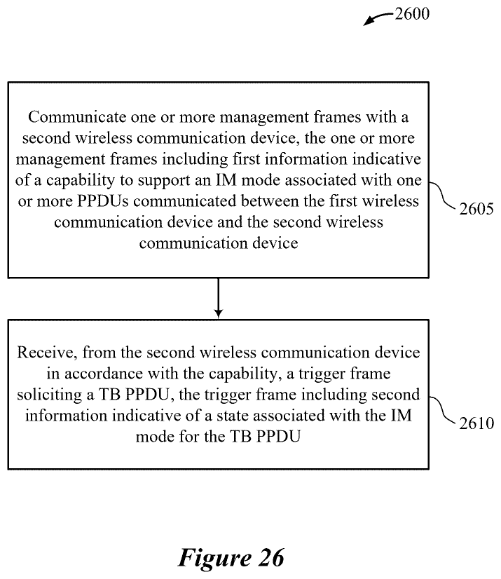

FIG. 26 shows a flowchart illustrating an example process 2600 performable by or at a wireless communication device that supports IM mode signaling designs for a PPDU. The operations of the process 2600 may be implemented by a first wireless communication device or its components. For example, the process 2600 may be performed by a wireless communication device, such as the wireless communication device 2200 described with reference to FIG. 22, operating as or within a wireless AP or a wireless STA. In some examples, the process 2600 may be performed by a wireless AP or a wireless STA, such as one of the APs 102 or the STAs 104 described with reference to FIG. 1.

In some examples, in 2605, the first wireless communication device may communicate one or more management frames with a second wireless communication device, the one or more management frames including first information indicative of a capability to support an IM mode associated with one or more PPDUs communicated between the first wireless communication device and the second wireless communication device. The operations of 2605 may be performed in accordance with examples as disclosed herein. In some implementations, aspects of the operations of 2605 may be performed by an association management component 2225 as described with reference to FIG. 22.

In some examples, in 2610, the first wireless communication device may receive, from the second wireless communication device in accordance with the capability, a trigger frame soliciting a TB PPDU, the trigger frame including second information indicative of a state associated with the IM mode for the TB PPDU. The operations of 2610 may be performed in accordance with examples as disclosed herein. In some implementations, aspects of the operations of 2610 may be performed by a trigger frame component 2235 as described with reference to FIG. 22.

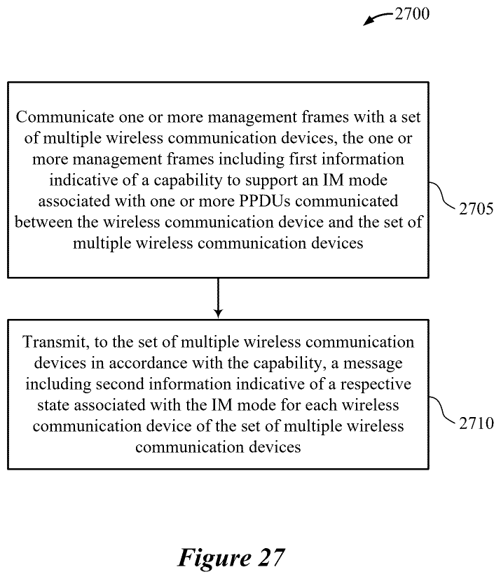

FIG. 27 shows a flowchart illustrating an example process 2700 performable by or at a wireless communication device that supports IM mode signaling designs for a PPDU. The operations of the process 2700 may be implemented by a wireless communication device or its components. For example, the process 2700 may be performed by the wireless communication device 2200 described with reference to FIG. 22, operating as or within a wireless AP or a wireless STA. In some examples, the process 2700 may be performed by a wireless AP or a wireless STA, such as one of the APs 102 or the STAs 104 described with reference to FIG. 1.

In some examples, in 2705, the wireless communication device may communicate one or more management frames with a set of multiple wireless communication devices, the one or more management frames including first information indicative of a capability to support an IM mode associated with one or more PPDUs communicated between the wireless communication device and the set of multiple wireless communication devices. The operations of 2705 may be performed in accordance with examples as disclosed herein. In some implementations, aspects of the operations of 2705 may be performed by an association management component 2225 as described with reference to FIG. 22.

In some examples, in 2710, the first wireless communication device may transmit, to the set of multiple wireless communication devices in accordance with the capability, a message including second information indicative of a respective state associated with the IM mode for each wireless communication device of the set of multiple wireless communication devices. The operations of 2710 may be performed in accordance with examples as disclosed herein. In some implementations, aspects of the operations of 2710 may be performed by a trigger frame component 2235 or a PPDU transmission component 2230 as described with reference to FIG. 22.

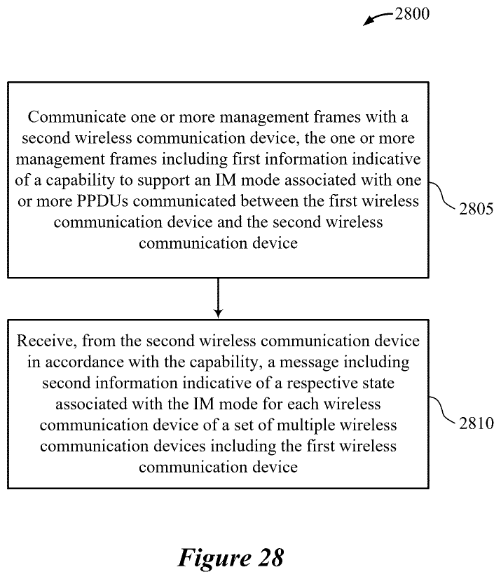

FIG. 28 shows a flowchart illustrating an example process 2800 performable by or at a wireless communication device that supports IM mode signaling designs for a PPDU. The operations of the process 2800 may be implemented by a first wireless communication device or its components. For example, the process 2800 may be performed by the wireless communication device 2200 described with reference to FIG. 22, operating as or within a wireless AP or a wireless STA. In some examples, the process 2800 may be performed by a wireless AP or a wireless STA, such as one of the APs 102 or the STAs 104 described with reference to FIG. 1.

In some examples, in 2805, the first wireless communication device may communicate one or more management frames with a second wireless communication device, the one or more management frames including first information indicative of a capability to support an IM mode associated with one or more PPDUs communicated between the first wireless communication device and the second wireless communication device. The operations of 2805 may be performed in accordance with examples as disclosed herein. In some implementations, aspects of the operations of 2805 may be performed by an association management component 2225 as described with reference to FIG. 22.

In some examples, in 2810, the first wireless communication device may receive, from the second wireless communication device in accordance with the capability, a message including second information indicative of a respective state associated with the IM mode for each wireless communication device of a set of multiple wireless communication devices including the first wireless communication device. The operations of 2810 may be performed in accordance with examples as disclosed herein. In some implementations, aspects of the operations of 2810 may be performed by a trigger frame component 2235 or a PPDU transmission component 2230 as described with reference to FIG. 22.

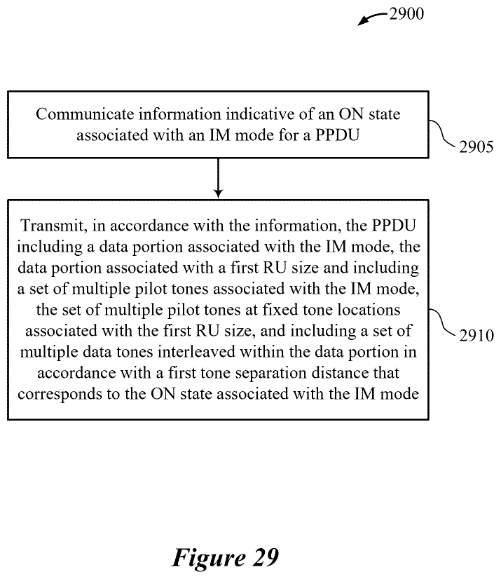

FIG. 29 shows a flowchart illustrating an example process 2900 performable by or at a wireless communication device that supports IM mode signaling designs for a PPDU. The operations of the process 2900 may be implemented by a wireless communication device or its components. For example, the process 2900 may be performed by a wireless communication device, such as the wireless communication device 2200 described with reference to FIG. 22, operating as or within a wireless AP or a wireless STA. In some examples, the process 2900 may be performed by a wireless AP or a wireless STA, such as one of the APs 102 or the STAs 104 described with reference to FIG. 1.

In some examples, in 2905, the wireless communication device may communicate information indicative of an ON state associated with an IM mode for a PPDU. The operations of 2905 may be performed in accordance with examples as disclosed herein. In some implementations, aspects of the operations of 2905 may be performed by an association management component 2225 as described with reference to FIG. 22.

In some examples, in 2910, the wireless communication device may transmit, in accordance with the information, the PPDU including a data portion associated with the IM mode, the data portion associated with a first RU size and including a set of multiple pilot tones associated with the IM mode, the set of multiple pilot tones at fixed tone locations associated with the first RU size, and including a set of multiple data tones interleaved within the data portion in accordance with a first tone separation distance that corresponds to the ON state associated with the IM mode. The operations of 2910 may be performed in accordance with examples as disclosed herein. In some implementations, aspects of the operations of 2910 may be performed by a PPDU transmission component 2230 as described with reference to FIG. 22.

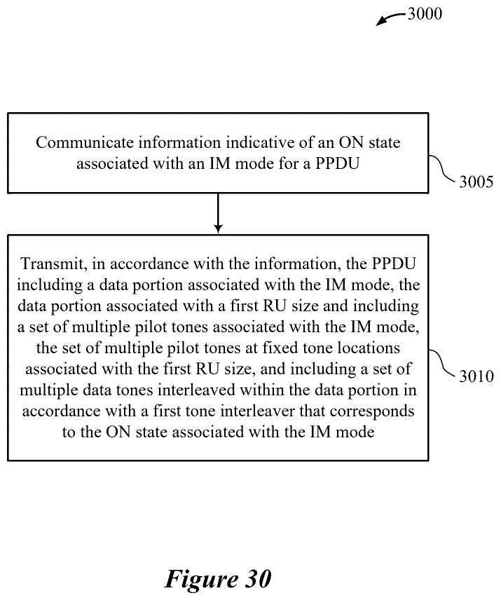

FIG. 30 shows a flowchart illustrating an example process 3000 performable by or at a wireless communication device that supports IM mode signaling designs for a PPDU. The operations of the process 3000 may be implemented by a wireless communication device or its components. For example, the process 3000 may be performed by a wireless communication device, such as the wireless communication device 2200 described with reference to FIG. 22, operating as or within a wireless AP or a wireless STA. In some examples, the process 3000 may be performed by a wireless AP or a wireless STA, such as one of the APs 102 or the STAs 104 described with reference to FIG. 1.

In some examples, in 3005, the wireless communication device may communicate information indicative of an ON state associated with an IM mode for a PPDU. The operations of 3005 may be performed in accordance with examples as disclosed herein. In some implementations, aspects of the operations of 3005 may be performed by an association management component 2225 as described with reference to FIG. 22.

In some examples, in 3010, the wireless communication device may transmit, in accordance with the information, the PPDU including a data portion associated with the IM mode, the data portion associated with a first RU size and including a set of multiple pilot tones associated with the IM mode, the set of multiple pilot tones at fixed tone locations associated with the first RU size, and including a set of multiple data tones interleaved within the data portion in accordance with a first tone interleaver that corresponds to the ON state associated with the IM mode. The operations of 3010 may be performed in accordance with examples as disclosed herein. In some implementations, aspects of the operations of 3010 may be performed by a PPDU transmission component 2230 as described with reference to FIG. 22.

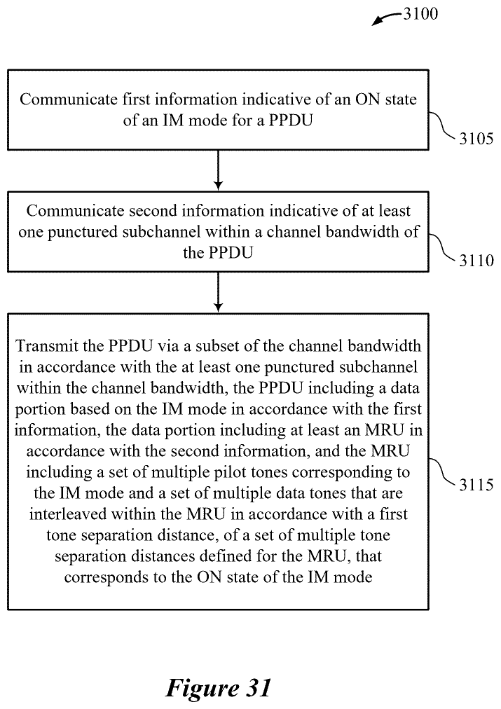

FIG. 31 shows a flowchart illustrating an example process 3100 performable by or at a wireless communication device that supports IM mode signaling designs for a PPDU. The operations of the process 3100 may be implemented by a wireless communication device or its components. For example, the process 3100 may be performed by a wireless communication device, such as the wireless communication device 2200 described with reference to FIG. 22, operating as or within a wireless AP or a wireless STA. In some examples, the process 3100 may be performed by a wireless AP or a wireless STA, such as one of the APs 102 or the STAs 104 described with reference to FIG. 1.

In some examples, in 3105, the wireless communication device may communicate first information indicative of an ON state of an IM mode for a PPDU. In some implementations, aspects of the operations of 3105 may be performed by an association management component 2225 as described with reference to FIG. 22.

In some examples, in 3110, the wireless communication device may communicate second information indicative of at least one punctured subchannel within a channel bandwidth of the PPDU. In some implementations, aspects of the operations of 3110 may be performed by a PPDU transmission component 2230 as described with reference to FIG. 22.

In some examples, in 3115, the wireless communication device may transmit the PPDU via a subset of the channel bandwidth in accordance with the at least one punctured subchannel within the channel bandwidth, the PPDU including a data portion based on the IM mode in accordance with the first information, the data portion including at least an MRU in accordance with the second information, and the MRU including a set of multiple pilot tones corresponding to the IM mode and a set of multiple data tones that are interleaved within the MRU in accordance with a first tone separation distance, of a set of multiple tone separation distances defined for the MRU, that corresponds to the ON state of the IM mode. In some implementations, aspects of the operations of 3115 may be performed by a PPDU transmission component 2230 as described with reference to FIG. 22.

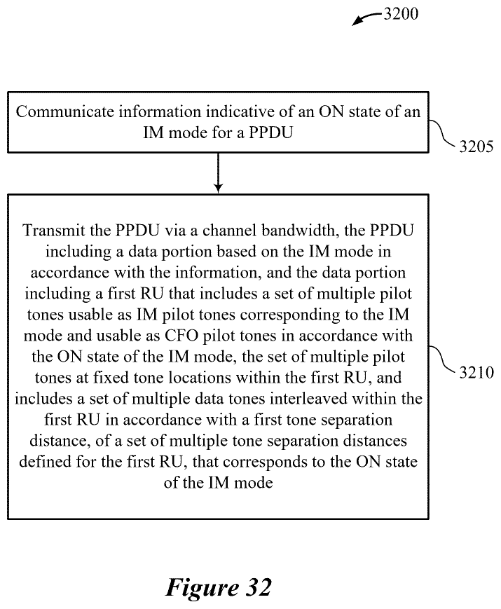

FIG. 32 shows a flowchart illustrating an example process 3200 performable by or at a wireless communication device that supports IM mode signaling designs for a PPDU. The operations of the process 3200 may be implemented by a wireless communication device or its components. For example, the process 3200 may be performed by a wireless communication device, such as the wireless communication device 2200 described with reference to FIG. 22, operating as or within a wireless AP or a wireless STA. In some examples, the process 3200 may be performed by a wireless AP or a wireless STA, such as one of the APs 102 or the STAs 104 described with reference to FIG. 1.

In some examples, in 3205, the wireless communication device may communicate information indicative of an ON state of an IM mode for a PPDU. In some implementations, aspects of the operations of 3205 may be performed by an association management component 2225 as described with reference to FIG. 22.

In some examples, in 3210, the wireless communication device may transmit the PPDU via a channel bandwidth, the PPDU including a data portion based on the IM mode in accordance with the information, and the data portion including a first RU that includes a set of multiple pilot tones usable as IM pilot tones corresponding to the IM mode and usable as CFO pilot tones in accordance with the ON state of the IM mode, the set of multiple pilot tones at fixed tone locations within the first RU, and includes a set of multiple data tones interleaved within the first RU in accordance with a first tone separation distance, of a set of multiple tone separation distances defined for the first RU, that corresponds to the ON state of the IM mode. In some implementations, aspects of the operations of 3210 may be performed by a PPDU transmission component 2230 as described with reference to FIG. 22.

Implementation examples are described in the following numbered clauses:

Clause 1: A method for wireless communication by a first wireless communication device, including: communicating (such as transmitting to and/or receiving from) one or more management frames with at least a second wireless communication device, the one or more management frames including first information indicative of a capability to support an IM mode associated with one or more PPDUs communicated between the first wireless communication device and at least the second wireless communication device; and communicating (such as transmitting to and/or receiving from), with at least the second wireless communication device in accordance with the capability, a first PPDU including a preamble portion and a data portion, the preamble portion of the first PPDU including second information indicative of a state associated with the IM mode for the first PPDU or for a second PPDU transmitted by at least the second wireless communication device to the first wireless communication device.

Clause 2: The method of clause 1, where the second information is indicative of the state associated with the IM mode for the first PPDU, and a data field within the data portion of the first PPDU is in accordance with the state associated with the IM mode.

Clause 3: The method of any of clauses 1-2, where the second information is indicative of the state associated with the IM mode for the second PPDU, the method further including: communicating (such as transmitting to and/or receiving from) the second PPDU with at least the second wireless communication device, where a data field of the second PPDU is in accordance with the state associated with the IM mode.

Clause 4: The method of clause 3, where the second information includes a request or a command for the state associated with the IM mode for the second PPDU.

Clause 5: The method of any of clauses 1-4, where the preamble portion of the first PPDU includes a U-SIG field and a UHR-SIG common field, and one or more first bits within a version-dependent portion of the U-SIG field or within the UHR-SIG common field indicate the second information.

Clause 6: The method of clause 5, where the second information is indicative of the state associated with the IM mode for the first PPDU, the one or more first bits include a single bit, and a first value of the single bit indicates that the state associated with the IM mode for the first PPDU is an ON state and a second value of the single bit indicates that the state associated with the IM mode for the first PPDU is an OFF state.

Clause 7: The method of any of clauses 5-6, where the second information is indicative of a requested or commanded state associated with the IM mode for the second PPDU, the one or more first bits include a single bit, and a first value of the single bit indicates that the requested or commanded state associated with the IM mode for the second PPDU is an ON state and a second value of the single bit indicates that the requested or commanded state associated with the IM mode for the second PPDU is an OFF state.

Clause 8: The method of any of clauses 5-7, where the one or more first bits include two or more bits, and a first codepoint associated with the two or more bits indicates that the state associated with the IM mode is an ON state.

Clause 9: The method of clause 8, where another codepoint associated with the two or more bits different than the first codepoint indicates that the state associated with the IM mode is an OFF state.

Clause 10: The method of any of clauses 5-9, where the version-dependent portion of the U-SIG field or the UHR-SIG common field further includes one or more second bits, and the one or more second bits indicate one or more parameters associated with the IM mode for the first PPDU or the second PPDU.

Clause 11: The method of any of clauses 5-10, where the one or more first bits within the version-dependent portion of the U-SIG field or within the UHR-SIG common field include at least a first bit indicating a first state associated with the IM mode for the first PPDU and include at least a second bit indicating a second state associated with the IM mode for the second PPDU.

Clause 12: The method of any of clauses 1-11, where the first PPDU or the second PPDU is associated with a full bandwidth transmission.

Clause 13: The method of any of clauses 1-12, where the first PPDU or the second PPDU is associated with an orthogonal frequency division multiple access (OFDMA) transmission, and each receiver of a set of receivers of the first PPDU or the second PPDU has the capability to support the IM mode.

Clause 14: The method of clause 13, where the state associated with the IM mode is either an ON state or an OFF state for the set of receivers of the first PPDU or the second PPDU in association with the first PPDU or the second PPDU being associated with the OFDMA transmission.

Clause 15: The method of any of clauses 1-14, where the IM mode is associated with a plurality of pilot tones, and the plurality of pilot tones is distributed over a plurality of time-frequency locations within a resource grid associated with a data field of the first PPDU or the second PPDU in accordance with a pattern.

Clause 16: The method of clause 15, where the pattern defines that the plurality of pilot tones is located within a fixed plurality of non-contiguous subcarriers over a plurality of contiguous symbols associated with the data field; varying subcarriers over the plurality of contiguous symbols associated with the data field; or a fixed plurality of contiguous subcarriers that spans a full bandwidth over a fixed plurality of non-contiguous symbols associated with the data field.

Clause 17: The method of any of clauses 15-16, where the plurality of pilot tones is associated with null-tone values, or the plurality of pilot tones is associated with a sequence of plus-one or minus-one values.

Clause 18: The method of any of clauses 1-17, where at least one management frame of the one or more management frames includes a capability element, and the capability element includes the first information indicative of the capability to support the IM mode.

Clause 19: A method for wireless communication by a first wireless communication device, including: communicating (such as transmitting to and/or receiving from) one or more management frames with at least a second wireless communication device, the one or more management frames including first information indicative of a capability to support an IM mode associated with one or more PPDUs communicated between the first wireless communication device and at least the second wireless communication device; and communicating (such as transmitting to and/or receiving from), with at least the second wireless communication device in accordance with the capability, a trigger frame soliciting a TB PPDU, the trigger frame including second information indicative of a state associated with the IM mode for the TB PPDU.

Clause 20: The method of clause 19, further including: communicating (such as transmitting to and/or receiving from) the TB PPDU with at least the second wireless communication device, where a data field of the TB PPDU is in accordance with the state associated with the IM mode.

Clause 21: The method of any of clauses 19-20, where the trigger frame includes one or both of a common information field or a special user information field, and one or more first bits within the common information field or the special user information field indicate the second information.

Clause 22: The method of clause 21, where the one or more first bits include a single bit, and a first value of the single bit indicates that the state associated with the IM mode is an ON state and a second value of the single bit indicates that the state associated with the IM mode is an OFF state.

Clause 23: The method of any of clauses 21-22, where the one or more first bits include two or more bits, and a first codepoint associated with the two or more bits indicates that the state associated with the IM mode is an ON state.

Clause 24: The method of clause 23, where another codepoint associated with the two or more bits different than the first codepoint indicates that the state associated with the IM mode is an OFF state.

Clause 25: The method of any of clauses 21-24, where the common information field or the special user information field further includes one or more second bits, and the one or more second bits indicate one or more parameters associated with the IM mode for the TB PPDU.

Clause 26: The method of any of clauses 19-25, where the TB PPDU is associated with a full bandwidth transmission.

Clause 27: The method of any of clauses 19-26, where the IM mode is associated with a plurality of pilot tones, and the plurality of pilot tones is distributed over a plurality of time-frequency locations within a resource grid associated with a data field of the TB PPDU in accordance with a pattern.

Clause 28: The method of clause 27, where the pattern defines that the plurality of pilot tones is located within a fixed plurality of non-contiguous subcarriers over a plurality of contiguous symbols associated with the data field; varying subcarriers over the plurality of contiguous symbols associated with the data field; or a fixed plurality of contiguous subcarriers that spans a full bandwidth over a fixed plurality of non-contiguous symbols associated with the data field.

Clause 29: The method of any of clauses 27-28, where the plurality of pilot tones is associated with null-tone values, or the plurality of pilot tones is associated with a sequence of plus-one or minus-one values.

Clause 30: The method of any of clauses 19-29, where at least one management frame of the one or more management frames includes a capability element, and the capability element includes the first information indicative of the capability to support the IM mode.

Clause 31: A first wireless communication device, including a processing system that includes processor circuitry and memory circuitry that stores code, the processing system configured to cause the first wireless communication device to perform a method of any of clauses 1-18.

Clause 32: A first wireless communication device, including at least one means for performing a method of any of clauses 1-18.

Clause 33: A non-transitory computer-readable medium storing code for wireless communication, the code including instructions executable by one or more processors (such as a processing system) to perform a method of any of clauses 1-18.

Clause 34: A first wireless communication device, including a processing system that includes processor circuitry and memory circuitry that stores code, the processing system configured to cause the first wireless communication device to perform a method of any of clauses 19-30.

Clause 35: A first wireless communication device, including at least one means for performing a method of any of clauses 19-30.

Clause 36: A non-transitory computer-readable medium storing code for wireless communication, the code including instructions executable by one or more processors (such as a processing system) to perform a method of any of clauses 19-30.

Clause 37: A method for wireless communication by a wireless communication device, including: communicating one or more management frames with a plurality of wireless communication devices, the one or more management frames including first information indicative of a capability to support an IM mode associated with one or more PPDUs communicated between the wireless communication device and the plurality of wireless communication devices; and transmitting, to the plurality of wireless communication devices in accordance with the capability, a message including second information indicative of a respective state associated with the IM mode for each wireless communication device of the plurality of wireless communication devices.

Clause 38: The method of clause 37, where the message includes a field that is applicable to the plurality of wireless communication devices, and the field that is applicable to the plurality of wireless communication devices includes the second information indicative of the respective state associated with the IM mode for each wireless communication device of the plurality of wireless communication devices.

Clause 39: The method of clause 38, where the field that is applicable to the plurality of wireless communication devices includes a subfield associated with the IM mode; and the subfield associated with the IM mode indicates a single RU or MRU, of a plurality of RUs or MRUs allocated by the message, for which the IM mode is associated with an ON state.

Clause 40: The method of any of clauses 38-39, where the field that is applicable to the plurality of wireless communication devices includes a plurality of RU allocation subfields; the plurality of RU allocation subfields allocates a plurality of RUs or MRUs to the plurality of wireless communication devices; and the plurality of RU allocation subfields indicates the respective state associated with the IM mode for each wireless communication device of the plurality of wireless communication devices.

Clause 41: The method of clause 40, where the plurality of RU allocation subfields includes a first RU allocation subfield that allocates a first RU or MRU and that indicates a first state associated with the IM mode for the first RU or MRU and includes a second RU allocation subfield that allocates a second RU or MRU and that indicates a second state associated with the IM mode for the second RU or MRU.

Clause 42: The method of any of clauses 40-41, where the plurality of RU allocation subfields indicates the respective state associated with the IM mode for each wireless communication device of the plurality of wireless communication devices in association with indicating the respective state associated with the IM mode for each RU or MRU of the plurality of RUs or MRUs, each RU or MRU allocated to one or more wireless communication devices of the plurality of wireless communication devices.

Clause 43: The method of any of clauses 38-42, where the field that is applicable to the plurality of wireless communication devices includes a bitmap corresponding to a plurality of subbands, each bit of the bitmap corresponding to a respective subband of the plurality of subbands; and the bitmap corresponding to the plurality of subbands indicates the respective state associated with the IM mode for each wireless communication device of the plurality of wireless communication devices.

Clause 44: The method of clause 43, where a first bit of the bitmap corresponds to a first subband of the plurality of subbands and indicates a first state associated with the IM mode for the first subband; and a second bit of the bitmap corresponds to a second subband of the plurality of subbands and indicates a second state associated with the IM mode for the second subband.

Clause 45: The method of any of clauses 43-44, where the bitmap corresponding to the plurality of subbands indicates the respective state associated with the IM mode for each wireless communication device of the plurality of wireless communication devices in association with indicating the respective state associated with the IM mode for each subband of the plurality of subbands, a union of one or more subbands for which the IM mode is associated with a same state including one or more RUs or MRUs allocated to one or more wireless communication devices of the plurality of wireless communication devices.

Clause 46: The method of any of clauses 38-45, where the field that is applicable to the plurality of wireless communication devices is a U-SIG field, a common field in a UHR-SIG field, a common information field, or a special user information field.

Clause 47: The method of any of clauses 37-46, where the message includes a plurality of user information fields, and the plurality of user information fields indicates the respective state associated with the IM mode for each wireless communication device of the plurality of wireless communication devices.

Clause 48: The method of clause 47, where the plurality of user information fields includes a first user information field associated with a first wireless communication device of the plurality of wireless communication devices that indicates a first state associated with the IM mode for the first wireless communication device and includes a second user information field associated with a second wireless communication device of the plurality of wireless communication devices that indicates a second state associated with the IM mode for the second wireless communication device.

Clause 49: The method of any of clauses 37-48, where the message includes a field that is applicable to the plurality of wireless communication devices and includes a plurality of user information fields associated with the plurality of wireless communication devices; the field that is applicable to the plurality of wireless communication devices indicates whether the IM mode is associated with an ON state for at least one wireless communication device of the plurality of wireless communication devices or is associated with an OFF state for the plurality of wireless communication devices; and a format or an interpretation of the plurality of user information fields is in accordance with whether the IM mode is associated with the ON state for the at least one wireless communication device of the plurality of wireless communication devices or is associated with the OFF state for the plurality of wireless communication devices.

Clause 50: The method of clause 49, where, in accordance with the format or the interpretation of the plurality of user information fields, the plurality of user information fields indicates the respective state associated with the IM mode for each wireless communication device of the plurality of wireless communication devices in association with the field that is applicable to the plurality of wireless communication devices indicating that the IM mode is associated with the ON state for the at least one wireless communication device of the plurality of wireless communication devices.

Clause 51: The method of clause 50, where the plurality of user information fields includes a first user information field associated with a first wireless communication device of the plurality of wireless communication devices that, in accordance with the format or the interpretation of the plurality of user information fields, indicates a first state associated with the IM mode for the first wireless communication device and includes a second user information field associated with a second wireless communication device of the plurality of wireless communication devices that, in accordance with the format or the interpretation of the plurality of user information fields, indicates a second state associated with the IM mode for the second wireless communication device.

Clause 52: The method of any of clauses 49-51, where the field that is applicable to the plurality of wireless communication devices is a U-SIG field, a common field in a UHR-SIG field, a common information field, or a special user information field.

Clause 53: The method of any of clauses 37-52, further including: communicating, with each wireless communication device of the plurality of wireless communication devices, respective data in accordance with the respective state associated with the IM mode corresponding to each wireless communication device of the plurality of wireless communication devices.

Clause 54: The method of clause 53, where the message includes a multi-user (MU) PPDU, and the respective data is communicated with each wireless communication device of the plurality of wireless communication devices via a respective RU or MRU of the MU PPDU in accordance with a single user communication scheme, a non-OFDMA MU-MIMO communication scheme, or an OFDMA communication scheme.

Clause 55: The method of clause 53, where the message includes a trigger frame, and the respective data is received from each wireless communication device of the plurality of wireless communication devices via a respective RU or MRU within a respective TB PPDU in accordance with a single user communication scheme, a non-OFDMA MU-MIMO communication scheme, or an OFDMA communication scheme.

Clause 56: A method for wireless communication by a first wireless communication device, including: communicating one or more management frames with a second wireless communication device, the one or more management frames including first information indicative of a capability to support an IM mode associated with one or more PPDUs communicated between the first wireless communication device and the second wireless communication device; and receiving, from the second wireless communication device in accordance with the capability, a message including second information indicative of a respective state associated with the IM mode for each wireless communication device of a set of multiple wireless communication devices including the first wireless communication device.

Clause 57: The method of clause 56, where the message includes a field that is applicable to the plurality of wireless communication devices and includes a plurality of user information fields associated with the plurality of wireless communication devices; the field that is applicable to the plurality of wireless communication devices indicates whether the IM mode is associated with an ON state for at least one wireless communication device of the plurality of wireless communication devices or is associated with an OFF state for the plurality of wireless communication devices; and a format or an interpretation of the plurality of user information fields is in accordance with whether the IM mode is associated with the ON state for the at least one wireless communication device of the plurality of wireless communication devices or is associated with the OFF state for the plurality of wireless communication devices.

Clause 58: A wireless communication device, including a processing system that includes processor circuitry and memory circuitry that stores code, the processing system configured to cause the wireless communication device to perform a method of any of clauses 37-55.

Clause 59: A wireless communication device for wireless communication, including at least one means for performing a method of any of clauses 37-55.

Clause 60: A non-transitory computer-readable medium storing code for wireless communication, the code including instructions executable by a processing system to perform a method of any of clauses 37-55.

Clause 61: A first wireless communication device, including a processing system that includes processor circuitry and memory circuitry that stores code, the processing system configured to cause the first wireless communication device to perform a method of any of clauses 56-57.

Clause 62: A first wireless communication device for wireless communication, including at least one means for performing a method of any of clauses 56-57.

Clause 63: A non-transitory computer-readable medium storing code for wireless communication, the code including instructions executable by a processing system to perform a method of any of clauses 56-57.

Clause 64: A method for wireless communication by a wireless communication device, including: communicating information indicative of an ON state associated with an IM mode for a PPDU; and transmitting, in accordance with the information, the PPDU including a data portion associated with the IM mode, the data portion associated with a first RU size and including a plurality of pilot tones associated with the IM mode, the plurality of pilot tones at fixed tone locations associated with the first RU size, and including a plurality of data tones interleaved within the data portion in accordance with a first tone separation distance that corresponds to the ON state associated with the IM mode.

Clause 65: The method of clause 64, further including: interleaving the plurality of data tones in accordance with the first tone separation distance that corresponds to the ON state associated with the IM mode, where transmitting the PPDU is in association with interleaving the plurality of data tones.

Clause 66: The method of any of clauses 64-65, further including: determining the first tone separation distance from a plurality of tone separation distances associated with the first RU size in accordance with the ON state associated with the IM mode for the PPDU, where the plurality of tone separation distances associated with the first RU size includes the first tone separation distance that corresponds to the ON state associated with the IM mode and a second tone separation distance that corresponds to an OFF state associated with the IM mode.

Clause 67: The method of clause 66, where each RU size of a plurality of RU sizes is associated with a respective plurality of tone separation distances, each respective plurality of tone separation distances including a respective first tone separation distance that corresponds to the ON state associated with the IM mode and a respective second tone separation distance that corresponds to the OFF state associated with the IM mode.

Clause 68: The method of any of clauses 64-67, where at least a portion of the plurality of pilot tones associated with the IM mode are evenly spaced within the data portion.

Clause 69: The method of any of clauses 64-68, where the data portion of the PPDU further includes a second plurality of pilot tones associated with a CFO measurement, and the fixed tone locations of the plurality of pilot tones associated with the IM mode are non-overlapping with the second plurality of pilot tones associated with the CFO measurement.

Clause 70: The method of any of clauses 64-69, where each RU of a complete set of RUs associated with the first RU size includes a same quantity of pilot tones associated with the IM mode and a same quantity of data tones; and the fixed tone locations of the plurality of pilot tones associated with the IM mode are shared across a first RU associated with the first RU size and a second RU associated with a second RU size in accordance with the first RU and the second RU having tone locations in common.

Clause 71: A method for wireless communication by a wireless communication device, including: communicating information indicative of an ON state associated with an IM mode for a PPDU; and transmitting, in accordance with the information, the PPDU including a data portion associated with the IM mode, the data portion associated with a first RU size and including a plurality of pilot tones associated with the IM mode, the plurality of pilot tones at fixed tone locations associated with the first RU size, and including a plurality of data tones interleaved within the data portion in accordance with a first tone interleaver that corresponds to the ON state associated with the IM mode.

Clause 72: The method of clause 71, further including: interleaving the plurality of data tones in accordance with the first tone interleaver that corresponds to the ON state associated with the IM mode in association with inputting, into the first tone interleaver, a first plurality of tone indexes and obtaining, as an output of the first tone interleaver, a second plurality of tone indexes, where transmitting the PPDU is in association with interleaving the plurality of data tones.

Clause 73: The method of clause 72, where the first tone interleaver converts a first tone index of the first plurality of tone indexes to a second tone index of the second plurality of tone indexes in accordance with a first tone mapping operation in association with the first tone index satisfying a condition or a second tone mapping operation in association with the first tone index failing to satisfy the condition.

Clause 74: The method of clause 73, where the first tone index satisfies the condition in association with a modulo between the first tone index and a distribution parameter being greater than a threshold value; and the first tone index fails to satisfy the condition in association with the modulo between the first tone index and the distribution parameter being less than or equal to the threshold value.

Clause 75: The method of clause 74, where the distribution parameter is equal to a value determined from a floor function of a quotient between the plurality of data tones and a tone separation distance; and the threshold value is equal to a modulo between the plurality of data tones and the distribution parameter.

Clause 76: The method of clause 75, further including: determining the tone separation distance independent of whether a state associated with the IM mode for the PPDU is the ON state or an OFF state.

Clause 77: The method of clause 75, further including: determining the tone separation distance from a plurality of tone separation distances associated with the first RU size in accordance with the ON state associated with the IM mode for the PPDU, where the plurality of tone separation distances associated with the first RU size includes a first tone separation distance that corresponds to the ON state associated with the IM mode and a second tone separation distance that corresponds to an OFF state associated with the IM mode.

Clause 78: The method of any of clauses 74-77, where the distribution parameter corresponds to a quantity of output bins into which the first tone interleaver distributes the first plurality of tone indexes.

Clause 79: The method of any of clauses 73-78, where the first tone mapping operation is associated with a tone adjustment and the second tone mapping operation is associated with an absence of the tone adjustment.

Clause 80: The method of any of clauses 72-79, where the first tone interleaver converts a first tone index of the first plurality of tone indexes to a second tone index of the second plurality of tone indexes in accordance with a single tone mapping operation commonly applicable to each tone index of the first plurality of tone indexes.

Clause 81: The method of clause 80, further including: determining a tone separation distance, a first quantity of the plurality of data tones, and a second quantity of the plurality of pilot tones in accordance with a condition associated with the single tone mapping operation.

Clause 82: The method of any of clauses 71-81, further including: determining the first tone interleaver from a plurality of tone interleavers in accordance with the ON state associated with the IM mode for the PPDU, where the plurality of tone interleavers includes the first tone interleaver that corresponds to the ON state associated with the IM mode and a second tone interleaver that corresponds to an OFF state associated with the IM mode.

Clause 83: The method of any of clauses 71-82, where at least a portion of the plurality of pilot tones associated with the IM mode are evenly spaced within the data portion.

Clause 84: The method of any of clauses 71-83, where the data portion of the PPDU further includes a second plurality of pilot tones associated with a CFO measurement, and the fixed tone locations of the plurality of pilot tones associated with the IM mode are non-overlapping with the second plurality of pilot tones associated with the CFO measurement.

Clause 85: The method of any of clauses 71-84, where each RU of a complete set of RUs associated with the first RU size includes a same quantity of pilot tones associated with the IM mode and a same quantity of data tones; and the fixed tone locations of the plurality of pilot tones associated with the IM mode are shared across a first RU associated with the first RU size and a second RU associated with a second RU size in accordance with the first RU and the second RU having tone locations in common.

Clause 86: A method for wireless communication by a wireless communication device, including: communicating information indicative of an ON state associated with an IM mode for a PPDU; and receiving, in accordance with the information, the PPDU including a data portion associated with the IM mode, the data portion associated with a first RU size and including a plurality of pilot tones associated with the IM mode, the plurality of pilot tones at fixed tone locations associated with the first RU size, and including a plurality of data tones interleaved within the data portion in accordance with a first tone separation distance that corresponds to the ON state associated with the IM mode.

Clause 87: The method of clause 86, further including: deinterleaving the plurality of data tones in accordance with the first tone separation distance that corresponds to the ON state associated with the IM mode, where receiving the PPDU is in association with deinterleaving the plurality of data tones.

Clause 88: A method for wireless communication by a wireless communication device, including: communicating information indicative of an ON state associated with an IM mode for a PPDU; and receiving, in accordance with the information, the PPDU including a data portion associated with the IM mode, the data portion associated with a first RU size and including a plurality of pilot tones associated with the IM mode, the plurality of pilot tones at fixed tone locations associated with the first RU size, and including a plurality of data tones interleaved within the data portion in accordance with a first tone interleaver that corresponds to the ON state associated with the IM mode.

Clause 89: The method of clause 88, further including: deinterleaving the plurality of data tones in accordance with the first tone interleaver that corresponds to the ON state associated with the IM mode in association with inputting, into the first tone interleaver, a first plurality of tone indexes and obtaining, as an output of the first tone interleaver, a second plurality of tone indexes, where receiving the PPDU is in association with deinterleaving the plurality of data tones.

Clause 90: A wireless communication device, including a processing system that includes processor circuitry and memory circuitry that stores code, the processing system configured to cause the wireless communication device to perform a method of any of clauses 64-70.

Clause 91: A wireless communication device, including at least one means for performing a method of any of clauses 64-70.

Clause 92: A non-transitory computer-readable medium storing code for wireless communication, the code including instructions executable by a processing system to perform a method of any of clauses 64-70.

Clause 93: A wireless communication device, including a processing system that includes processor circuitry and memory circuitry that stores code, the processing system configured to cause the wireless communication device to perform a method of any of clauses 71-85.

Clause 94: A wireless communication device, including at least one means for performing a method of any of clauses 71-85.

Clause 95: A non-transitory computer-readable medium storing code for wireless communication, the code including instructions executable by a processing system to perform a method of any of clauses 71-85.

Clause 96: A wireless communication device, including a processing system that includes processor circuitry and memory circuitry that stores code, the processing system configured to cause the wireless communication device to perform a method of any of clauses 86-87.

Clause 97: A wireless communication device, including at least one means for performing a method of any of clauses 86-87.

Clause 98: A non-transitory computer-readable medium storing code for wireless communication, the code including instructions executable by a processing system to perform a method of any of clauses 86-87.

Clause 99: A wireless communication device, including a processing system that includes processor circuitry and memory circuitry that stores code, the processing system configured to cause the wireless communication device to perform a method of any of clauses 88-89.

Clause 100: A wireless communication device, including at least one means for performing a method of any of clauses 88-89.

Clause 101: A non-transitory computer-readable medium storing code for wireless communication, the code including instructions executable by a processing system to perform a method of any of clauses 88-89.

Clause 102: A method for wireless communication by a wireless communication device, including: communicating first information indicative of an ON state of an interference mitigation mode for a PPDU; communicating second information indicative of at least one punctured subchannel within a channel bandwidth of the PPDU; and transmitting the PPDU via a subset of the channel bandwidth in accordance with the at least one punctured subchannel within the channel bandwidth, where the PPDU includes a data portion based on the interference mitigation mode in accordance with the first information, where the data portion includes at least an MRU in accordance with the second information, and where the MRU includes a plurality of pilot tones corresponding to the interference mitigation mode and a plurality of data tones that are interleaved within the MRU in accordance with a first tone separation distance, of a plurality of tone separation distances defined for the MRU, that corresponds to the ON state of the interference mitigation mode.

Clause 103: The method of clause 102, further including: interleaving the plurality of pilot tones corresponding to the interference mitigation mode and the plurality of data tones in accordance with the first tone separation distance that corresponds to the ON state of the interference mitigation mode, where transmitting the PPDU is in accordance with interleaving the plurality of pilot tones corresponding to the interference mitigation mode and the plurality of data tones.

Clause 104: The method of any of clauses 102-103, further including: determining the first tone separation distance from the plurality of tone separation distances defined for the MRU in accordance with the ON state of the interference mitigation mode for the PPDU, where the plurality of tone separation distances defined for the MRU includes the first tone separation distance that corresponds to the ON state of the interference mitigation mode and includes a second tone separation distance that corresponds to an OFF state of the interference mitigation mode.

Clause 105: The method of clause 104, where the first tone separation distance is equal to 9 tones, and the second tone separation distance is equal to 18 tones.

Clause 106: The method of any of clauses 102-105, where the MRU is a 484-tone plus 242-tone MRU (MRU484+242).

Clause 107: The method of clause 106, where in accordance with the ON state of the interference mitigation mode, the plurality of pilot tones corresponding to the interference mitigation mode includes 78 pilot tones and the plurality of data tones includes 624 data tones.

Clause 108: The method of any of clauses 106-107, where the channel bandwidth is equal to 160 MHz, and the data portion further includes a 996-tone RU (RU996) in accordance with the channel bandwidth being equal to 160 MHz and in accordance with the at least one punctured subchannel including a 20 MHz subchannel.

Clause 109: The method of clause 108, where the RU996 includes a second plurality of pilot tones corresponding to the interference mitigation mode and a second plurality of data tones that are interleaved within the RU996 in accordance with a second tone separation distance, of a second plurality of tone separation distances defined for the RU996, that corresponds to the ON state of the interference mitigation mode.

Clause 110: The method of any of clauses 106-107, where the channel bandwidth is equal to 80 MHz, and the data portion exclusively includes the MRU484+242 in accordance with the channel bandwidth being equal to 80 MHz and in accordance with the at least one punctured subchannel including a 20 MHz subchannel.

Clause 111: The method of any of clauses 102-110, where the PPDU is a punctured SU PPDU, and the channel bandwidth is greater than or equal to 80 MHz.

Clause 112: The method of any of clauses 102-111, where the data portion of the PPDU further includes a second plurality of pilot tones corresponding to a CFO measurement.

Clause 113: The method of any of clauses 102-112, where the MRU is in accordance with a parameter value for a quantity of data tones in a fractional RU increment to use in a pre-FEC padding calculation, of a plurality of parameter values defined for the MRU for the quantity of data tones in the fractional RU increment to use in pre-FEC padding calculations, that corresponds to the ON state of the interference mitigation mode.

Clause 114: The method of clause 113, where the MRU is a 484-tone plus 242-tone MRU (MRU484+242), and the parameter value is equal to 156.

Clause 115: The method of any of clauses 113-114, where each MRU of a plurality of MRUs is defined with a respective parameter value of a plurality of parameter values, for the quantity of data tones in the fractional RU increment to use in the pre-FEC padding calculation, that corresponds to the ON state of the interference mitigation mode, and a first parameter value of the plurality of parameter values is defined for a 484-tone plus 242-tone MRU (MRU484+242) and is equal to 156, a second parameter value of the plurality of parameter values is defined for a 996-tone plus 484-tone MRU (MRU996+484) and is equal to 324, a third parameter value of the plurality of parameter values is defined for a 996-tone plus 484-tone plus 242-tone MRU (MRU996+484+242) and is equal to 372, a fourth parameter value of the plurality of parameter values is defined for a 996-tone plus 996-tone plus 484-tone MRU (MRU2×996+484) and is equal to 552, a fifth parameter value of the plurality of parameter values is defined for a 996-tone plus 996-tone plus 996-tone MRU (MRU3×996) and is equal to 660, and a sixth parameter value of the plurality of parameter values is defined for a 996-tone plus 996-tone plus 996-tone plus 484-tone MRU (MRU3×996+484) and is equal to 768.

Clause 116: The method of any of clauses 113-114, where each MRU of a plurality of MRUs is defined with a respective parameter value of a plurality of parameter values, for the quantity of data tones in the fractional RU increment to use in the pre-FEC padding calculation, that corresponds to the ON state of the interference mitigation mode, and a first parameter value of the plurality of parameter values is defined for a 484-tone plus 242-tone MRU (MRU484+242) and is equal to 156, a second parameter value of the plurality of parameter values is defined for a 996-tone plus 484-tone MRU (MRU996+484) and is equal to 324, a third parameter value of the plurality of parameter values is defined for a 996-tone plus 484-tone plus 242-tone MRU (MRU996+484+242) and is equal to 372, a fourth parameter value of the plurality of parameter values is defined for a 996-tone plus 996-tone plus 484-tone MRU (MRU2×996+484) and is equal to 540, a fifth parameter value of the plurality of parameter values is defined for a 996-tone plus 996-tone plus 996-tone MRU (MRU3×996) and is equal to 660, and a sixth parameter value of the plurality of parameter values is defined for a 996-tone plus 996-tone plus 996-tone plus 484-tone MRU (MRU3×996+484) and is equal to 768.

Clause 117: A method for wireless communication by a wireless communication device, including: communicating information indicative of an ON state of an interference mitigation mode for a PPDU; and transmitting the PPDU via a channel bandwidth, where the PPDU includes a data portion based on the interference mitigation mode in accordance with the information, and where the data portion includes a first RU that includes a plurality of pilot tones usable as interference measurement pilot tones corresponding to the interference mitigation mode and usable as CFO measurement pilot tones in accordance with the ON state of the interference mitigation mode, the plurality of pilot tones at fixed tone locations within the first RU, and includes a plurality of data tones interleaved within the first RU in accordance with a first tone separation distance, of a plurality of tone separation distances defined for the first RU, that corresponds to the ON state of the interference mitigation mode.

Clause 118: The method of clause 117, further including: interleaving the plurality of data tones in accordance with the first tone separation distance that corresponds to the ON state of the interference mitigation mode, where transmitting the PPDU is in accordance with interleaving the plurality of data tones.

Clause 119: The method of any of clauses 117-118, further including: determining the first tone separation distance from the plurality of tone separation distances defined for the first RU in accordance with the ON state of the interference mitigation mode for the PPDU, where the plurality of tone separation distances defined for the first RU includes the first tone separation distance that corresponds to the ON state of the interference mitigation mode and includes a second tone separation distance that corresponds to an OFF state of the interference mitigation mode.

Clause 120: The method of any of clauses 117-119, where the first RU has a first RU size, and the fixed tone locations within the first RU correspond, at least in part, to CFO pilot tone locations of a plurality of RUs having a second RU size smaller than the first RU size.

Clause 121: The method of clause 120, where the fixed tone locations within the first RU correspond to a full union of all the CFO pilot tone locations of the plurality of RUs having the second RU size.

Clause 122: The method of clause 120, where the fixed tone locations within the first RU correspond to a subset of the CFO pilot tone locations of the plurality of RUs having the second RU size.

Clause 123: The method of clause 120, where the fixed tone locations within the first RU correspond to at least a subset of the CFO pilot tone locations of the plurality of RUs having the second RU size and to one or more additional tone locations within the first RU.

Clause 124: The method of any of clauses 120-123, where the second RU size is a 26-tone RU (RU26).

Clause 125: The method of any of clauses 117-124, where the channel bandwidth is equal to 20 MHz and the first RU is a 242-tone RU (RU242), the plurality of pilot tones includes 18 pilot tones, the plurality of data tones includes 224 data tones, and the first tone separation distance is equal to 8 tones.

Clause 126: The method of any of clauses 117-124, where the channel bandwidth is equal to 40 MHz and the first RU is a 484-tone RU (RU484), the plurality of pilot tones includes 36 pilot tones, the plurality of data tones includes 448 data tones, and the first tone separation distance is equal to 8 tones.

Clause 127: The method of any of clauses 117-124, where the channel bandwidth is equal to 80 MHz and the first RU is a 996-tone RU (RU996), the plurality of pilot tones includes 84 pilot tones, the plurality of data tones includes 896 data tones, and the first tone separation distance is equal to 16 tones.

Clause 128: A method for wireless communication by a wireless communication device, including: communicating first information indicative of an ON state of an interference mitigation mode for a PPDU; communicating second information indicative of at least one punctured subchannel within a channel bandwidth of the PPDU; and receiving the PPDU via a subset of the channel bandwidth in accordance with the at least one punctured subchannel within the channel bandwidth, where the PPDU includes a data portion based on the interference mitigation mode in accordance with the first information, where the data portion includes at least an MRU in accordance with the second information, and where the MRU includes a plurality of pilot tones corresponding to the interference mitigation mode and a plurality of data tones that are interleaved within the MRU in accordance with a first tone separation distance, of a plurality of tone separation distances defined for the MRU, that corresponds to the ON state of the interference mitigation mode.

Clause 129: The method of clause 128, further including: deinterleaving the plurality of pilot tones corresponding to the interference mitigation mode and the plurality of data tones in accordance with the first tone separation distance that corresponds to the ON state of the interference mitigation mode, where receiving the PPDU is in accordance with deinterleaving the plurality of pilot tones corresponding to the interference mitigation mode and the plurality of data tones.

Clause 130: A method for wireless communication by a wireless communication device, including: communicating information indicative of an ON state of an interference mitigation mode for a PPDU; and receiving the PPDU via a channel bandwidth, where the PPDU includes a data portion based on the interference mitigation mode in accordance with the information, and where the data portion includes a first RU that includes a plurality of pilot tones usable as interference measurement pilot tones corresponding to the interference mitigation mode and usable as CFO measurement pilot tones in accordance with the ON state of the interference mitigation mode, the plurality of pilot tones at fixed tone locations within the first RU, and includes a plurality of data tones interleaved within the first RU in accordance with a first tone separation distance, of a plurality of tone separation distances defined for the first RU, that corresponds to the ON state of the interference mitigation mode.

Clause 131: The method of clause 130, further including: deinterleaving the plurality of data tones in accordance with the first tone separation distance that corresponds to the ON state of the interference mitigation mode, where receiving the PPDU is in accordance with deinterleaving the plurality of data tones.

Clause 132: A wireless communication device for wireless communication, including a processing system that includes processor circuitry and memory circuitry that stores code, the processing system configured to cause the wireless communication device to perform a method of any of clauses 102-116.

Clause 133: A wireless communication device for wireless communication, including at least one means for performing a method of any of clauses 102-116.

Clause 134: A non-transitory computer-readable medium storing code for wireless communication, the code including instructions executable by one or more processors to perform a method of any of clauses 102-116.

Clause 135: A wireless communication device for wireless communication, including a processing system that includes processor circuitry and memory circuitry that stores code, the processing system configured to cause the wireless communication device to perform a method of any of clauses 117-127.

Clause 136: A wireless communication device for wireless communication, including at least one means for performing a method of any of clauses 117-127.

Clause 137: A non-transitory computer-readable medium storing code for wireless communication, the code including instructions executable by one or more processors to perform a method of any of clauses 117-127.

Clause 138: A wireless communication device for wireless communication, including a processing system that includes processor circuitry and memory circuitry that stores code, the processing system configured to cause the wireless communication device to perform a method of any of clauses 128-129.

Clause 139: A wireless communication device for wireless communication, including at least one means for performing a method of any of clauses 128-129.

Clause 140: A non-transitory computer-readable medium storing code for wireless communication, the code including instructions executable by one or more processors to perform a method of any of clauses 128-129.

Clause 141: A wireless communication device for wireless communication, including a processing system that includes processor circuitry and memory circuitry that stores code, the processing system configured to cause the wireless communication device to perform a method of any of clauses 130-131.

Clause 142: A wireless communication device for wireless communication, including at least one means for performing a method of any of clauses 130-131.

Clause 143: A non-transitory computer-readable medium storing code for wireless communication, the code including instructions executable by one or more processors to perform a method of any of clauses 130-131.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination may be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless communication device, comprising:
a processing system that includes processor circuitry and memory circuitry that stores code, the processing system configured to cause the wireless communication device to:
communicate first information indicative of an ON state of an interference mitigation mode for a physical layer protocol data unit (PPDU);
communicate second information indicative of at least one punctured subchannel within a channel bandwidth of the PPDU; and
transmit the PPDU via a subset of the channel bandwidth in accordance with the at least one punctured subchannel within the channel bandwidth,
the PPDU comprising a data portion based at least in part on the interference mitigation mode in accordance with the first information,
the data portion comprising at least a multiple resource unit (MRU) in accordance with the second information, and
the MRU comprising a plurality of pilot tones corresponding to the interference mitigation mode and a plurality of data tones that are interleaved within the MRU in accordance with a first tone separation distance, of a plurality of tone separation distances defined for the MRU, that corresponds to the ON state of the interference mitigation mode.

2. The wireless communication device of claim 1, wherein the processing system is further configured to cause the wireless communication device to:
determine the first tone separation distance from the plurality of tone separation distances defined for the MRU in accordance with the ON state of the interference mitigation mode for the PPDU,
wherein the plurality of tone separation distances defined for the MRU comprises:
the first tone separation distance that corresponds to the ON state of the interference mitigation mode, and
a second tone separation distance that corresponds to an OFF state of the interference mitigation mode.

3. The wireless communication device of claim 2, wherein:
the first tone separation distance is equal to 9 tones, and
the second tone separation distance is equal to 18 tones.

4. The wireless communication device of claim 1, wherein the MRU is a 484-tone plus 242-tone MRU (MRU484+242).

5. The wireless communication device of claim 4, wherein, in accordance with the ON state of the interference mitigation mode, the plurality of pilot tones corresponding to the interference mitigation mode comprises 78 pilot tones and the plurality of data tones comprises 624 data tones.

6. The wireless communication device of claim 4, wherein:
the channel bandwidth is equal to 160 megahertz (MHz), and
the data portion further comprises a 996-tone resource unit (RU) (RU996) in accordance with the channel bandwidth being equal to 160 MHz and in accordance with the at least one punctured subchannel comprising a 20 MHz subchannel.

7. The wireless communication device of claim 6, wherein the RU996 comprises a second plurality of pilot tones corresponding to the interference mitigation mode and a second plurality of data tones that are interleaved within the RU996 in accordance with a second tone separation distance, of a second plurality of tone separation distances defined for the RU996, that corresponds to the ON state of the interference mitigation mode.

8. The wireless communication device of claim 4, wherein:
the channel bandwidth is equal to 80 megahertz (MHz), and
the data portion exclusively comprises the MRU484+242 in accordance with the channel bandwidth being equal to 80 MHz and in accordance with the at least one punctured subchannel comprising a 20 MHz subchannel.

9. The wireless communication device of claim 1, wherein:
the PPDU is a punctured single user (SU) PPDU, and
the channel bandwidth is greater than or equal to 80 megahertz (MHz).

10. The wireless communication device of claim 1, wherein the data portion of the PPDU further comprises a second plurality of pilot tones corresponding to a carrier frequency offset (CFO) measurement.

11. The wireless communication device of claim 1, wherein the MRU is in accordance with a parameter value for a quantity of data tones in a fractional resource unit (RU) increment to use in a pre-forward error correction (FEC) padding calculation, of a plurality of parameter values defined for the MRU for the quantity of data tones in the fractional RU increment to use in pre-FEC padding calculations, that corresponds to the ON state of the interference mitigation mode.

12. The wireless communication device of claim 11, wherein each MRU of a plurality of MRUs is defined with a respective parameter value of a plurality of parameter values, for the quantity of data tones in the fractional RU increment to use in the pre-FEC padding calculation, that corresponds to the ON state of the interference mitigation mode, and wherein:
a first parameter value of the plurality of parameter values is defined for a 484-tone plus 242-tone MRU (MRU484+242) and is equal to 156,
a second parameter value of the plurality of parameter values is defined for a 996-tone plus 484-tone MRU (MRU996+484) and is equal to 324,
a third parameter value of the plurality of parameter values is defined for a 996-tone plus 484-tone plus 242-tone MRU (MRU996+484+242) and is equal to 372,
a fourth parameter value of the plurality of parameter values is defined for a 996-tone plus 996-tone plus 484-tone MRU (MRU2×996+484) and is equal to 552,
a fifth parameter value of the plurality of parameter values is defined for a 996-tone plus 996-tone plus 996-tone MRU (MRU3×996) and is equal to 660, and
a sixth parameter value of the plurality of parameter values is defined for a 996-tone plus 996-tone plus 996-tone plus 484-tone MRU (MRU3×996+484) and is equal to 768.

13. The wireless communication device of claim 11, wherein each MRU of a plurality of MRUs is defined with a respective parameter value of a plurality of parameter values, for the quantity of data tones in the fractional RU increment to use in the pre-FEC padding calculation, that corresponds to the ON state of the interference mitigation mode, and wherein:
a first parameter value of the plurality of parameter values is defined for a 484-tone plus 242-tone MRU (MRU484+242) and is equal to 156,
a second parameter value of the plurality of parameter values is defined for a 996-tone plus 484-tone MRU (MRU996+484) and is equal to 324,
a third parameter value of the plurality of parameter values is defined for a 996-tone plus 484-tone plus 242-tone MRU (MRU996+484+242) and is equal to 372,
a fourth parameter value of the plurality of parameter values is defined for a 996-tone plus 996-tone plus 484-tone MRU (MRU2×996+484) and is equal to 540,
a fifth parameter value of the plurality of parameter values is defined for a 996-tone plus 996-tone plus 996-tone MRU (MRU3×996) and is equal to 660, and
a sixth parameter value of the plurality of parameter values is defined for a 996-tone plus 996-tone plus 996-tone plus 484-tone MRU (MRU3×996+484) and is equal to 768.

14. A wireless communication device, comprising:
a processing system that includes processor circuitry and memory circuitry that stores code, the processing system configured to cause the wireless communication device to:
communicate information indicative of an ON state of an interference mitigation mode for a physical layer protocol data unit (PPDU); and
transmit the PPDU via a channel bandwidth, the PPDU comprising a data portion based at least in part on the interference mitigation mode in accordance with the information, and the data portion comprising a first resource unit (RU) that comprises:
a plurality of pilot tones usable as interference mitigation pilot tones corresponding to the interference mitigation mode and usable as carrier frequency offset (CFO) pilot tones in accordance with the ON state of the interference mitigation mode, the plurality of pilot tones at fixed tone locations within the first RU, and
a plurality of data tones interleaved within the first RU in accordance with a first tone separation distance, of a plurality of tone separation distances defined for the first RU, that corresponds to the ON state of the interference mitigation mode.

15. The wireless communication device of claim 14, wherein:
the first RU has a first RU size, and
the fixed tone locations within the first RU correspond, at least in part, to CFO pilot tone locations of a plurality of RUs having a second RU size smaller than the first RU size.

16. The wireless communication device of claim 15, wherein the fixed tone locations within the first RU correspond to a full union of all the CFO pilot tone locations of the plurality of RUs having the second RU size.

17. The wireless communication device of claim 15, wherein the fixed tone locations within the first RU correspond to a subset of the CFO pilot tone locations of the plurality of RUs having the second RU size.

18. The wireless communication device of claim 15, wherein the fixed tone locations within the first RU correspond to at least a subset of the CFO pilot tone locations of the plurality of RUs having the second RU size and to one or more additional tone locations within the first RU.

19. A method for wireless communication by a wireless communication device, comprising:
communicating first information indicative of an ON state of an interference mitigation mode for a physical layer protocol data unit (PPDU);
communicating second information indicative of at least one punctured subchannel within a channel bandwidth of the PPDU; and
transmitting the PPDU via a subset of the channel bandwidth in accordance with the at least one punctured subchannel within the channel bandwidth,
the PPDU comprising a data portion based at least in part on the interference mitigation mode in accordance with the first information,
the data portion comprising at least a multiple resource unit (MRU) in accordance with the second information, and
the MRU comprising a plurality of pilot tones corresponding to the interference mitigation mode and a plurality of data tones that are interleaved within the MRU in accordance with a first tone separation distance, of a plurality of tone separation distances defined for the MRU, that corresponds to the ON state of the interference mitigation mode.

20. The method of claim 19, further comprising:
interleaving the plurality of pilot tones corresponding to the interference mitigation mode and the plurality of data tones in accordance with the first tone separation distance that corresponds to the ON state of the interference mitigation mode,
wherein transmitting the PPDU is in accordance with interleaving the plurality of pilot tones corresponding to the interference mitigation mode and the plurality of data tones.
